(19) United States
(12) Patent Application Publication
(10) Pub. No.: US 2026/0216760 A1
(43) Pub. Date: Jul. 30, 2026

(54) System and Method for Cleaning Transport Enclosures

(71) Applicant: AgTech Cleaning Solutions, LLC, Houston, TX (US)

(72) Inventors: Steve Brandt, Canmore (CA); Garth Belue, Houston, TX (US); Robbert Vijlbrief, Belmopan (BZ)

(21) Appl. No.: 19/457,970

(22) Filed: Jan. 23, 2026

Related U.S. Application Data
(60) Provisional application No. 63/750,186, filed on Jan. 27, 2025.

(51) Int. Cl. B08B 9/00; B60P 3/04; B60S 3/00

(52) U.S. Cl. CPC B08B 9/00; B60P 3/04; B60S 3/008

(57) ABSTRACT

The disclosure is directed to a system and method for cleaning transport enclosures, including animal transport enclosures, positioned within one or more designated cleaning spaces of the system. One or more transport enclosures may include one or more roofed enclosures, each having one or more roof-accessible pathways for positioning one or more first fluid outlets of the system at one or more dispensing positions effective for emitting pressurized fluid onto interior surfaces of a transport enclosure targeted for cleaning. The first fluid outlets may be adjustable for use with roofed enclosures that vary in the total number of roof-accessible pathways and/or in the layout of those pathways.

### CROSS-REFERENCE TO RELATED APPLICATIONS

This application claims benefit of U.S. Provisional Patent Application No. 63/750,186, filed on Jan. 27, 2025, the content of which is hereby incorporated by reference in its entirety.

### BACKGROUND OF THE DISCLOSURE

### 1. Field of the Disclosure

This disclosure relates generally to systems and methods for cleaning transport enclosures, including enclosures used for transporting animals.

### 2. Background Art

Transport enclosures used for storing and/or transporting flowable materials, such as liquids or solids, as well as enclosures used for transporting animals, are typically cleaned prior to reuse. In the context of animal transport, a variety of waste materials may accumulate within an enclosure, including animal feed waste, bedding, spilled potable liquids, and animal waste such as excrement, blood, urine, and other bodily fluids. To prevent contamination, both the interior and exterior surfaces of such enclosures are generally washed prior to subsequent use.

The interior configuration of transport enclosures can vary considerably, with many incorporating stall dividers and others utilizing double, triple, or even quadruple decking to maximize capacity. Consequently, thorough cleaning often necessitates time-consuming and physically demanding manual labor. In numerous instances, one or more individuals must enter the enclosure equipped with hoses, brushes, brooms, scrapers, wiping cloths, or similar tools to ensure that all surfaces are properly cleaned, whether for operational efficiency or to comply with applicable legal and regulatory requirements.

Addressing these shortcomings is therefore desirable.

### SUMMARY OF THE DISCLOSURE

The disclosure provides a system, comprising one or more roofed enclosures, each of the one or more roofed enclosures comprising one or more roof-accessible pathways; and a fluid dispensing system comprising one or more first fluid outlets configured to be directed into the one or more roof-accessible pathways of the one or more roofed enclosures and to dispense a fluid within an interior of the one or more roofed enclosures.

The disclosure further provides a system, comprising at least a first roofed enclosure comprising one or more roof-accessible pathways; and a fluid dispensing system comprising one or more first fluid outlets configured to be directed to one or more dispensing positions within the one or more roof-accessible pathways of the first roofed enclosure.

The disclosure further provides a system, comprising (1) at least a first roofed enclosure; and (2) at least one cleaning fluid dispensing system comprising one or more first fluid outlets; wherein the first roofed enclosure includes one or more resilient roof hatches forming one or more first vertical pathways in an interior of the first roofed enclosure; wherein the one or more first fluid outlets are moveable in a manner effective to be directed to one or more dispensing positions within the one or more first vertical pathways, the one or more dispensing positions corresponding to one or more target interior surfaces of the first roofed enclosure; wherein the one or more resilient roof hatches are configured to concentrically maintain the one or more first fluid outlets in the one or more first vertical pathways; and wherein the one or more first vertical pathways of the first roofed enclosure are configured according to at least (1) an inner surface configuration of the first roofed enclosure and (2) an operative spray range of each of the one or more first fluid outlets.

### BRIEF DESCRIPTION OF THE SEVERAL VIEWS OF THE DRAWING

FIG. 1 is a side view of an embodiment of an openwork animal transport enclosure.

FIG. 2 is a side view of another embodiment of an openwork animal transport enclosure.

FIG. 3 is a side view of another embodiment of an openwork animal transport enclosure hitched to a vehicular truck.

FIG. 4 is a perspective view of another embodiment of an openwork animal transport enclosure.

FIG. 5 is a side view of another embodiment of an openwork animal transport enclosure.

FIG. 6 is a side view of another embodiment of an openwork animal transport enclosure hitched to a vehicular truck.

FIG. 7 is a side view of another embodiment of an openwork animal transport enclosure supported on a flatbed of a vehicular truck.

FIG. 8 is a rear view of an embodiment of an openwork animal transport enclosure.

FIG. 9 is a rear view of an embodiment of an openwork animal transport enclosure.

FIG. 10 is a rear view of an embodiment of an openwork animal transport enclosure.

FIG. 11 is a rear view of an embodiment of an openwork animal transport enclosure including post-production apertures in the roof of the openwork animal transport enclosure.

FIG. 12 illustrates an embodiment of a system of this disclosure.

FIG. 13 illustrates an embodiment of a system of this disclosure.

FIG. 14 illustrates an embodiment of a system of this disclosure.

FIG. 15 illustrates an embodiment of a system of this disclosure.

FIG. 16 illustrates an embodiment of a system of this disclosure.

FIG. 17 illustrates an embodiment of a system of this disclosure.

FIG. 18 illustrates a fluid delivery system and control system of a system of this disclosure.

FIG. 19 is a top view of an embodiment of a cleaning bay of this disclosure.

FIG. 20 is front perspective partial view of an embodiment of a cleaning bay of this disclosure.

FIG. 21 is rear perspective partial view of an embodiment of a cleaning bay of this disclosure.

FIG. 22 is top view of an embodiment of a cleaning bay of this disclosure with an openwork animal transport enclosure located in a cleaning zone of the cleaning bay.

FIG. 23 is a front perspective partial view of an embodiment of a cleaning bay of this disclosure with an openwork animal transport enclosure located in a cleaning zone of the cleaning bay.

FIG. 24 is a top view of an embodiment of a cleaning zone of a cleaning bay with an openwork animal transport enclosure located in the cleaning zone.

FIG. 25 is a side view of an exemplary openwork animal transport enclosure positioned within a cleaning bay of this disclosure.

FIG. 26 is a top view illustration of a simplified cleaning bay, fluid line and an embodiment of a manually operable fluid outlet of this disclosure.

FIG. 27 is a perspective view of an embodiment of an overhead primary support of a cleaning bay of this disclosure.

FIG. 28 is top view of an embodiment of a cleaning bay of this disclosure.

FIG. 29 is a perspective view of fluid delivery assemblies secured to an overhead primary support and overhead secondary supports of a cleaning bay of this disclosure.

FIG. 30 is a perspective view of a fluid delivery assembly secured to an overhead primary support and an overhead secondary support of a cleaning bay of this disclosure.

FIG. 31 is a rear view of an embodiment of an openwork animal transport enclosure located in a cleaning zone of a cleaning bay of this disclosure.

FIG. 32 is a perspective view of a fluid outlet secured to an overhead primary support of a cleaning bay of this disclosure.

FIG. 33 is a side view of an openwork animal transport enclosure illustrating an exemplary pressurized fluid stream spray pattern along an external side surface of the transport enclosure.

FIG. 34 is a perspective view of fluid delivery assemblies secured to an overhead primary support and overhead secondary supports of a cleaning bay of this disclosure with pressurized hoses of the fluid delivery assemblies shown disposed through roof apertures of an openwork animal transport enclosure via a top down entry.

FIG. 35 is a perspective view of an interior of a roofed openwork animal transport enclosure illustrating fluid outlets located within the openwork animal transport enclosure via a top down entry through roof apertures of the openwork animal transport enclosure.

FIG. 36 is a perspective view of the interior of the roofed openwork animal transport enclosure and fluid outlets of FIG. 35 illustrating spherical patterns of fluid streams emitted from each of the fluid outlets.

FIG. 37 is a top view of a roofed openwork animal transport enclosure illustrating overlapping fluid streams emitted from fluid outlets located within the roofed openwork animal transport enclosure via a top down entry through roof apertures.

FIG. 38 is a top view of a roofed openwork animal transport enclosure illustrating roof aperture placement for washing interior surfaces of the roofed openwork animal transport enclosure.

FIG. 39 is a top view of a roofed openwork animal transport enclosure illustrating a directional wave pattern of fluid streams formed by fluid outlets located within the roofed openwork animal transport enclosure via a top down entry through roof apertures.

FIG. 40 is a top view of a roofed openwork animal transport enclosure illustrating a directional wave pattern of fluid streams formed by fluid outlets located within the roofed openwork animal transport enclosure via a top down entry through roof apertures.

FIG. 41 is a top view of a roofed openwork animal transport enclosure illustrating a directional wave pattern of fluid streams formed by fluid outlets located within the roofed openwork animal transport enclosure via a top down entry through roof apertures.

FIG. 42 is a perspective view of the interior of a roofed openwork animal transport enclosure illustrating a fluid outlet disposed through a deck floor aperture.

FIG. 43 is a side view of an embodiment of a roofed openwork animal transport enclosure.

FIG. 44 is a top view of a roofed openwork animal transport enclosure illustrating fluid outlet alignment areas for corresponding roof apertures.

FIG. 45 is a top view of a roofed openwork animal transport enclosure illustrating fluid outlet alignment areas for corresponding roof apertures.

FIG. 46 is a top view of an embodiment of a roofed openwork animal transport enclosure of this disclosure.

FIG. 47 is a side view of an embodiment of a roofed openwork animal transport enclosure of this disclosure.

FIG. 48 is a side view of an embodiment of a roofed openwork animal transport enclosure of this disclosure.

FIG. 49 is a side view of an embodiment of a roofed openwork animal transport enclosure of this disclosure.

FIG. 50 is a bottom perspective view of an embodiment of a roof hatch of a roofed openwork animal transport enclosure of this disclosure.

FIG. 51 is a top view of an embodiment of a roof hatch of a roofed openwork animal transport enclosure of this disclosure.

FIG. 52 is a top perspective view of an embodiment of a resilient cover member for a roof aperture of a roofed openwork animal transport enclosure of this disclosure.

FIG. 53 is a bottom perspective view of an embodiment of a roof hatch of a roofed openwork animal transport enclosure of this disclosure illustrating a fluid outlet partially disposed there through.

FIG. 54 is a bottom perspective view of an embodiment of a roof hatch of a roofed openwork animal transport enclosure of this disclosure illustrating a pressurized hose of a fluid outlet disposed there through.

FIG. 55 is a top perspective view of a deck floor aperture and a corresponding deck floor aperture cover member of a roofed openwork animal transport enclosure of this disclosure depicting the deck floor aperture cover member in a non-mated position.

FIG. 56 is a top perspective view of a deck floor aperture cover member in a mated position with a deck floor aperture including an extraction tool in operable communication with the deck floor aperture cover member.

FIG. 57 is a flowchart illustrating a system of this disclosure.

### DEFINITIONS USED IN THE DISCLOSURE

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” or “essentially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within #1% of the stated value. In other embodiments, the value is within ±0.5% of the stated value. In other embodiments, the value is within ±0.1% of the stated value.

The term “and/or” includes any and all combinations of one or more of the associated listed items.

### DETAILED DESCRIPTION OF THE DISCLOSURE

For the purposes of promoting an understanding of the principles of the disclosure, reference is now made to the embodiments illustrated in the drawings and particular language will be used to describe the same. It is understood that no limitation of the scope of the claimed subject matter is intended by way of the disclosure.

The terms “first,” “second,” “third,” and the like, herein do not denote any order, quantity, or importance, but rather are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be.”

In regard to the use of a term in this disclosure in the singular and/or plural, persons of ordinary skill in the art can translate such term(s) from the singular to the plural and/or from the plural to the singular in accordance with the context of the disclosure. The inclusion of “(s)” after an element or a step indicates that one or more than one of such element or step is present with the understanding that each thereof is an independent aspect of the disclosure.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like. The use of the term “assembly” does not imply that the components or functionality described or claimed as part of an assembly are all necessarily configured in a common package.

As used in this specification and the appended claims, the term “animal” refers to any animal capable of being transported in an animal transport trailer, including, for example, one or more domesticated animals or one or more zoo animals. Herein, domesticated animals may be categorized as pets, livestock, or working or draft animals.

For purposes of this disclosure, the term “livestock” refers to domesticated animals maintained for productive purposes, such as for meat, milk, work, wool, hide, and/or combinations thereof. Livestock may include, but are not limited to, poultry (Aves), cattle (Bovine), sheep (Ovine), goats (Caprine), swine (Porcine), rabbits (Leporidae), and horses (Equine). Non-limiting examples of poultry include chickens, geese, ducks, and turkeys. The particular types of livestock transported by animal transport trailer may vary by area, region, or country. Accordingly, additional examples of animals that may be considered livestock for transport purposes may include, but are not limited to, alpacas, llamas, flightless birds such as ostriches and emus, musk oxen, and bovine animals such American bison, African buffalo and water buffalo.

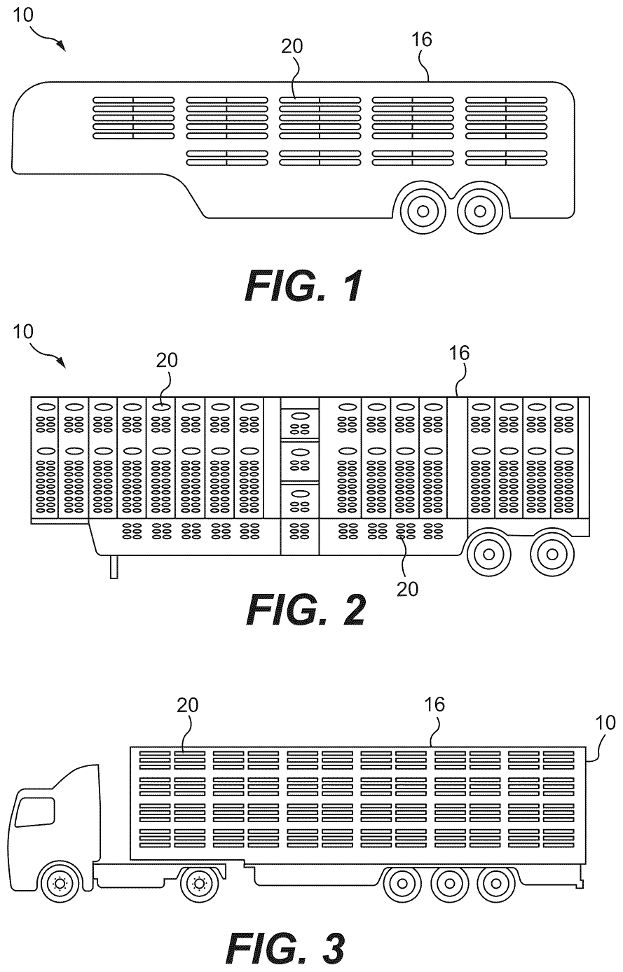

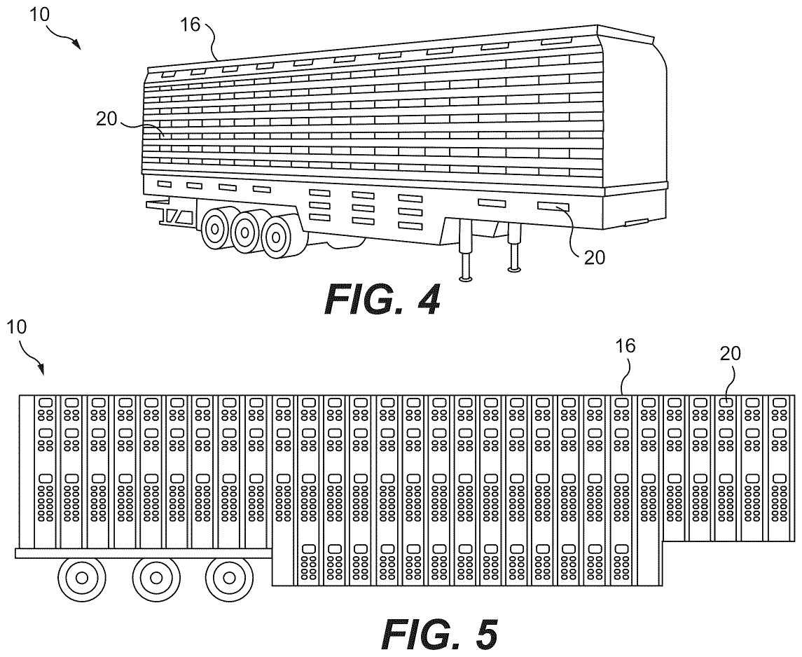

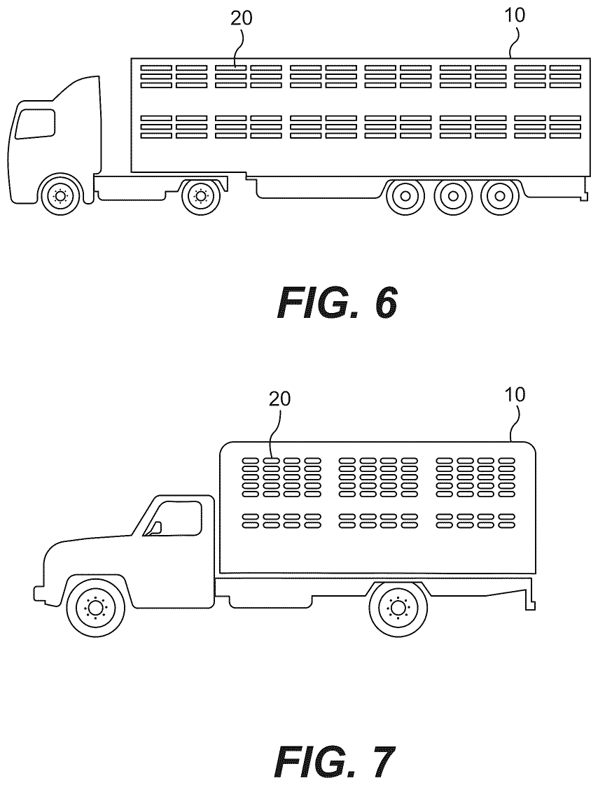

To date, various types of animal transport enclosures have been employed to move animals between locations. The enclosure selected for a particular operation may depend, at least in part, on factors such as the type of animal(s) being transported, the number of animals being transported, and the distance to be traveled. One commonly used enclosure includes an openwork towable trailer-type animal transport enclosure 10 as shown in the embodiments of FIGS. 1-6. Another includes a truck-mounted openwork enclosure 10 as shown in FIG. 7. As understood by persons of ordinary skill in the art of animal transport, the animal transport enclosures 10 of FIGS. 1-6 are generally referred to as “livestock trailers,” while the truck-mounted openwork enclosure 10 as shown in FIG. 7 is commonly referred to as a “livestock truck.”

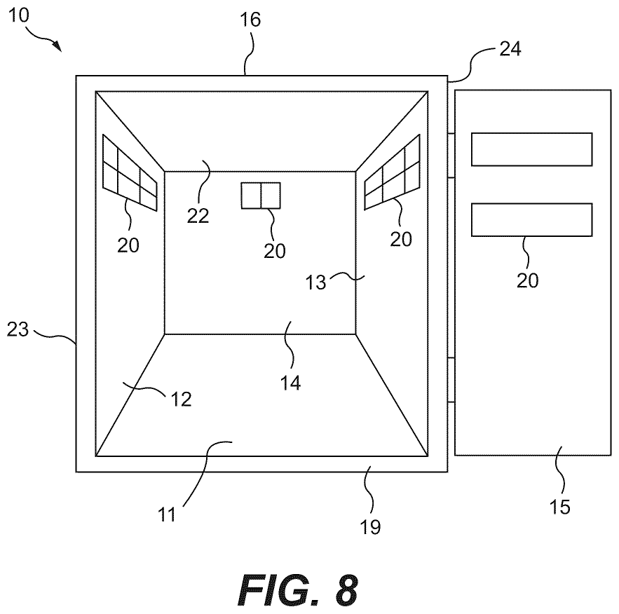

With reference to FIGS. 8-10, animal transport enclosures 10 commonly include a first bottom support surface or floor 11 and a vertical enclosure extending upward from the floor 11. The vertical enclosure typically comprises: (1) a left side wall having an interior surface 12 and an exterior surface 23; (2) a right side wall having an interior surface 13 and an exterior surface 24; (3) a forward wall 14; and (4) one or more doors 15 positioned at a rear end 19, such as swing doors, swing gates, slide gates, sliding doors, loading gates, or loading ramps. As further shown in FIGS. 8-10, commercially available animal transport enclosures 10 may include a closed top 16 (or “roof 16”) defining an interior upper surface or ceiling 22, while other enclosures may be provided as open-top configurations. Other commercially available animal transport enclosures 10 may be provided as open top animal transport enclosures. Non-limiting examples of open top animal transport enclosures are described in United States Patent Number U.S. Pat. No. 8,910,593 B2, titled “Livestock Trailer Corral Assembly,” issued Dec. 16, 2014; U.S. Pat. No. 5,174,240, titled “Livestock Trailer with Catch Gate,” issued Dec. 29, 1992; and United States Patent Number U.S. Pat. No. 6,792,892 B2, titled “Portable Pen for Shipping Livestock by Container Ship, Rail and Truck,” issued Sep. 21, 2004; each of which is herein incorporated by reference in its entirety.

For purposes of this disclosure, an animal transport enclosure 10 may be referred to as a “transport enclosure 10” or an “enclosure 10.” Likewise, an animal transport enclosure 10 having a roof 16 as shown in FIGS. 1-10 may be referred to as a “roofed transport enclosure 10” or a “roofed enclosure 10.”

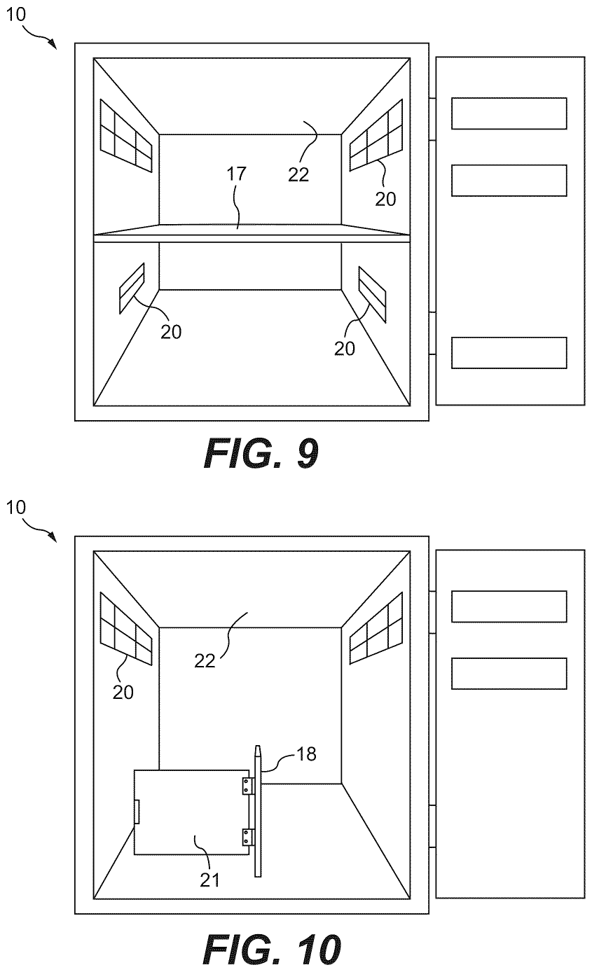

As shown in FIGS. 9 and 10, in an embodiment an enclosure 10 may include one or more interior surface features including, but not limited to, a second support surface (or “deck floor 17”) for holding one or more animals during transport, one or more vertical partitions or dividers 18, and/or combinations thereof. Other interior surface features may include, but are not limited to, one or more loading gates 21 configured to direct animals to various locations within an enclosure 10. Other exemplary components or items may include, but are not limited to interior lighting and mechanical ventilations systems.

As shown in the embodiments of FIGS. 1-10, enclosures 10 may be manufactured with openwork comprising one or more openings 20 in at least the left side wall 12 and/or the right side wall 13 to provide air ventilation to the interior of the enclosure 10. In an embodiment, an enclosure 10 including one or more openings 20 may be referred to herein as a “perforated enclosure 10,” comprising at least a perforated left side wall 12 and/or a perforated right side wall 13. In other embodiments, an enclosure 10 may be manufactured to include a forward wall 14 and/or one or more rear doors 15 having one or more openings 20. With reference to the embodiments of FIGS. 2 and 5, side openings 20 of an enclosure 10 may be referred to herein as “punch holes” describing the punched metal sheet material (e.g., punched aluminum sheet material) used to construct an enclosure 10 having an array of openings 20 in left side wall 12 and the right side wall 13. Enclosures 10 comprising punch holes are commonly referred to as “punch side” trailers. With reference to the embodiments of FIGS. 3, 4, and 6, one or more openings 20 may be provided in what is commonly referred to in the art as a “slat side” configuration, wherein such enclosures 10 are commonly referred to as “slat side” trailers. In an embodiment, the openwork of an enclosure 10 may include one or more openings 20 at one or more one or more locations in left side wall 12 and/or the right side wall 13, operable as one or more points of entry into an interior of an enclosure 10 for washing operations.

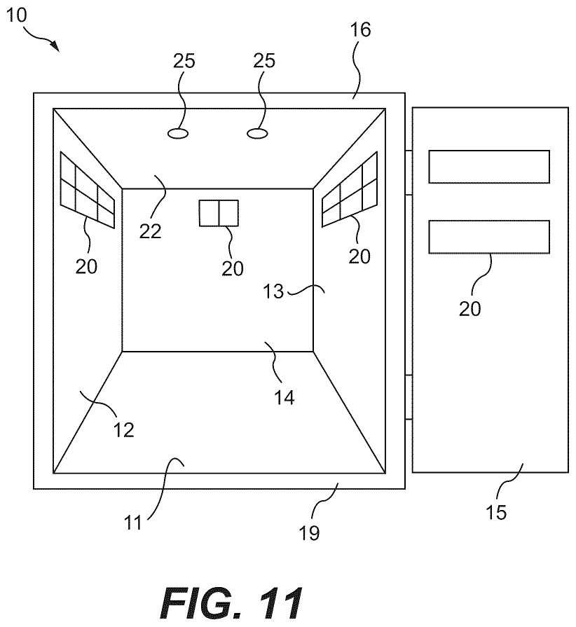

As understood by the skilled artisan, enclosures 10 as shown in the embodiments of FIGS. 1-10 are commonly manufactured to include a closed roof 16. As described below, in an embodiment one or more apertures 25 may be formed in a roof 16 of an enclosure 10 providing a perforated roof comprising one or more points of entry into an interior of an enclosure 10 for washing operations (see apertures 25 in FIG. 11). Accordingly, the present disclosure provides a versatile cleaning system configured for use with various types and sizes of enclosures 10. The system is adaptable to different opening 20 configurations, different roof 16 configurations, different exterior surface configurations, and different interior surface configurations, according to the type of contaminant(s) targeted for removal and/or destruction from the exterior and/or interior surfaces of the animal transport enclosures 10.

Without limiting the disclosure, contaminants to be removed and/or destroyed from an enclosure 10 may include, but are not limited to those recurrently encountered in animal transport operations and in portable enclosures generally. Exemplary contaminants include, but are not limited to: (1) animal waste materials such as animal feed waste, animal bedding waste, spilled potable liquids, excrement, blood, urine, nasal fluid, ocular fluid, fetal fluid, and other bodily fluids; (2) pathogens; (3) insects and insect waste; (4) arachnids (e.g., spiders, ticks, mites) and arachnid byproducts (e.g., spider webs); (5) odors; (6) pollens; (7) dust; (8) chemical poisons; (9) human generated debris, excrement, and bodily fluids; (10) hydrocarbon containing substances such as diesel fuel, gasoline, ethanol, and lubricants including oil, grease, penetrating lubricants, and dry lubricants; (11) animal medicinal solids, liquids, and semi-solids; (12) earth materials; (13) animal carcasses; and/or combinations thereof.

Non-limiting examples of pathogens include algae, bacteria, fungi, prions, viroids, viruses, parasites such as protozoans, parasitic worms, and fly larvae (e.g., screwworms). Non-limiting examples of bacteria include Mycobacterium bovis and spore-forming bacteria such as Bacillus anthracis. Non-limiting examples of viruses include Porcine Epidemic Diarrhea Virus (“PEDV”), Porcine Reproductive and Respiratory Syndrome (“PRRS”) and Influenza A viruses such as swine influenza virus (“SIV”), bovine respiratory syncytial virus (“BRSV”), bovine herpesvirus type 1 (“BHV-1”), bovine parainfluenza virus type 3 (“BPIV3”), bovine viral diarrhea virus, vesicular stomatitis virus (“VSV”), avian influenza virus type A (“H5N1”), and lyssaviruses. One non-limiting example of a protozoan includes Tritrichomonas foetus. Non-limiting examples of earth materials include, but are not limited to minerals, rocks, stones, gravel, mud, dirt, sand, clay, water, ice, and/or combinations thereof.

One or more pathogens described above may cause animal diseases that may be carried by animals located within an enclosure 10 of this disclosure (e.g., domestic animal diseases and/or foreign animal diseases, each of which may include one or more zoonotic diseases). Non-limiting examples of viral animal diseases include African swine fever (“ASF”), swine influenza, avian influenza (“AI”), foot-and-mouth disease, rabies, bovine ephemeral fever, sheeppox, goatpox, Newcastle disease, and/or combinations thereof. Non-limiting examples of bacterial animal diseases include brucellosis, anthrax, bovine tuberculosis, avian tuberculosis, contagious bovine pleuropneumonia, contagious caprine pleuropneumonia, and/or combinations thereof. Non-limiting examples of parasitic animal diseases include African trypanosomosis, bovine babesiosis, scabies, and/or combinations thereof. One non-limiting example of a prion-related disease includes bovine spongiform encephalopathy.

In describing a cleaning system of this disclosure, to “clean” an enclosure 10 refers to the use of one or more fluid streams and/or one or more manual contaminant removal techniques and/or one or more mechanical contaminant removal techniques and/or energy transfer to remove and/or eliminate contaminants from one or more interior and/or exterior surfaces of the enclosure 10. As described herein, in an embodiment, cleaning an enclosure 10 may include washing the enclosure 10, which may involve the turbulent action of one or more high pressure fluid streams and/or one or more low pressure fluid streams and/or one or more high temperature fluid streams and/or one or more low temperature fluid streams to remove contaminants from the interior surfaces and/or exterior surfaces of the enclosure 10. In an embodiment, cleaning an enclosure 10 may be defined as the removal of visible material, including organic material and/or inorganic material (e.g., dirt) from interior and/or exterior surfaces of the enclosure 10. In an embodiment, cleaning an enclosure 10 may include a microbicidal treatment, such as sanitizing the enclosure 10, which may be defined as reducing the number of pathogens present on the interior and/or exterior surfaces of the enclosure 10 to a non-harmful level suitable for animals to be subsequently placed within the enclosure 10. In an embodiment, cleaning an enclosure 10 may include a microbicidal treatment, such as disinfecting the enclosure 10, which may be defined as destroying or otherwise eliminating most or all pathogens, excluding bacterial spores, from the interior and/or exterior surfaces of the enclosure 10. In an embodiment, cleaning an enclosure may include heating the enclosure 10, or one or more surfaces thereof, by applying one or more heat treatments. In an embodiment, cleaning an enclosure 10 may include rinsing the enclosure 10 with one or more fluid streams to remove contaminants and/or post-wash residual substances from the interior surfaces and/or exterior surfaces of the enclosure 10. In an embodiment, the cleaning of an enclosure 10 may also be referred to as a “cleaning operation” or “treatment.” As such, the cleaning of a particular enclosure 10 may also be referred to as “treating” the enclosure 10 and/or “treating” one or more contaminants associated with the enclosure 10. In an embodiment, cleaning an enclosure 10 may include moisture removal (“drying”) of one or more surfaces of the enclosure 10 following washing, by methods such as air drying, suction drying, absorbent drying, and/or combinations thereof. Non-limiting examples of air drying include forced air drying, hot air drying, ambient air drying, and/or combinations thereof. Absorbent drying may be accomplished using one or more absorbent drying rollers, one or more absorbent towels, one or more absorbent paper products, one or more sponges, and/or combinations thereof. One or more absorbent towels may be constructed from materials including but not limited to, cotton, linen, bamboo, synthetic microfibers, and/or combinations thereof. One or more absorbent paper products may be constructed from materials including, but not limited to wood pulp. One or more sponges may include natural sponges comprised of flexible protein skeletons and/or synthetic sponges constructed from materials including, but not limited to, cellulose, polyester, plastic, and/or combinations thereof.

In an embodiment, cleaning an enclosure 10 may include manually removing one or more contaminants from an enclosure 10, mechanically removing one or more contaminants from an enclosure 10, sanitizing the enclosure 10, disinfecting the enclosure 10, rinsing the enclosure 10, drying the enclosure 10, exposing the enclosure 10 to electromagnetic radiation (e.g., ultraviolet light), air-blowing one or more contaminants out from the enclosure 10 (e.g., via an air blower), heating the enclosure 10, and/or combinations thereof.

Herein, “MPa” refers to megapascal; “kPa” refers to kilopascal; “psi” refers to pounds-force per square inch; “BSP” refers to British Standard Pipe; and “BSPP” refers to British Standard Pipe parallel or straight threads. “CMR” stands for “Convention Relative au Contrat de Transport International de Marchandises par la Route” as understood by the skilled artisan in the field of road and highway transport. “OE” refers to original equipment. “PLC” refers to a programmable logic controller or programmable controller. “GPM” refers to gallons per minute and “LPM” refers to liters per minute. “ISO” refers to the International Organization for Standardisation. “HMI” refers to Human Machine Interface. “GUI” refers to Graphical User Interface. Herein, “ppm” stands for parts per million and “nm” refers to nanometer. “PTFE” stands for polytetrafluoroethylene. “PFA” stands for perfluoroalkoxy. “DIN” stands for “Deutsches Institut für Normung,” which means “German institute for Standardization.” “Also known as” is abbreviated “aka” herein. “SAE” stands for Society of Automotive Engineers. Herein, “m/s” refers to meters per second and “ft/s” refers to feet per second. “N” refers to newton and “gf” refers to gram-force. Herein, “km/h” stands for kilometers per hour and “mph” stands for miles per hour. Herein, a forty-foot shipping container may also be referred to as a forty-foot container, a 40-foot container, a 12.19-meter container, or a 12.19-meter ISO container.

In an embodiment, the disclosure relates to a system and method for cleaning one or more enclosures 10 and/or other open-air containers. In an embodiment, the disclosure relates to a partly autonomous system for cleaning one or more enclosures 10 and/or other open-air containers that require one or more manual actions. In an embodiment, the disclosure relates to a wholly autonomous system for cleaning one or more animal transport enclosures 10 and/or other open-air containers. In an embodiment, a system may comprise one or more upstream fluid sources in fluid communication with one or more fluid outlets for directing one or more fluid streams onto one or more surfaces of animal transport enclosures 10.

In an embodiment, the disclosure relates to a system configured to clean a plurality of enclosures 10 that may vary in configuration, including variations in: (1) dimension, (2) interior surface configuration, (3) openwork configuration (e.g., the size, shape, and layout or pattern of one or more openings 20), (4) aperture 25 configuration along a roof 16, (5) roof-accessible pathway configuration of an enclosure 10 for receiving movable fluid outlets as described below, (6) materials of construction, and/or combinations thereof.

In an embodiment, the disclosure relates to a system configured to clean one or more enclosures 10, the system comprising a cleaning area including at least one cleaning bay for receiving and holding at least one animal transport enclosure 10. The cleaning bay may have one or more fluid outlets configured to apply one or more fluid streams onto one or more surfaces of the enclosure 10 from one or more points in space within the enclosure 10 (i.e., from one or more dispensing positions within the enclosure 10) and/or along the exterior of the enclosure 10 at one or more periods of time. In an embodiment, an operating distance in space of any one fluid outlet of the system from one or more particular target surfaces may vary during a cleaning operation.

In an embodiment, the disclosure relates to a system configured to position one or more fluid outlets within a roofed enclosure through one or more roof-accessible pathways at one or more dispensing positions selected according to the one or more interior surfaces to be impacted by one or more fluid streams during a cleaning operation. In such an embodiment, the interior surface configuration or layout of the roofed enclosure and the ability of the one or more fluid outlets to effectively apply the one or more fluid streams to the one or more interior surfaces together influence the placement of the one or more roof-accessible pathways, such that the one or more dispensing positions available to the one or more fluid outlets correspond to the one or more interior surfaces targeted for cleaning.

In an embodiment, the disclosure relates to a system configured to clean one or more enclosures 10, the system comprising a cleaning area that includes one or more cleaning bays, each cleaning bay comprising one or more adjustable fluid outlets and/or one or more fluid outlets that are moveable during operation and/or one or more fixed fluid outlets.

In an embodiment, the disclosure relates to a cleaning system including at least (1) a first cleaning area having one or more cleaning bays, each cleaning bay comprising one or more adjustable fluid outlets, and (2) one or more enclosures 10, each enclosure 10 having one or more apertures 25 in its roof 16 for receiving one or more of the adjustable fluid outlets there through into the enclosure 10 for cleaning one or more interior surfaces of the enclosure 10.

In an embodiment, the disclosure relates to a system for cleaning roofed enclosures 10, the system including at least (1) a first cleaning area having one or more cleaning bays, each cleaning bay comprising one or more fluid outlets, and (2) one or more roofed enclosures 10 fitted with one or more apertures 25 configured as upper access points of open access pathways disposed within each roofed enclosure 10. Each of the pathways allows for at least vertical travel of a corresponding fluid outlet from the roof 16 toward the floor 11 of the roofed enclosure 10. As such, in an embodiment, a roof-accessible pathway having an aperture 25 as an upper access point may also be referred to herein as “roof-accessible vertical pathway.”

In an embodiment, the disclosure relates to a method for cleaning one or more roofed enclosures 10 via a system comprising a cleaning area that includes at least one or more cleaning bays, each cleaning bay comprising one or more fluid outlets, for example, one or more adjustable fluid outlets and/or one or more fluid outlets moveable during operation and/or one or more fixed fluid outlets. In an embodiment, the method includes forming one or more apertures 25 in a roof 16 of one or more roofed enclosures 10 according, at least in part, to an interior surface configuration or layout of each roofed enclosure 10, thereby providing one or more points of entry for one or more fluid outlets into the interior of each roofed enclosure 10. Once a roofed enclosure 10 having one or more apertures 25 is located in a cleaning bay, one or more fluid outlets may be directed vertically downward through corresponding apertures 25 to one or more positions within the roofed enclosure 10 for cleaning one or more interior surfaces of the roofed enclosure 10. In an embodiment, the interior of a roofed enclosure 10 may be cleaned beginning with an upper part of the interior of the roofed enclosure 10 and then moving downward to clean a lower part of the interior of the roofed enclosure 10 last (i.e., top-to-bottom cleaning of the interior of the roofed enclosure 10).

In an embodiment, the disclosure relates to a system for cleaning interior surfaces of one or more roofed enclosures 10, each roofed enclosure 10 comprising one or more apertures 25 in the roof 16 that provide access points for fluid outlets of the system to the interior of the one or more roofed enclosures 10. In an embodiment, the system comprises low-pressure and/or high-pressure fluid outlets that are extendable and retractable through the apertures 25 for emitting low-pressure and/or high-pressure fluid onto one or more interior surfaces of the one or more roofed enclosures 10.

In an embodiment, the disclosure relates to a system for cleaning an enclosure 10, the system comprising a cleaning area including one or more cleaning bays in which an enclosure 10 is to be positioned for applying one or more cleaning applications. In an embodiment, the cleaning area, including each of the one or more cleaning bays, is scalable.

In an embodiment, the disclosure relates to a system comprising multiple cleaning areas, each cleaning area including one or more cleaning bays for applying one or more wash applications to multiple enclosures 10 simultaneously.

In an embodiment, the disclosure relates to a system for cleaning one or more enclosures 10, the system being configured to provide repeatable cleaning cycles at periods of time shorter than those realized using other cleaning techniques known at the time of this disclosure.

In an embodiment, the disclosure relates to a system under control of one or more operators for cleaning one or more interior surfaces and one or more exterior surfaces of one or more enclosures 10. Cleaning of the interior surfaces and exterior surfaces of the enclosures 10 may include mechanical contaminant removal techniques including, but not limited to, sweeping, mopping, scrubbing, sanding, scraping, vibrating, air blowing, vacuuming, and/or combinations thereof.

In an embodiment, the system, or a portion thereof, may be installed in an indoor facility, an outdoor facility, an open-air covered facility, and/or combinations thereof.

In an embodiment, and depending on the system installation, the system may include one or more illumination sources for use in an indoor cleaning installation or for outdoor system operation under low-light or nighttime conditions.

In an embodiment, the system may comprise one or more ultraviolet light sources for irradiating one or more interior surfaces and/or one or more exterior surfaces of one or more enclosures 10 with ultraviolet light at wavelengths from or about 100.0 nm to or about 400.0 nm for one or more periods of time.

In an embodiment, the disclosure relates to a system comprising one or more fluid outlets configured to provide low-pressure and/or high-pressure flowable or moveable liquids. In an embodiment, the one or more fluid outlets may be directed in space along X, Y, and Z axes for operation.

In an embodiment, the disclosure relates to a system configured to convey pressurized fluid up to or about 34473.8 kPa (5000.0 psi). For purposes of this disclosure, low-pressure fluid conveyed via the system includes fluid at pressures below 861.8 kPa (125.0 psi).

In an embodiment, the disclosure relates to a system and method for automated or partly automated cleaning of one or more enclosures 10 using a low volume of high-pressure fluid, wherein all system equipment, including but not necessarily limited to all fluid line components (e.g., fluid conduits such as hoses and piping, valves, couplings, seals and spray nozzles), is operationally dedicated for internal high-fluid-pressure use up to or about 34473.8 kPa (5000.0 psi).

In an embodiment, the disclosure relates to a roofed enclosure 10 having one or more apertures 25 disposed along the roof 16 in a layout determined, at least in part, by an interior surface configuration of the roofed enclosure 10. In an embodiment, each of the one or more apertures 25 may include a removable cover member. In an embodiment, each of the one or more apertures 25 may include a resilient cover member. In an embodiment, each of the one or more apertures 25 may include both a removable cover member and a resilient cover member.

In an embodiment, the disclosure relates to a roofed enclosure 10 having one or more apertures 25 disposed along the roof 16 in a layout determined, at least in part, by an interior surface configuration of the roofed enclosure 10, the layout including one or more apertures 25 located on a first side of a longitudinal center line of the roofed enclosure 10 and one or more apertures located on a second side of the longitudinal center line of the roofed enclosure 10.

In an embodiment, the disclosure is related to a roofed enclosure 10 having one or more apertures 25 disposed along the roof 16 of the roofed enclosure 10 forming one or more vertical pathways within the roofed enclosure 10 for one or more fluid outlets. In an embodiment, the disclosure is related to a multi-deck roofed enclosure 10 having one or more apertures 25 disposed along the roof 16 and one or more deck floor apertures as described below within the roofed enclosure 10 corresponding to the one or more apertures 25 collectively forming one or more vertical pathways for one or more fluid outlets.

In an embodiment, the disclosure is related to a roofed enclosure 10 comprising one or more elevated decks, wherein the roof 16 of the enclosure 10 includes one or more apertures 25 and the one or more elevated decks include one or more deck floor apertures corresponding to the one or more apertures 25 providing one or more vertical pathways for one or more fluid outlets.

In an embodiment, the disclosure is related to a multi-deck roofed enclosure 10 having one or more apertures 25 and one or more deck floor apertures providing one or more vertical pathways for one or more fluid outlets, including one or more vertical pathways of a first length or depth within a multi-deck roofed enclosure 10 and one or more vertical pathways of at least a second length or depth within the multi-deck roofed enclosure 10.

In an embodiment, the disclosure is related to a multi-deck roofed enclosure 10 having one or more roof hatches and one or more deck floor hatches vertically aligned with one or more of the one or more roof hatches providing one or more vertical pathways for one or more fluid outlets, including one or more vertical pathways of a first length or depth within a multi-deck roofed enclosure 10 and one or more vertical pathways of at least a second length or depth within the multi-deck roofed enclosure 10.

In an embodiment, the disclosure is related to a multi-deck roofed enclosure 10 having at least one roof hatch and at least one deck floor hatch vertically aligned with the at least one roof hatch providing at least one vertical pathway for at least one fluid outlet into the interior of the multi-deck roofed enclosure 10.

In an embodiment, the disclosure is related to a multi-deck roofed enclosure 10 having one or more sealable roof hatches and/or one or more sealable deck floor hatches collectively forming on or more vertical pathways within the multi-deck roofed enclosure 10 for one or more retractable fluid outlets.

In another embodiment, the disclosure is related to a system for cleaning the interior of one or more roofed enclosures 10, wherein the one or more roofed enclosures 10 of the system are characterized by one or more apertures 25 disposed along the roof 16 for use as access points for one or more fluid outlets of the system. In an embodiment, the one or more fluid outlets are moveable along at least X and Y axes for (1) aligning the one or more fluid outlets with one or more target apertures 25, (2) introducing the one or more fluid outlets into a roofed enclosure 10 through corresponding target apertures 25 along a Z axis and (3) withdrawing the one or more fluid outlets out from the corresponding target apertures 25 along the Z axis.

In an embodiment, the one or more fluid outlets of a system of this disclosure may be directed along at least X and Y axes to direct one or more liquid streams in one or more desired directions within a roofed enclosure 10. In another embodiment, the one or more fluid outlets may comprise spray nozzles that may be oriented to direct one or more fluid streams in one or more desired directions within a roofed enclosure 10. In another embodiment, the one or more fluid outlets may include fluid outlets comprising self-rotating, self-propelled or free spinning spray nozzles for emitting pressurized fluid streams providing rapidly repeating impacts against one or more target interior surfaces within a roofed enclosure 10.

In another embodiment, the disclosure is related to a system for cleaning interior surfaces of one or more roofed enclosures 10 characterized by one or more apertures 25 for use as access points for one or more fluid outlets of the system. In an embodiment, the one or more fluid outlets are moveable along at least X, Y, and Z axes for (1) aligning the one or more fluid outlets with one or more target apertures 25, (2) introducing the one or more fluid outlets vertically into a roofed enclosure 10 through corresponding target apertures 25, and (3) withdrawing the one or more fluid outlets vertically out from the target apertures 25.

In another embodiment, the disclosure is related to a system operational at low internal fluid pressures and at high internal fluid pressures ranging from or about 275.8 kPa (40.00 psi) up to or about 34473.8 kPa (5000.0 psi). In another embodiment, the disclosure is related to a system operational at low internal fluid pressures and at high internal fluid pressures ranging from or about 3447.4 kPa (500.00 psi) up to or about 34473.8 kPa (5000.0 psi). In another embodiment, pressurized fluid may be conveyed from one or more fluid sources of the system via one or more pumps. In another embodiment, pressurized fluid may be produced via gravity, including one or more elevated fluid sources of a volume and positioned at one or more elevations for producing desired pressurized fluid flow of the system.

In another embodiment, the disclosure is related to a system for cleaning one or more enclosures 10, the system including one or more fluid sources housing one or more fluids and one or more fluid drains and/or fluid collection containers and/or fluid reclamation systems. In an embodiment, the system may include one or more filters and/or filter systems for filtering fluid collected for disposal and/or reclamation purposes.

In another embodiment, the disclosure is related to a system comprising an installation for cleaning one or more enclosures 10 using one or more pressurized fluid streams directed according to the interior and/or exterior surface configuration of each enclosure 10. Suitably, the distribution of the pressurized fluid conveyed or emitted into a particular enclosure 10 during a washing application prevents or minimizes the occurrence of “dead spots” or “shadows” (i.e., interior areas of an enclosure 10 where fluid does not flow with intended cleaning effectiveness and/or where fluid flow stagnates), which would otherwise require adjustment of one or more pressurized fluid streams for one or more secondary washing applications of the one or more dead spots.

In another embodiment, the disclosure is related to a system for cleaning one or more enclosures 10 wherein the system may be provided as a permanent installation or as a portable installation.

In another embodiment, the disclosure is related to a system having computer-based electronic controls (e.g., a PLC), for providing programmable cleaning operations and safeguards for operating temperatures, chemical usage, and fluid pressure.

In another embodiment, the disclosure is related to a system for cleaning one or more enclosures 10 that may further include one or more manual cleaning operations by one or more persons for removing one or more particular contaminants from within an enclosure 10 (e.g., large contaminants and physical objects).

In another embodiment, the disclosure is related to a system for cleaning one or more enclosures 10, the system comprising at least (1) control circuitry, (2) one or more cleaning fluid dispensing systems, and (3) one or more upstream pressurized fluid sources in fluid communication with the one or more cleaning fluid dispensing systems via one or more upstream fluid lines. In an embodiment, the fluid delivered from the one or more pressurized fluid sources is conveyed to the one or more cleaning fluid dispensing systems via the one or more upstream fluid lines at an internal fluid pressure from or about 40.0 psi to or about 5000.0 psi to produce fluid streams applied to one or more interior surfaces and/or one or more exterior surfaces of the one or more enclosures 10 without atomization of the fluid jet streams. The period of time for a particular cleaning operation may be programmed as desired, including the use of one or more individual fluid wash cycles at one or more periods of time.

In another embodiment, the disclosure is related to a system for cleaning one or more enclosures 10, the system comprising an automation and control system including a telemetry and operations package providing system users with real-time cleaning operation reports and to allow system users to remotely diagnose any system operational alarms. In another embodiment, the system may include remote video monitoring and/or third-party observation and/or inspection of cleaning operations.

In another embodiment, the disclosure is related to a system having a recycling system whereby washing water of the system may be reused without end by way of the recycling system.

In another embodiment, the disclosure is related to a system for cleaning one or more target surfaces including at least one or more interior surfaces of one or more enclosures 10, wherein the one or more interior surfaces may include, but are not limited to, floors, sidewalls, doors, gates (including, but not limited to divide gates), forward walls, rear walls, interior walls, ceilings, sprinkler systems, support beams, loading ramps, surface cracks of varying size, surface holes of varying size, door and/or gate hinges, stalls, lights, cages, windows, concealed surfaces, deck plates (also referred to as deck boards or deck planks), winter boards (also referred to as winter panels), drain plugs, electrical components, ventilation system components, storage boxes, drinker systems, and/or combinations thereof.

In another embodiment, the disclosure is related to a system for cleaning one or more exterior surfaces of one or more enclosures 10 wherein the one or more exterior surfaces may include, but are not limited to, sidewalls, rear walls, forward walls, roofs, lights, reflectors, chassis, bumpers, loading ramps, ladders, storage boxes, doors, gates, wheels, wheel nuts, rims, tires, winter boards, mud flaps, decals, steps, windows, handles, railing, one or more undercarriage surfaces, and/or combinations thereof.

In another embodiment, the disclosure is related to a system for cleaning one or more interior and one or more exterior surfaces of one or more enclosures 10 without damaging interior and/or exterior surface finishes such as polished surfaces, painted surfaces, coated surfaces, anodized surfaces, galvanized surfaces, sealed surfaces, and/or combinations thereof.

Various embodiments of a system of the present disclosure are described below. Although a system described herein may be configured to clean a plurality of vehicles, towable items, and rail freight containers, amongst other items, a system is described here forward in terms of cleaning one or more enclosures 10.

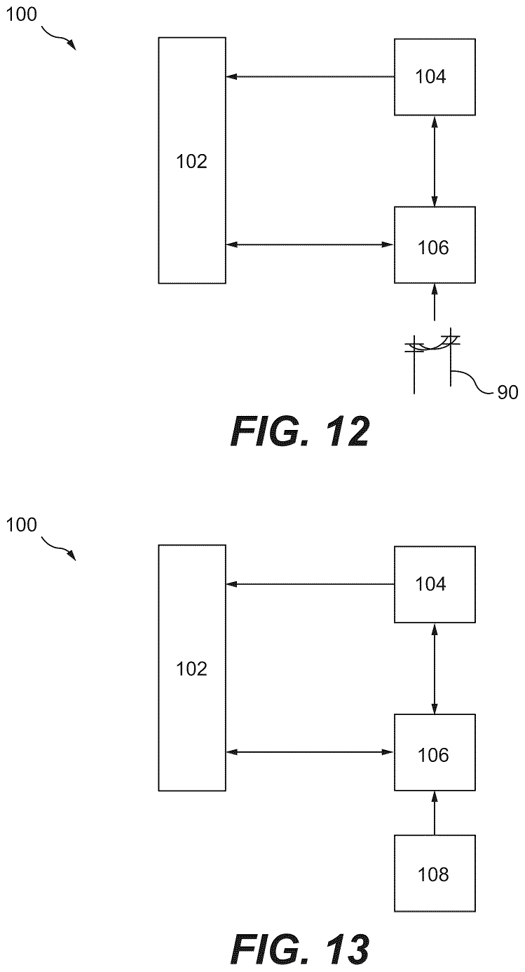

Referring now to FIG. 12, an embodiment of a system 100 of this disclosure is provided. In this embodiment, the system 100 includes at least (1) a cleaning area comprising one or more cleaning bays 102 configured to accommodate one or more enclosures 10 of various size and/or shape and/or type, (2) a fluid delivery system 104 for providing one or more fluids to the one or more cleaning bays 102, and (3) a control system 106 including programmable command and control circuitry in electrical communication with various components of the system 100 for executing one or more functions. In an embodiment, a system 100 of this disclosure may be powered via a local power distribution grid (or “electrical grid 90”).

In an embodiment as depicted in FIG. 13, a system 100 of this disclosure may comprise one or more standalone power sources 108 in electrical communication with the control system 106 and configured as a feed source of electric power for the system 100. In another embodiment, a system 100 of this disclosure may be powered via an electrical grid 90 and optionally via one or more standalone power sources 108. As described herein, a system 100 of this disclosure may be provided as part of an original-construction cleaning facility or installation. A system 100 of this disclosure may also be provided as a retrofit-type installation of an existing structure including, but not limited to, (1) an existing cleaning facility or former cleaning facility for enclosures 10, (2) an existing cleaning facility or former cleaning facility for towable tanks (e.g., food tanks, fuel tanks, chemical tanks, dry bulk tanks), (3) an existing structure repurposed for cleaning enclosures 10, and (4) one or more open areas having a roof, canopy, cover, or overhang.

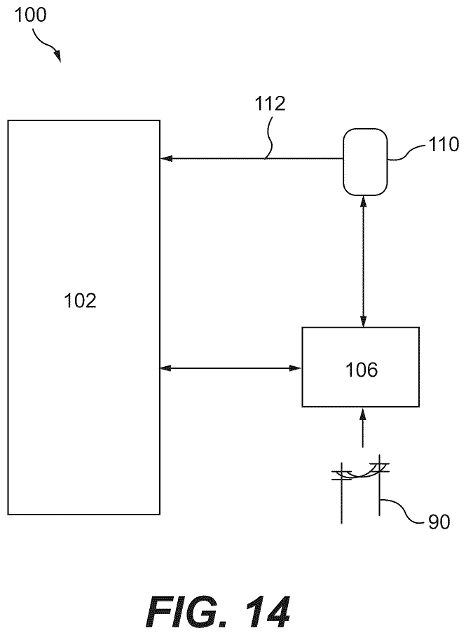

As described herein, a fluid delivery system 104 is configured to provide one or more pressurized fluids (i.e., pressurized liquids and/or liquid solutions) in one or more volumes, at one or more pressures, and at one or more temperatures as desired or as otherwise required for one or more cleaning operations. With reference to FIG. 14, in one embodiment a fluid delivery system 104 may include (1) a cleaning fluid system 110 that houses and/or otherwise provides one or more cleaning fluids and cleaning fluid ingredients, and (2) one or more fluid lines 112 for conveying pressurized cleaning fluid from the cleaning fluid system 110 to one or more cleaning bays 102. In an embodiment, pressurized cleaning fluid may be produced via gravity by locating a cleaning fluid system 110 at one or more altitudes higher than the corresponding one or more cleaning bays 102. In another embodiment, pressurized cleaning fluid may be pumped from a cleaning fluid system 110 to one or more cleaning bays 102. In another embodiment, pressurized cleaning fluid may be delivered to one or more cleaning bays 102 via a combination of an elevated cleaning fluid system 110 and fluid pumping action.

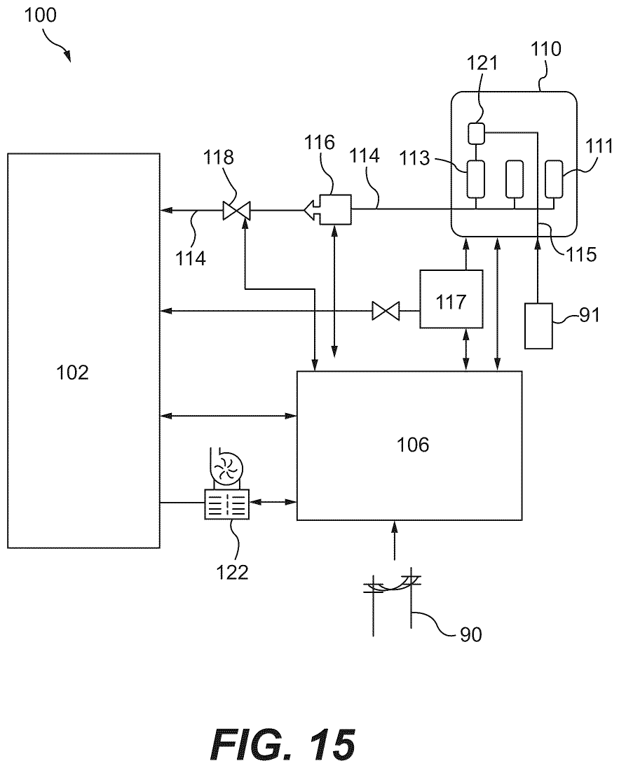

Referring to FIG. 15, in an embodiment a cleaning fluid system 110 may include one or more storage containers 111 in fluid communication with one or more water sources 91 via one or more water lines 115 and also in fluid communication with the one or more fluid lines 112. In an embodiment, the cleaning fluid system 110 may also include one or more water heating systems 121 including one or more heaters and/or one or more boilers and related conduits in fluid communication with (1) one or more water sources 91 and (2) a container 113 of the one or more storage containers 111 designated as a hot water source of the system 100. In an embodiment, a water heating system 121 may include (1) a boiler (e.g., a natural gas boiler), and (2) a plate heat exchanger. In an embodiment, one or more water sources 91 may include, but are not limited to, one or more water wells, water storage tanks, retention ponds, municipal water sources (i.e., public water lines), and/or combinations thereof.

As shown in FIG. 15, the one or more fluid lines 112 may include an assembly comprising (1) one or more fluid conduits 114 (e.g., piping and/or hose), (2) one or more fluid pumps 116, (3) one or more valves 118 and corresponding seals and/or welds and/or couplings for controlling the conveyance of pressurized cleaning fluid up to or about 5000.0 psi from a cleaning fluid system 110 to one or more cleaning bays 102. In one embodiment, the one or more fluid lines 112 and/or the one or more water lines 115 may include conduit such as stainless-steel pipe, PVC pipe, CPVC pipe, copper pipe, and/or combinations thereof, and/or one or more high pressure hoses, and/or combinations thereof. In addition, one or more fluid lines of a system 100 of this disclosure, including the one or more fluid lines 112 and/or the one or more water lines 115, may be insulated, and optionally, heat traced to prevent freezing of the one or more fluid lines. Suitable insulation includes industrial pipe insulation configured to form a barrier between the contents of the fluid lines and the ambient environment at temperatures as low as or about −40.0° C. (−40.0° F.). Suitable heat traces may include self-regulating heating cables. In an embodiment, heat tracing may also be employed via one or more constant-wattage heating cables and/or heating tape (e.g., FailSafe Super (“FSS”) heating cable, Freezstop Extra (“FSE”) heating tape, as well as Chromalox® hot-water maintenance heat trace cable, Chromalox® CPR heating cable, and Chromalox® CZH heating cable commercially available from Chromalox, Inc., Pittsburgh, Pennsylvania, U.S.A.).

Still referring to FIG. 15, the system 100 may also include a pneumatic system 117 configured to produce compressed air for operating any pneumatic equipment that may be included as part of the system 100. The system 100 may also include one or more dryers 122 in fluid communication with one or more cleaning bays 102.

Suitable one or more fluid pumps 116 may include, but are not limited to, one or more centrifugal pumps, one or more positive displacement pumps, and/or combinations thereof. An example of a positive displacement pump may include, but is not limited to, a reciprocating pump such as a plunger pump. Suitable valves 118 may include, but are not limited to, ball valves, metering valves, butterfly valves, gate valves, globe valves, diaphragm valves, solenoid valves, angle seat valves, and/or combinations thereof.

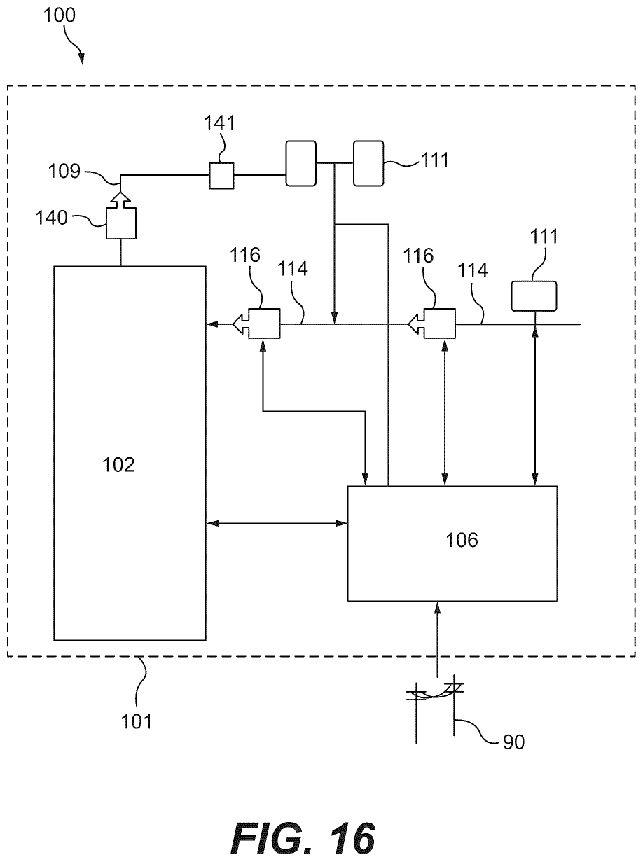

For purposes of this disclosure, the configuration and/or layout of a particular system 100 may vary according to one or more cleaning specifications and/or location considerations, including, but not limited to, (1) one or more laws and/or regulatory requirements and/or restrictions, (2) available space for new system 100 construction (e.g., surface area availability of a new site), (3) zoning requirements for new construction, and (4) the layout of an existing facility or structure to be repurposed for system 100 use (e.g., ceiling height, entrance and exit locations, exterior and/or interior wall configurations, plumbing configurations, electrical system configurations, and floor space). For example, in an embodiment as shown in FIG. 15, a cleaning fluid system 110 may include one or more storage containers 111 located in a common area or space upstream of the one or more fluid lines 112 (see one or more fluid conduits 114) and one or more cleaning bays 102. In another embodiment, a cleaning fluid system 110 may include one or more storage containers 111 located in one or more first locations of an installation 101 and one or more storage containers 111 located in one or more second locations upstream of the one or more fluid lines 112 and one or more cleaning bays 102 (see FIG. 16).

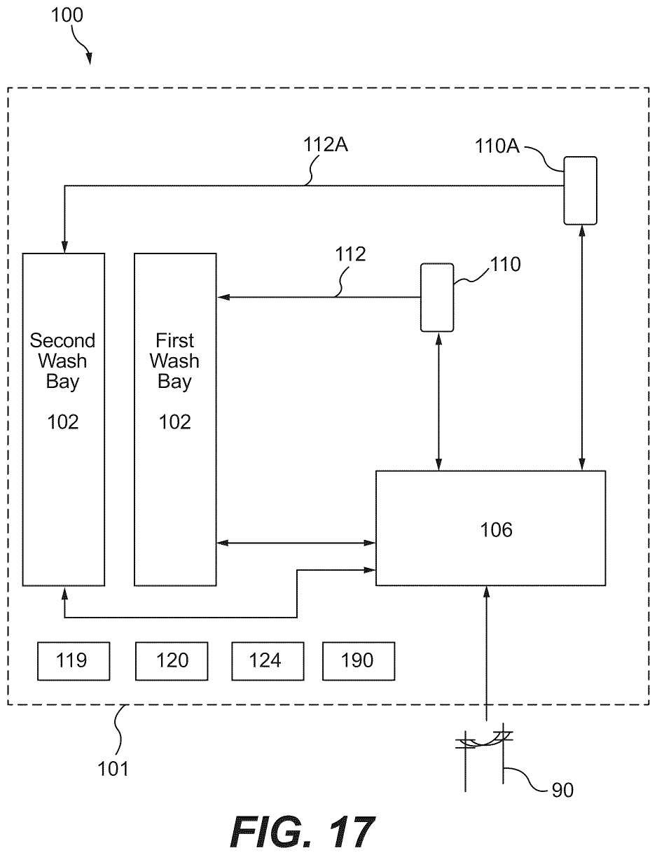

In another embodiment, a system 100 may include a second cleaning fluid system 110A separate from a first cleaning fluid system 110 and configured to supply one or more second cleaning bays 102 via one or more second fluid lines 112A as shown in FIG. 17. As further shown in FIG. 17, in an embodiment a system 100 may include one or more drying bays 119 for drying of enclosures 10 post wash. In an embodiment, a drying bay 119 may include one or more aeration fans configured to blow ambient and/or heated filtered air within the drying bay 119.

As further shown in FIG. 17, in an embodiment a system 100 may include one or more baking bays 120 configured to heat enclosures 10 post-wash at one or more temperatures for one or more periods of time to ensure microbicidal activity. In an embodiment, a system 100 may also include one or more steam bays 124 configured to heat enclosures 10 post wash at one or more temperatures for one or more periods of time to ensure microbicidal activity. In an embodiment, a system 100 may also include one or more UV bays 190 configured to emit ultraviolet light onto exterior surfaces and/or interior surfaces of enclosures 10 for one or more periods of time to ensure microbicidal activity.

For treating one or more contaminants as described above, the one or more storage containers 111 may house one or more cleaning fluids, for example, one or more water variants, one or more liquid chemicals, one or more liquid chemical solutions, one or more enzymatic cleaning solutions, and/or combinations thereof, configured to be delivered to one or more cleaning bays 102 via the one or more fluid lines 112 in separate feeds or as compositions of one or more liquid solutions in one or more volumes and at one or more fluid pressures and at one or more temperatures (collectively “cleaning fluid specifications”) effective to treat one or more target contaminants on one or more surfaces of one or more enclosures 10. In addition, a system 100 of this disclosure may further include one or more storage containers 111 housing one or more additives for producing one or more cleaning fluids. Herein, the one or more cleaning fluids and the one or more additives of this disclosure may be referred to collectively as one or more “washing chemicals.”

Exemplary storage containers 111 may include, but are not limited to, underground storage tanks, above-ground storage tanks, above-ground storage containers, above-ground closed vessels, mixers, blenders, and/or combinations thereof configured to be fluidly communicated together and/or with the one or more fluid lines 112 of the system 100. Exemplary underground storage tanks may include refillable liquid vertical storage tanks and/or horizontal storage tanks. Exemplary above-ground storage tanks may include refillable fixed storage tanks, refillable portable storage tanks, prefilled replacement storage tanks, and/or combinations thereof. Exemplary above-ground storage containers may include refillable storage containers, prefilled replacement storage containers, and/or combinations thereof. Exemplary above-ground fixed storage tanks may include vertical and/or horizontal ground storage tanks, vertical and/or horizontal elevated storage tanks, and/or combinations thereof. Exemplary portable storage tanks may include skid-based storage tanks, pallet-based storage tanks, and/or combinations thereof.

An example of a prefilled replacement storage container includes what is commonly referred to by persons of ordinary skill in the art as an “intermediate bulk container” or “IBC” (also commonly referred to as an “IBC tank,” “IBC tote,” or “pallet tank”). Another example of a replacement storage container that may be refillable or provided as a prefilled container includes a drum comprising a spigot or faucet (e.g., a 200.0 liter drum (55.0 gallon drum)). Still another example of a replacement storage container that may be refillable or provided as a prefilled container includes an intermodal tank or “ISO tank.”

Above-ground storage containers of this disclosure may be configured to hold one or more liquids, one or more solids, one or more semi-solids, one or more gels, one or more pastes, and one or more gases as described below. One non-limiting example of an above-ground storage container for holding solids includes a solids settling cone storage tank (i.e., a cone-bottom silo storage tank). Examples of above-ground closed vessels include one or more pressure vessels, one or more boilers, one or more water softeners, and/or combinations thereof.

The volume of any one storage container 111 of the system 100 may be provided as desired or as may otherwise be required for one or more particular known cleaning operations and/or anticipated cleaning operations of the system 100.

The materials of construction of any one storage container 111 may depend on the type(s) of materials to be stored therein. Exemplary materials of construction may include, but are not limited to, one or more metals, one or more plastics, glass-reinforced plastic, one or more cementitious materials, one or more composite materials, one or more woods, glass, and/or combinations thereof. Exemplary metals may include, but are not limited to, carbon steel, stainless steel, galvanized steel, copper, brass, aluminum, nickel, titanium, and/or combinations thereof. Exemplary plastics may include, but are not limited to acrylic resin, polyethylene, polypropylene, polyvinyl chloride, and/or combinations thereof.

One or more storage containers 111 of this disclosure may also include one or more drop-in liners, polyurea liners, other chemical-resistant coatings on the interior surface of a container, and/or combinations thereof. In one exemplary embodiment, cold water stored as part of a cleaning fluid system 110 may be stored in a 3785.41 liter (1000.0 gallon) polypropylene tank, and hot water stored as part of a cleaning fluid system 110 may be stored in a 24983.72 liter (6600.00 gallon) ISO tank. In one embodiment, an ISO tank for storing hot water may be located at an altitude higher than the altitude(s) of the one or more cleaning bays 102 in fluid communication with the ISO tank. In one exemplary embodiment, chemicals stored as part of a cleaning fluid system 110 may be stored in an IBC (e.g., a 1000.0 liter (264.2 gallon) IBC, a 1041 liter (275.0 gallon) IBC).

Exemplary variants of water that may be stored for use via the cleaning fluid system 110 include, but are not limited to, (1) cold water at temperatures of or about 15.0° C. (59.0° F.) or less; (2) hot water at temperatures of or about 43.0° C. (109.4° F.); (3) tap water; (4) surface water; (5) groundwater; (6) collected rainwater; (7) purified water (e.g., distilled water, filtered water); (8) hard water (e.g., 100.0 ppm or greater); (9) soft water (e.g., 50.0 ppm or less); (10) acidic water (e.g., pH less than 7.0); (11) alkaline water (e.g., pH greater than 7.0); (12) neutral water (e.g., pH of 7.0); and/or combinations thereof. Depending on the type(s) of water provided for system 100 operation, water may be delivered via truck transport for refilling one or more fluid storage containers 111 on-site, and/or one or more prefilled fluid storage containers 111 may replace one or more empty fluid storage containers 111, and/or water may be pumped into one or more storage containers 111, and/or water may be fed to one or more storage containers 111 via one or more water sources 91. In one embodiment, the system 100 may use soft water effective to increase the operational lifespan of one or more system 100 components such as system 100 pumps.

Exemplary liquid chemicals that may be stored for use via the cleaning fluid system 110 include, but are not limited to, hydrogen peroxide, chloroxylenol, chlorohexidine, oxygenated solvents, hydrocarbon solvents, halogenated solvents, and/or combinations thereof. Other examples of solvents that may be provided for system 100 operation include, but are not limited to the one or more water variants described above, isopropyl alcohol, glycol ethers, D-Limonene, and/or combinations thereof. For purposes of this disclosure, hydrogen peroxide may be provided at one or more concentrations and/or diluted via mixing with one or more other liquids and/or liquid solutions of the cleaning fluid system 110. Suitably, the one or more liquid chemicals may be delivered from one or more storage containers 111 to the cleaning bay 102 at temperatures ranging from or about 30.0° C. (86.0° F.) up to or about 65.0° C. (149.0° F.).

Exemplary liquid chemical solutions that may be stored for use via the cleaning fluid system 110 include, but are not limited to one or more acidic solutions, one or more alkaline solutions, one or more pH neutral solutions, one or more enzymatic solutions, and/or combinations thereof. One or more acidic solutions may include, but are not limited to one or more acetic-acid-based (vinegar) solutions, one or more citric acid based (lemon) solutions, and/or combinations thereof. One or more alkaline solutions may include, but are not limited to, one or more water-based degreasers, one or more solvent-based degreasers, potassium hydroxide solutions, sodium hydroxide solutions, and/or combinations thereof. Exemplary enzymatic solutions may comprise proteases, amylases, lipases, and/or combinations thereof.

Exemplary additives that may be stored for use via the cleaning fluid system 110 include, but are not limited to one or more solids, one or more semi-solids, one or more gels, one or more pastes, one or more gases, one or more liquids, and/or combinations thereof. Non-limiting examples of additives include surfactants, chloroxylenol, chlorohexidine, triclosan, and/or combinations thereof. Exemplary surfactants include, but are not limited to, nonionic surfactants, anionic surfactants, and/or combinations thereof. Exemplary nonionic surfactants include, but are not limited to, alcohol ethoxylates, alkyl phenol ethoxylates, fatty acid ethoxylates, monoalkaolamide ethoxylates, sorbitan ester ethoxylates, fatty amine ethoxylates, polymeric surfactants, alkyl polyglycosides, and/or combinations thereof. Exemplary anionic surfactants include, but are not limited to, alcohol ether sulfates, sodium lauryl sulfate, sodium laureth sulfate, ammonium lauryl sulfate, ammonium laureth sulfate, and/or combinations thereof. In addition, one or more surfactants of this disclosure may include one or more biodegradable surfactants.

As stated above, a system 100 of this disclosure may include a control system 106 comprising programmable command and control circuitry in electrical communication with various components of the system 100. Suitable programmable command and control circuitry may include one or more computer-based controls (e.g., a PLC) in electrical communication and/or wireless communication with various equipment and/or components of the one or more cleaning bays 102, the cleaning fluid system 110, one or more fluid lines 112, one or more standalone power sources 108 when applicable, and the pneumatic system 117.

In one embodiment, a control system 106 may include one or more PLCs and one or more other user interfaces (1) located at an on-site control station (e.g., a control room or control van) and/or (2) located remotely for the purpose of measuring, monitoring, protection, detection, control, and management of system 100 processes. Examples of user interfaces include, but are not limited to, one or more control panels (e.g., console control panels, a motor control center (“MCC”) for controlling one or more electric motors of the system 100), one or more switch lockout devices for use when servicing electric motors, one or more pneumatic controls, and one or more emergency stops.

In an embodiment, a PLC may be used to control system 100 equipment including, but not limited to, one or more variable frequency drives (“VFD”) or other controllers for activating and deactivating the one or more fluid pumps 116, pneumatic controls and pneumatic actuators of a pneumatic system 117, one or more boilers, and one or more illumination sources (e.g., one or more LED light sources). A PLC may also be used for system 100 error logging and controlling washing chemicals dosing of one or more storage containers 111. A PLC may include and/or otherwise access one or more databases configured to store cleaning program and cleaning parameter information.

Each of the one or more cleaning bays 102 may comprise at least one HMI controller in electrical communication with the PLC for operator(s) to start, stop, and monitor cleaning bay 102 operations. In one embodiment, an HMI may include a selection menu allowing an operator to select one or more particular cleaning programs according to one or more cleaning parameters including, but not limited to, (1) the type of enclosure 10 located in the cleaning bay 102; (2) the level of fouling for each enclosure 10 located in the cleaning bay 102, for example, (a) the type and/or state of one or more contaminants located on one or more exterior and/or one or more interior surfaces of the enclosure 10, (b) the amount and distribution of contamination located on one or more exterior and/or one or more interior surfaces of the enclosure 10 (e.g., low level contamination, medium level contamination, high level of contamination, uneven distribution, even distribution), and (c) the location of one or more contaminants along the exterior and/or interior surfaces of the enclosure 10; and (3) one or more other surface cleaning requirements (e.g., washing requirements or standards, sanitization requirements or standards, disinfecting requirements or standards). Legal and/or regulatory type factors may also determine one or more particular cleaning programs based on the location of a particular system 100 (e.g., a system 100 that is located in a state of the United States compared to a system 100 located in Canada and/or other country).

In one embodiment, an on-site control station of a control system 106 may include what may be referred to herein as a technical room provided in an open area or provided within an enclosed structure (e.g., a forty-foot container or other housing), operationally configured to house an MCC and computer-based controls including one or more user interfaces and a hardware and/or software program in communication with the system 100 control circuitry for handling cleaning operations from acceptance of an enclosure 10 through invoicing. One or more user interfaces may be used for manually programming an enclosure 10 cleaning operation. To minimize operational and human errors, the software may include automatic programming selections and controls for employing a particular cleaning operation at a desired time interval according to the types and amounts of one or more contaminants of a particular enclosure 10. The software may also be programmed with safety regulations, requirements, and instructions for a system 100 operator in regard to a target enclosure 10.

The information entered into a software program of the system 100 suitably enables required cleaning by continuously recording information from the hardware. By way of one or more user interfaces, information such as system 100 diagnostics, system 100 errors (e.g., alarms), the operation of the one or more fluid pumps 116, the one or more valves 118, the operation of one or more water heating systems 121, fluid flow rate, the operation of one or more manually operable fluid outlets 137 (see FIG. 26), dosing of one or more cleaning fluids and/or cleaning fluid ingredients, the ambient temperature, and the temperature of one or more storage containers 111, one or more water lines 115, and one or more fluid lines 112 may be continuously recorded via one or more sensors and measuring instruments (e.g., output control). The information may be continuously validated during operation. If one or more of the cleaning programs do not meet required or set values, the software program may repeat a previous cleaning program step. By this principle, the quality and assurance of the entire cleaning process of an enclosure 10 may be monitored and recorded.

A system 100 of this disclosure may also employ a telemetry and operations package configured to provide users with real-time cleaning operation reports and to allow for remote system 100 diagnostics.

In an embodiment, the system 100 may include a video monitoring system (e.g., a remote video system) for monitoring cleaning operations via one or more cameras installed at the one or more cleaning bays 102 and/or at other system 100 locations. In an embodiment, the system 100 may include one or more machine-learning algorithms and/or other artificial-intelligence-based image-analysis techniques configured to detect visible contaminants and/or one or more other conditions using a video monitoring system. Such artificial-intelligence-based techniques may include, but are not limited to, computer-vision models, pattern-recognition algorithms, object-detection models, anomaly-detection models, and/or combinations thereof, configured to identify contamination levels, verify cleaning progress, and/or detect operational irregularities.

In an embodiment, the system 100 may include a weep system controlled via the controls system 106 (i.e., a PLC), the weep system including one or more dedicated flush valves for use in temperatures ranging from or about −40.0° C. (−40.0° F.) up to or about 52.0° C. (125.0° F.).

As stated above, a pneumatic system 117 may be included for producing compressed air to operate pneumatic equipment of the system 100. In an embodiment, a pneumatic system 117 may include one or more air compressors, one or more pneumatic conduits, and one or more pneumatic control valves for delivering compressed air to pneumatic equipment including, but not limited to, one or more process control valves, one or more actuators, one or more pneumatic chemical dosing pumps, and/or combinations thereof. In an embodiment, a pneumatic system 117 and corresponding pneumatic equipment of the system 100 may be in electrical communication with the control system 106 via wired and/or wireless connections. In one or more embodiments, a pneumatic system 117 may be considered a subsystem or part of the control system 106.

In addition, in an embodiment where an on-site control station of a control system 106 comprises a forty-foot container or other housing type structure, an upper surface of a forty-foot container or other housing type structure may further operate as an elevated support surface for one or more storage containers 111 of a cleaning fluid system 110 (e.g., a hot-water ISO tank). In an embodiment, the same forty-foot container or other housing type structure may also be used to store one or more other storage containers 111 of a system 100 (e.g., a cold-water polypropylene tank).

In an embodiment of a system 100 comprising one or more standalone power sources 108, a suitable standalone power source 108 may include, but is not limited to, an electric power supply system comprising an engine and an electric generator that may be provided as a single unit (“electric power generation set”) with or without an enclosure. In one embodiment, an engine may include an internal combustion engine operated using hydrocarbon fuel (e.g., a compression-ignition engine or a spark ignition engine). A suitable compression-ignition engine includes a diesel engine. A suitable spark-ignition engine includes a gasoline engine. Exemplary engines may include one of a plurality of commercially available engines, including, but not limited to, engines and generator sets manufactured by Caterpillar, Inc., Peoria, Illinois, U.S.A., for example, the Caterpillar® C4.4, In-line 4, 4-cycle diesel engine, the Caterpillar® C32 V-12, 4-stroke water-cooled diesel engine, and the Caterpillar® C7.1 ACERT® Tier 4 Diesel Engine.

In still another embodiment, a system 100 may include one or more designated areas for parking one or more enclosures 10 post cleaning. Such areas may be located at one or more indoor locations and/or one or more outdoor locations and/or one or more covered locations.

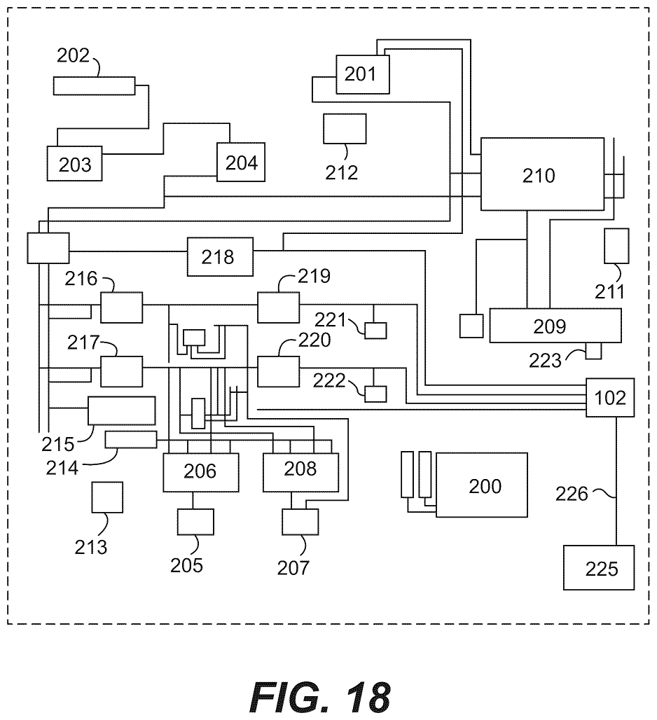

With reference to FIG. 18, in an embodiment a control system 106 may include at least a control station 200 including an internet connection and at least one MCC. In an embodiment, a fluid delivery system 104 may include at least the following: (1) at least one hot-water storage tank 201 rated for 60.0° C. (140.0° F.) and having a volume of 22712.5 liters (6000.0 gallons); (2) at least one potable water source 202; (3) at least one water softener 203; (4) at least one cold-water storage tank 204 having a volume of 3997.4 liters (1056.0 gallons); (5) at least one washing chemical storage container 205 (e.g., an alkaline storage container having a volume of 1000.0 liters (264.2 gallons)); (6) at least one pump 206 for the washing chemical storage container 205; (7) at least one disinfectant storage container 207 having a volume of 60.0 liters (15.9 gallons); (8) at least one pump 208 for the disinfectant storage container 207; (9) at least one hot-water boiler 209 (e.g., a low temperature boiler) for heating a primary water circuit of the system 100 (e.g., a three pass oil/gas boiler with a heating output of 90.0-1950.0 kW); (10) at least one heat exchanger 210 (e.g., a plate heat exchanger); (11) one or more exhaust fans 211 and 212; (12) at least one air compressor 213; (13) at least one instrument air inlet 214; (14) at least one low pressure pump 215 for the one or more cleaning bays 102; (15) one or more booster pumps 216 and 217; (16) at least one high pressure floor level fluid outlet pump 218; (17) at least one first cleaning bay 102 high pressure pump 219; (18) at least one second cleaning bay 102 high pressure pump 220; and (19) at least one drain (see drains 221, 222 and 223). Other exemplary fluid delivery system 104 parts may include, but are not limited to, one or more gate valves, hoses including suction hoses and high pressure hoses, aluminum clamps, couplings, strainers, solenoid valves, coils, ball valves, pressure transmitters, temperature sensors, regulating valves, butterfly valves, compensators, check valves, proximity switches, gauge valves, pressure gauges, regulating valves, electric motors, V-belts, safety valves, pressure accumulators, bursting disc or rupture disc holders, seal kits, metering containers, diaphragm valves, hydraulic couplers, axial fans, thermometers, and/or combinations thereof. In an embodiment, a potable water source 202 may include a public water line 91.

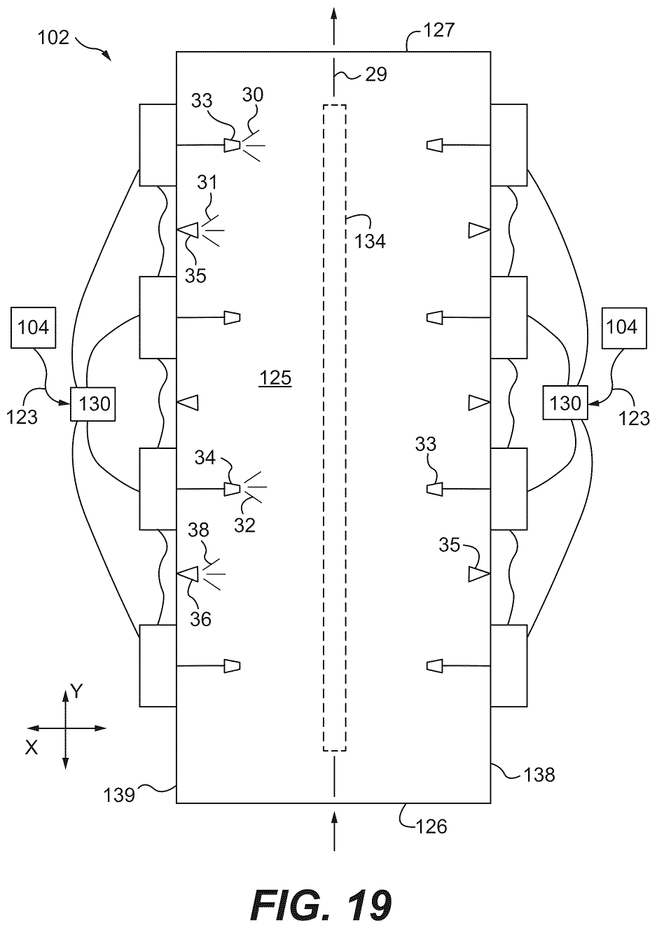

Suitably, a cleaning bay 102 of this disclosure is configured to receive one or more pressurized cleaning fluids from the fluid delivery system 104 and convert the one or more pressurized cleaning fluids into one or more pressurized cleaning fluid streams (e.g., one or more high pressure cleaning fluid streams and one or more low pressure cleaning fluid streams), comprised of one or more fluid spray patterns and/or one or more fluid impingement forces and/or one or more shear stresses (hereafter collectively referred to as one or more “spray parameters”) via one or more fluid outlets for washing one or more enclosures 10. With reference to FIG. 19, in an embodiment a cleaning bay 102 may include at least one designated cleaning space (hereafter “cleaning zone 125”) for positioning at least one enclosure 10 and a cleaning fluid dispensing system 130 with one or more fluid outlets located on one or both sides of the cleaning zone 125 and/or above the cleaning zone 125 for washing one or more interior and/or exterior surfaces of the at least one enclosure 10 located in the cleaning zone 125. In an embodiment, a cleaning fluid dispensing system 130 may also include one or more fluid outlets located on one or both ends of a cleaning zone 125.

In the embodiment of FIG. 19, the cleaning fluid dispensing system 130 includes at least (1) one or more fluid inlet lines 123 in fluid communication with the one or more fluid lines 112 of the fluid delivery system 104 and (2) one or more fluid outlets located on one or both sides of the cleaning zone 125 (i.e., one or more fluid outlets located on a first side 138 of the cleaning zone 125 and/or one or more fluid outlets located on a second side 139 of the cleaning zone 125). In an embodiment, the one or more fluid outlets may include (1) one or more multi-axis first fluid outlets 33 configured to emit one or more first pressurized cleaning fluid streams 30 into the cleaning zone 125 and onto one or more interior surfaces of at least one enclosure 10 positioned in the cleaning zone 125, and (2) one or more multi-axis second fluid outlets 35 configured to emit one or more second pressurized cleaning fluid streams 31 into the cleaning zone 125 onto one or more exterior surfaces of at least one enclosure 10 positioned in the cleaning zone 125 as described below. In an embodiment, the one or more first fluid outlets 33 and the one or more second fluid outlets 35 may be configured to emit one or more first and second pressurized fluid streams 30 and 31 in a manner effective to cover all or substantially all of a corresponding cleaning zone 125 (i.e., to wet all or substantially all of a corresponding cleaning zone 125, or at least cover or wet all, or substantially all, of an area designated for locating one or more enclosures 10 in the cleaning zone 125).

As further shown in FIG. 19, in an embodiment, in addition to or as alternative to the one or more steam bays 124, the one or more fluid outlets of a cleaning bay 102 may include (1) one or more multi-axis first fluid steam outlets 34 configured to emit one or more steam fluid streams 32 into the cleaning zone 125 and onto one or more interior surfaces of at least one enclosure 10 positioned in the cleaning zone 125; and (2) one or more second fluid steam outlets 36 configured to emit one or more steam fluid streams 38 into the cleaning zone 125 and onto one or more exterior surfaces of at least one enclosure 10 positioned in the cleaning zone 125. With reference to FIG. 18, in an embodiment a fluid delivery system 104 may include one or more steam boilers 225 configured to receive hard potable well water or water from a public water line 91 or water via at least one water softener 203, wherein steam generated by the one or more steam boilers 225 is conveyed to the one or more first fluid steam outlets 34 and the one or more second fluid steam outlets 36 of a cleaning bay 102 via one or more steam lines 226. In an embodiment including one or more steam bays 124, the one or more steam bays 124 may be configured to receive steam from the one or more steam boilers 225 and/or one or more separate steam boilers dedicated for use with the one or more steam bays 124 of the system 100.

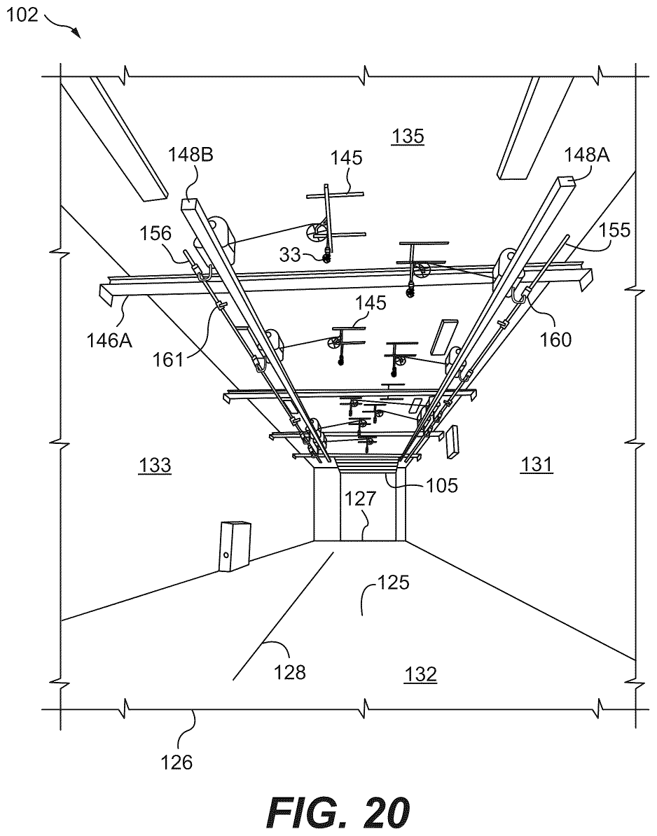

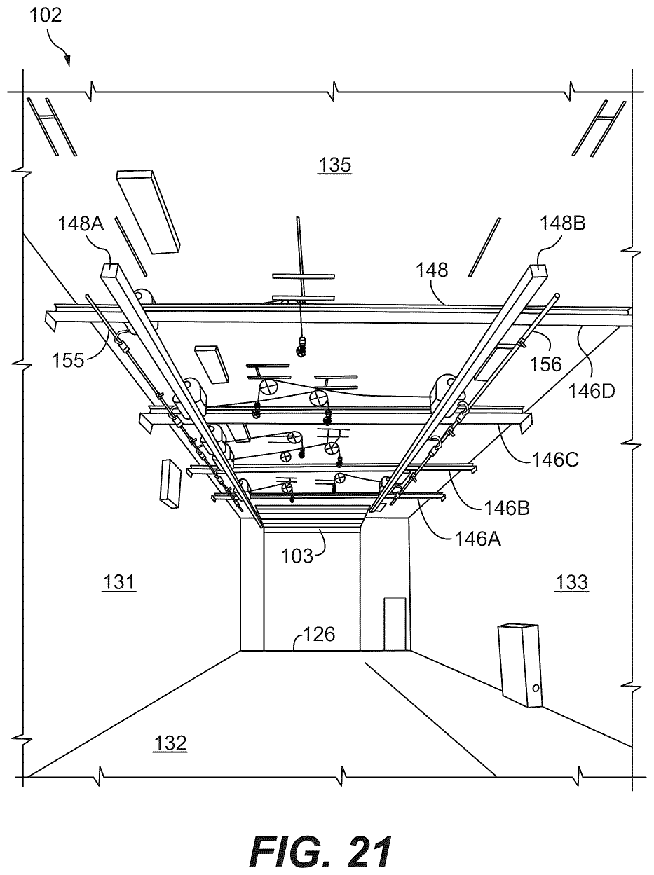

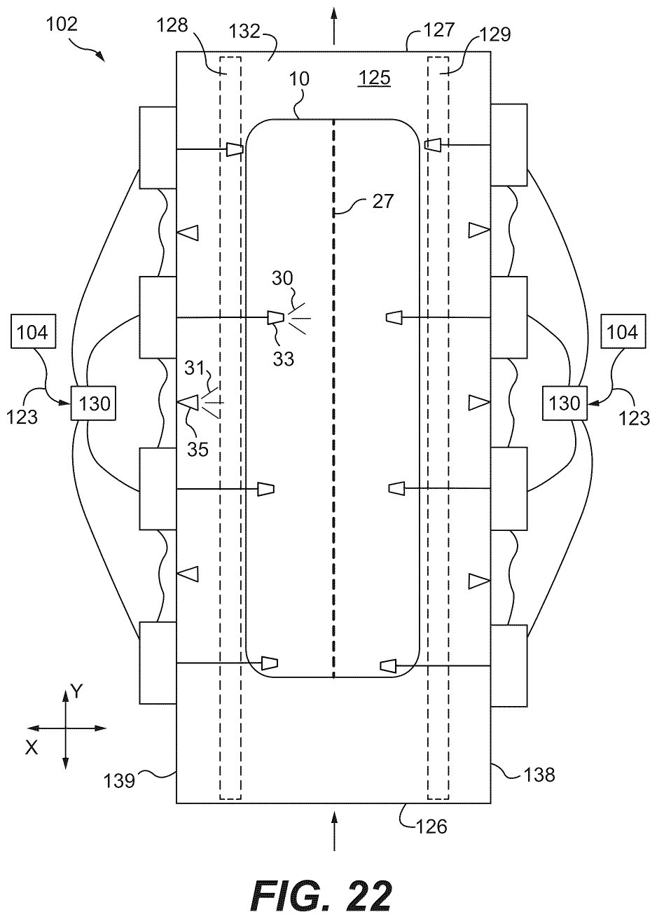

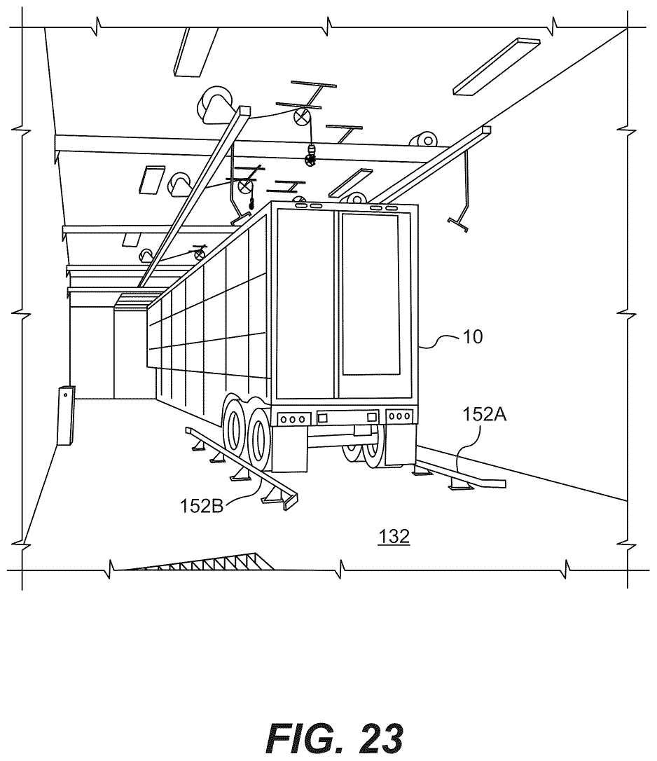

In an embodiment, a cleaning zone 125 may be configured as a rectangular vehicular drive-through space as shown with opposing open ends configured as an entry 126 and as an exit 127 for moving enclosures 10 in and out of the cleaning bay 102, the cleaning zone 125 having a width and length to accommodate one or more known and/or anticipated types of enclosures 10 (see also FIGS. 20 and 21). In operation, an enclosure 10 may be towed or otherwise directed into a cleaning zone 125 in a parked position as shown in FIGS. 22 and 23, whereby a cleaning fluid dispensing system 130 is configured to emit one or more pressurized fluid streams 30, 31 in a manner effective to impact up to the full length, width and height of an enclosure 10. In another embodiment, a cleaning zone 125 may include a non-rectangular shape.

To assist in placing an enclosure 10 within a cleaning zone 125 for desired washing, a cleaning zone 125 may include opposing parallel lane markings 128, 129 disposed on a support surface 132 of the cleaning bay 102 to assist in guiding an enclosure 10 into the cleaning zone 125 and/or aligning a longitudinal center line 27 of the enclosure 10 with a longitudinal center line 29 of a cleaning zone 125 parallel or substantially parallel with the lane markings 128, 129 (see FIGS. 19 and 22). To enhance visibility, the lane markings 128, 129 may be illuminated and/or comprise one or more colors including one or more fluorescent colors. In another embodiment, raised guide rails and/or linear raised curb type surfaces may be used in place of or in addition to lane markings 128, 129 to assist in aligning an enclosure 10 within a cleaning zone 125 (see guide rails 152A, 152B in FIG. 23). In general, lane markings 128, 129 and/or guide rails 152A, 152B are configured to properly position an enclosure 10 in a cleaning zone 125 along an X-axis of the cleaning bay 102.

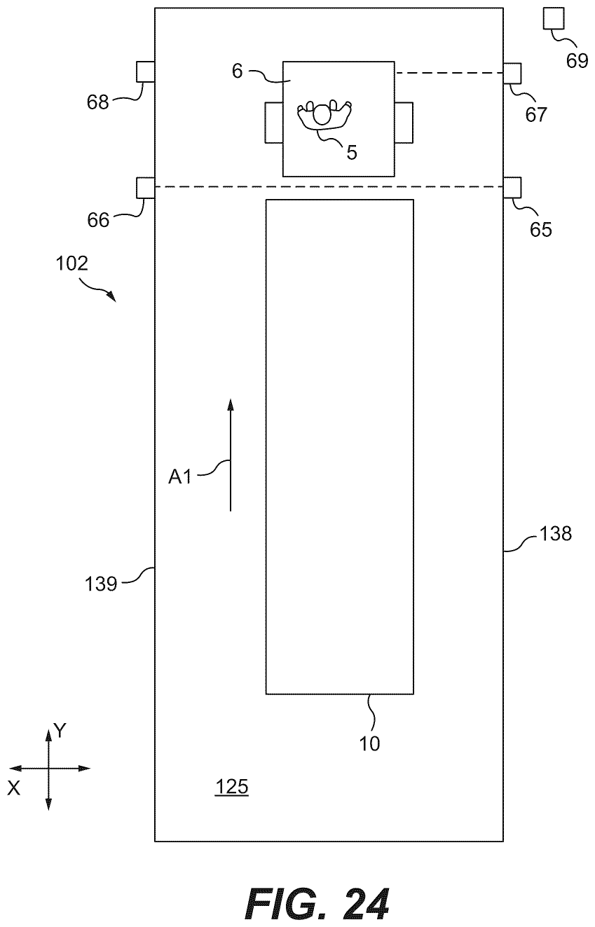

As shown in FIG. 24, the system 100 may include an enclosure 10 positioning system in electrical communication with a PLC of the system 100 configured to assist an operator 5 of a power unit for an enclosure 10 such as a tractor 6 or the like, to properly position the enclosure 10 in a cleaning zone 125 along a Y-axis of the cleaning bay 102. In an embodiment, an enclosure 10 positioning system may include (1) a first laser break beam sensor including a first laser emitting member 65 located on a first side 138 of a cleaning zone 125 and a first laser receiving member 66 located on a second side 139 of the cleaning zone 125 opposite the first laser emitting member 65, and (2) at least a second laser break beam sensor including a second laser emitting member 67 located on the first side 138 of the cleaning zone 125 and a second laser receiving member 68 located on the second side 139 of the cleaning zone 125 opposite the second laser emitting member 67, or vice versa. Suitably, the first laser break beam sensor and the second laser break beam sensor are located at points along the cleaning zone 125 and at heights above the a support surface 132 of the cleaning bay 102 effective for positioning an enclosure 10 at a desired location in the cleaning zone 125. An enclosure 10 positioning system as described in this paragraph may also be referred to as a “laser parking system” for one or more enclosures 10.

With reference to FIG. 24, in operation, as an operator 5 pulls an enclosure 10 into a cleaning zone 125 of a cleaning bay 102 (see directional arrow A1 in FIG. 24), the tractor 6 first breaks the laser beam of the first laser break beam sensor, whereby a first caution signal is generated in the cleaning bay 102 to communicate to the operator 5 that the enclosure 10 is approaching a cleaning position in the cleaning zone 125 and to inform the operator 5 to reduce speed and prepare the tractor 6 for stoppage. As the tractor 6 continues to move forward in the cleaning zone 125 to a position where the tractor 6 breaks the laser beam of the second laser break beam sensor as shown in FIG. 24, a second caution signal is generated in the cleaning bay 102 to communicate to the operator 5 that the enclosure 10 has nearly reached the cleaning position in the cleaning zone 125, thereby preparing the operator 5 to stop the tractor 6. The tractor 6 suitably continues to move forward in the cleaning zone 125 until the enclosure 10 breaks the laser beam of the first laser break beam sensor whereby a third caution signal (or “full stop” signal) is generated in the cleaning bay 102 to communicate to the operator 5 to stop the tractor 6 as the enclosure 10 has reached a desired cleaning position in the cleaning zone 125.

The one or more signaling devices 69 in a cleaning bay 102 may include, but are not limited to, one or more visual signaling devices and/or one or more audible signaling devices. Suitable visual signaling devices may include, but are not limited to, one or more blinking lights and/or other lighting effects, one or more colored lights (e.g., a green light as a first caution signal, a yellow light as a second caution signal, and red light as a full stop signal, and/or combinations thereof). One or more audible signaling devices may include, but are not limited to, one or more sirens with one or more selected alarm tones, one or more sound signal horns or the like with one or more selected alarm tones, and/or combinations thereof configured to produce audible first, second and third caution signals. In an embodiment, a speaker may be located in the cleaning bay 102 wherein personnel in a control room of the cleaning bay 102 may verbally communicate to an operator 5 regarding the position of the enclosure 10 in the cleaning zone 125 including a full-stop position.

In an embodiment, the distance between the first laser break beam sensor and the second laser break beam sensor may be determined by an average length for a tractor 6 and an average speed of an enclosure 10 at a point when the tractor 6 breaks the laser beam of the first laser break beam sensor. In an embodiment for cleaning enclosures 10 as described herein, the first laser break beam sensor may be positioned along the cleaning zone 125 apart from the second laser break beam sensor at a distance of or about 3.7 meters (12.0 feet). In an embodiment, an average speed that a tractor 6 pulls an enclosure 10 into a cleaning zone 125 is a speed ranging from or about 4.8 km/h (3.0 mph) to or about 16.1 km/h (10.0 mph).

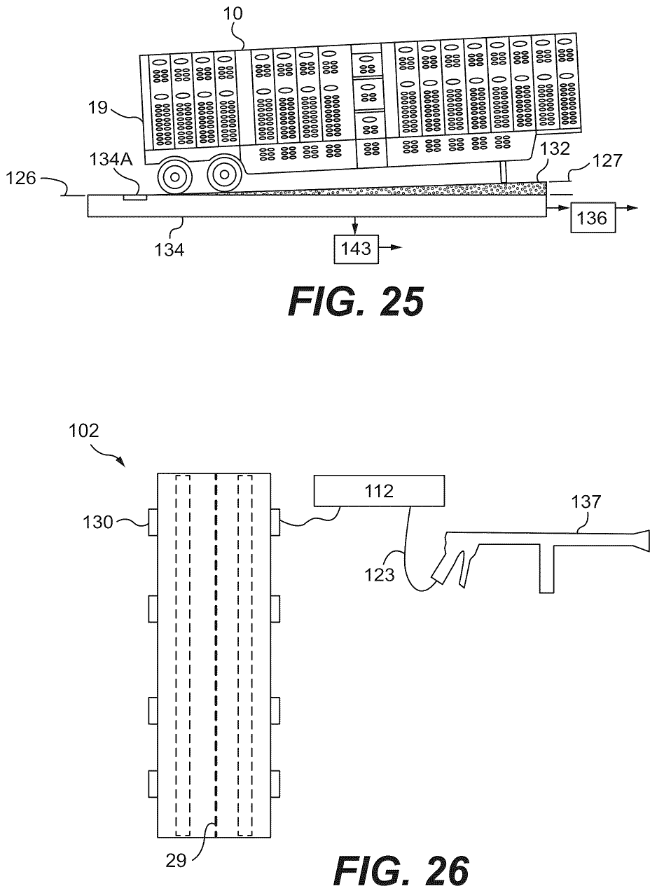

In an embodiment, a support surface 132 of a cleaning bay 102 may be provided as a horizontal planar floor surface. As shown in FIG. 25, in an embodiment, a support surface 132, or at least a part of the support surface 132 comprising the cleaning zone 125, may be provided as a planar incline floor surface wherein the support surface 132 at or near the exit 127 is set at a higher altitude than at or near the entry 126, which suitably inclines a floor 11 of an enclosure 10 to promote gravitational drainage of cleaning fluid and any contaminants entrained therein out of a rear end 19 of the an enclosure 10. A support surface 132 of this disclosure is not limited to a particular floor grade angle. In a non-limiting embodiment, the support surface 132 may have a floor-grade angle of or about 5.0 degrees.

As further shown in FIG. 25, a support surface 132 may also include a gravitational drainage system comprising one or more gravitational drains 134 disposed below the support surface 132. In an embodiment, the one or more gravitational drains 134 may include one or more drain covers 134A, for example, one or more planar covers in planar alignment or substantially planar alignment with the support surface 132. The number, location and orientation of one or more gravitational drains 134 may vary as desired or as may otherwise be required for a particular cleaning operation.

In an embodiment, a gravitational drainage system may include a sedimentation pit 136 or basin in fluid communication with the one or more gravitational drains 134 for collecting cleaning fluid. In an embodiment, cleaning fluid entering the one or more gravitational drains 134 may be pumped out from a sedimentation pit 136 to a municipal sewage system or the like. In an embodiment, a gravitational drainage system may include a reclamation system 109 configured to reuse or recycle water used during one or more wash operations (see FIG. 16). In an embodiment, a reclamation system 109 may include a pumping system 140 and one or more filtration systems 141 for delivering filtered water back to the cleaning fluid system 110 for system 100 reuse. As shown in FIG. 25, in an embodiment, a gravitational drainage system may include a separation system 143 in fluid communication with the one or more gravitational drains 134 configured to separate oil, grease, water, and solids.

It is also contemplated that in an embodiment, a cleaning bay 102 having a horizontal or incline support surface 132 may operate as a two-way vehicular drive-through space wherein whereby enclosures 10 may enter into the cleaning bay 102 via either open end. In still another embodiment, a cleaning bay 102 may include a closed end with an open end serving as dual entry/exit for one or more enclosures 10. Although a support surface 132 may be constructed from one or more materials as desired, for cleaning enclosures 10 a support surface 132 is suitably constructed from one or more cementitious compositions (e.g., a support surface 132 constructed of a concrete mixture as known in the art of vehicular driveways, garages, and/or the like). In an embodiment, a concrete support surface 132 may comprise precast concrete. In an embodiment, a concrete support surface 132 may be left uncoated, may include tile, may include one or more sealants, and/or may include one or more outer coatings (e.g., one or more epoxy coatings, polyurethane coatings, polyaspartic coatings, or acrylic coatings). With reference to FIGS. 20 and 21, a vertical planar first sidewall 131 and a vertical planar second sidewall 133 of a cleaning bay 102 may be constructed of a concrete mixture similar or dissimilar as a corresponding support surface 132 and may also be left uncoated, may include tile, may include one or more sealants, and/or may include one or more outer coatings (e.g., one or more epoxy coatings, polyurethane coatings, polyaspartic coatings, or acrylic coatings).

In an embodiment, a ceiling 135 of a cleaning bay 102 may be comprised of a wooden truss construction with polyethylene paneling and/or the like forming an exterior planar surface of the ceiling 135. In an embodiment, a ceiling 135 may be comprised of a metal truss construction for receiving polyethylene paneling and/or the like. Although a cleaning bay 102 of this disclosure is scalable, a system 100 will be described herein in terms of a cleaning bay 102 having dimensions as listed in Table 1 effective to clean enclosures 10 having maximum dimensions as listed in Table 2.

TABLE 1

| | |
|---|---|
| Length | of or about 30.48 meters (100.0 feet) |
| Width | of or about 7.62 meters (25.0 feet) |
| Height at entry 126 | of or about 5.18 meters (17.0 feet) |
| Height at exit 127 | of or about 5.49 meters (18.0 feet) |

TABLE 2

| | |
|---|---|
| Length | of or about 18.3 meters (60.0 feet) |
| Width | of or about 3.1 meters (10.0 feet) |
| Height | of or about 4.3 meters (14.0 feet) |

With reference to FIG. 26, as stated above a cleaning bay 102 may include one or more support surface 132 level manually operable fluid outlets 137 (hereafter “floor level fluid outlets 137”) for emitting pressurized fluid streams onto interior and/or exterior surfaces of enclosures 10 and any other items located in the cleaning bay 102. Suitable floor level fluid outlets 137 may include, but are not limited to one or more low pressure water faucets (or spigots) and one or more faucet controlled hoses, one or more valve controlled permanent installation hoses, one or more hose connected brushes, one or more hose connected push brooms, one or more hose connected fixed or adjustable manual pressure washers (e.g., one or more spray wands or spray guns, and/or combinations thereof). In an embodiment, the one or more floor level fluid outlets 137 may be fluidly communicated with one or more fluid lines 112 of a fluid delivery system 104 as shown in FIG. 26. In an embodiment, the one or more floor level fluid outlets 137 may be fluidly communicated with one or more water sources 91 as described above.

A cleaning bay 102 may also include one or more low pressure floor level fluid outlets 137 in fluid communication with the low pressure pump 215 and configured as one or more water fluid outlets for cleaning one or more undercarriage surfaces of an enclosure 10 and/or for emitting water onto the support surface 132 of the cleaning bay 102 to assist in draining spent cleaning fluid and one or more contaminants from the support surface 132 into one or more gravitational drains 134. Exemplary undercarriage surfaces of an enclosure 10 of this disclosure include, but are not limited to surfaces of items such as axles, frames, subframes, connectors, couplers, slides, underside surfaces of floors 11, spare wheels/tires, support jacks, suspensions, and/or combinations thereof. In another embodiment, one or more low pressure floor level fluid outlets 137 may be fluidly communicated with a high pressure pump (e.g., pump 218).

One or more cleaning bays 102 may further include entry and exit overhead doors as known in the art of commercial overhead doors (see entry door 103 in FIG. 21 and exit door 105 in FIG. 20). In addition, one or more cleaning bays 102 may also include one or more alarm systems, one or more illumination sources, one or more fixed catwalks, one or more portable catwalks, one or more portable hose reels, one or more wall-mounted hose reels, one or more hose hooks, one or more video cameras, one or more audible speakers, one or more communication systems, and/or combinations thereof.

As described herein, in an embodiment a cleaning fluid dispensing system 130 may be provided as an overhead cleaning fluid dispensing system 130 configured to emit one or more pressurized fluid streams 30, 31 in a manner effective to cover all or substantially all of a corresponding cleaning zone 125. In an embodiment, a cleaning fluid dispensing system 130 may be provided as an overhead cleaning fluid dispensing system 130 operably secured to the ceiling 135 and/or sidewall 131 and/or sidewall 133 via an overhead support system. For example, a cleaning fluid dispensing system 130 may be secured to one or more overhead support members including, but not limited to ceiling 135 mountable support members secured to joists and/or girders of a cleaning bay 102. In another embodiment, a cleaning fluid dispensing system 130 may be provided as an overhead cleaning fluid dispensing system 130 operably secured to one or more overhead support members that are in fixed communication with the ceiling 135 and/or sidewall 131 and/or sidewall 133. In another embodiment, a cleaning fluid dispensing system 130 may be provided as an overhead cleaning fluid dispensing system 130 operably secured to one or more support surface 132 vertically disposed supports (e.g., one or more vertical columns, vertical walls, or vertical metal and/or wood and/or plastic framework members). In another embodiment, a cleaning fluid dispensing system 130 may be provided as an overhead cleaning fluid dispensing system 130 operably secured to a combination of an overhead support system and one or more support surface 132 vertically disposed supports.

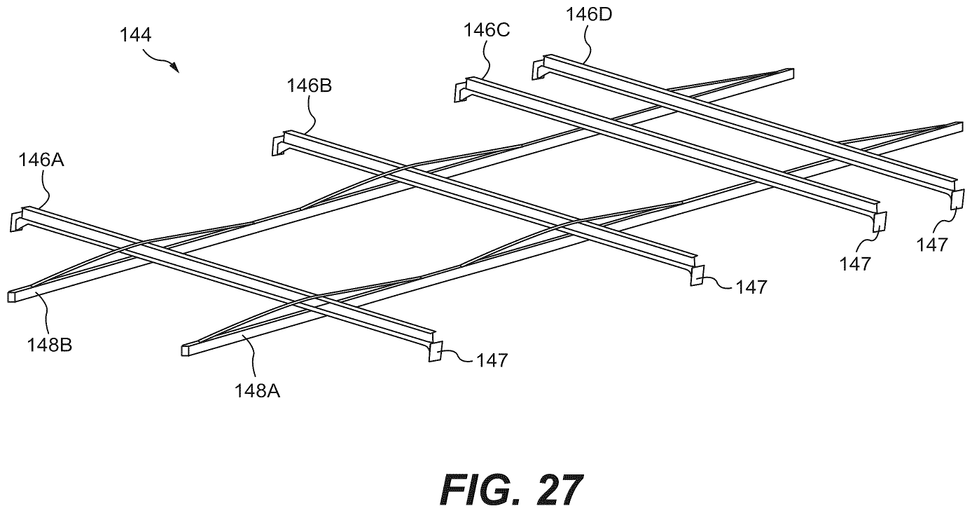

With reference to FIGS. 20, 21 and 27, in an embodiment a cleaning fluid dispensing system 130 may be provided as an overhead cleaning fluid dispensing system 130 operably secured to an overhead support system comprised of at least (1) one or more overhead primary supports 144 disposed across and along a cleaning zone 125 and/or (2) one or more overhead secondary supports 145 located on the ceiling 135 and/or sidewall 131 and/or sidewall 133 and/or one or more other overhead support surfaces.

In an embodiment, the one or more overhead primary supports 144 (hereafter “one or more primary supports 144”) may include one or more overhead frame-type structures comprising an I-beam assembly including at least (1) a plurality of horizontal, linear, parallel first I-beams (see first I-beams 146A-146D) with opposing distal ends comprising planar mounting surfaces 147 for abutting planar sidewalls 131 and 133, and (2) a plurality of horizontal, linear, parallel second I-beams 148 (see second I-beams 148A-148B) perpendicular to and secured to a bottom side of each of the first I-beams 146A-146D. In an embodiment, the one or more second I-beams 148A-148B may be secured directly to the bottom side of one or more of the one or more first I-beams 146A-146D as shown. In another embodiment, one or more spacers may be disposed between the bottom side of each of the one or more first I-beams 146A-146D and the one or more second I-beams 148A-148B. In an embodiment, the one or more primary supports 144 may be provided as a single-piece construction. Other implementations of an overhead support system and a vertical wall-mounted support system are herein contemplated. For purposes of this disclosure, an overhead support system as described herein may be considered as part of the cleaning fluid dispensing system 130.

In an embodiment, the one or more fluid inlet lines 123 for directing fluid into the cleaning fluid dispensing system 130 may be comprised of one or more fluid conduits, connectors, couplers, valves, and/or combinations thereof secured to the overhead support system and configured to receive one or more pressurized cleaning fluids from the fluid delivery system 104 and convey the one or more pressurized cleaning fluids to one or more fluid distribution systems of the cleaning fluid dispensing system 130 that are configured to selectably and controllably convey one or more pressurized fluid streams 30, 31 and one or more steam fluid streams 32, 38 into a cleaning zone 125.

Referring to FIGS. 20, 21 and 28, in an embodiment the one or more fluid distribution systems of a cleaning fluid dispensing system 130 may include at least (1) a header assembly 154 configured to convey one or more pressurized cleaning fluids received from the one or more fluid inlet lines 123 to the one or more first fluid outlets 33 and the one or more second fluid outlets 35; and (2) a valve control system including (a) one or more fluid-actuated control valves 160 (or “one or more valves 160”) in fluid communication with the header assembly 154, and (b) at least a first manifold member 161 (or “manifold 161”) in fluid communication with the one or more valves 160 via one or more fluid lines 162.

In an embodiment, the header assembly 154 may be configured to receive pressurized steam from the one or more steam boilers 225 and convey the pressurized steam to the one or more first fluid steam outlets 34 and the one or more second fluid steam outlets 36 (see FIG. 19) via one or more valves 160. In another embodiment, a cleaning bay 102 may include a second header assembly with one or more fluid-actuated control valves in fluid communication with the manifold 161 configured for dedicated use with the one or more steam boilers 225, the one or more first fluid steam outlets 34 and the one or more second fluid steam outlets 36.

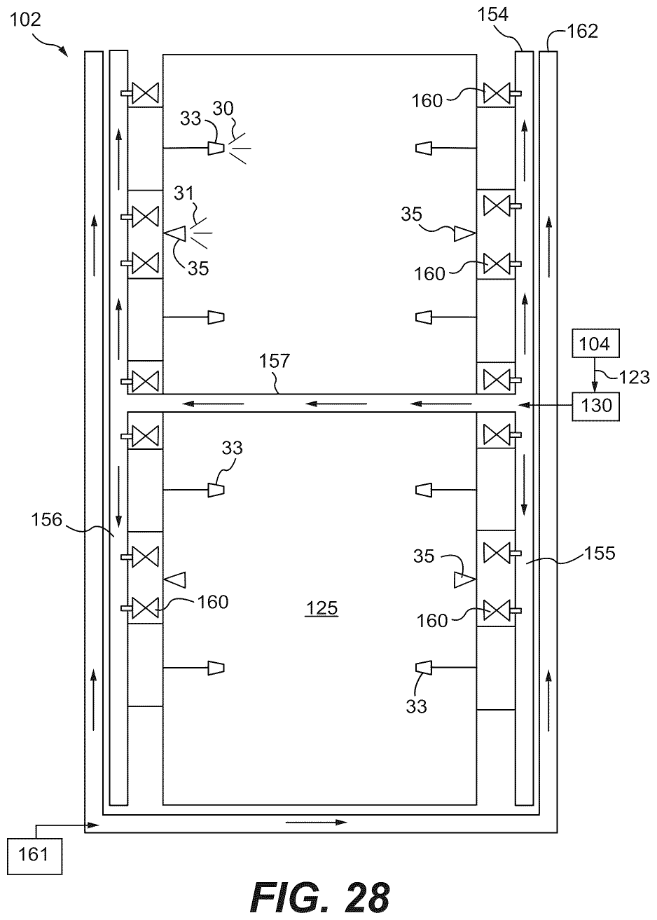

In an embodiment as shown FIG. 28, a header assembly 154 may include a first header member 155 disposed along a first side 138 of the cleaning zone 125 and a second header member 156 disposed along a second side 139 of the cleaning zone 125. In an embodiment as shown, the first header member 155 may be configured to receive one or more pressurized cleaning fluids from the fluid delivery system 104 and convey the one or more pressurized cleaning fluids to the second header member 156 via at least a first connecting fluid line 157. In an embodiment, each of the first header member 155 and the second header member 156 may receive one or more pressurized cleaning fluids from the fluid delivery system 104 via separate fluid inlet lines 123.

As shown in FIG. 28, a first header member 155 and a second header member 156 may each have a length the same or substantially similar as the length of the corresponding cleaning zone 125. In another embodiment, each of the first header 155 and the second header 156 may have a length less than or greater than the length of a corresponding cleaning zone 125. Although a system 100 of this disclosure is scalable, in an embodiment of a cleaning bay 102 having dimensions as provided in Table 1, the first header 155 and the second header 156 may each be provided as 3.81 cm (1.5 inch) diameter, Schedule 40 316 stainless steel tube with a length of or about 13.72 meters (45.0 feet).

In an embodiment as shown in FIGS. 20 and 21, each of the first and second headers members 155 and 156 may be secured to the one or more primary supports 144 (e.g., secured to the one or more first I-beams 146A-146D), wherein the first header member 155 is disposed adjacent second I-beam 148A and the second header member 156 is disposed adjacent the second I-beam 148B as shown. In an embodiment, the one or more fluid distribution systems may comprise one or more additional header members secured to the one or more primary supports 144, whereby the first and second headers members 155 and 156 may be configured for use with the one or more first fluid outlets 33 and the one or more additional header members may be configured for use with the one or more second fluid outlets 35 (e.g., a total of four header members with two header members disposed along each side 138, 139 of the cleaning zone 125).

In an embodiment, each of the first and second header members 155 and 156 may include one or more fluid outlets disposed along the respective header member for conveying the one or more pressurized cleaning fluids to separate valves 160. As described below, each valve 160 may be in fluid communication with a corresponding fluid outlet of the one or more first fluid outlets 33 or the one or more second fluid outlets 35.

Still referring to FIG. 28, in an embodiment each of the valves 160 may be provided as a pneumatically controlled high-pressure valve with a pneumatic actuator in fluid communication with the manifold 161, wherein the manifold 161 may include a pneumatic manifold 161 configured to selectably and controllably supply pressurized air received from the air compressor 213 to each of the one or more valves 160 via the one or more fluid lines 162. In an embodiment, the manifold 161 interfaces with the control system 106, allowing system 100 operators to open or close each individual valve 160 as desired during operation. In an embodiment, the one or more valves 160 may include one or more ball valves, each having a pneumatic double-acting actuator. In an embodiment, the one or more fluid lines 162 may include one or more pneumatic fluid lines, including, but not limited to, one or more pneumatic hoses, each having a working pressure of or about 300.0 psi. In an embodiment, a suitable pneumatic hose may include a molded polyurethane hose.

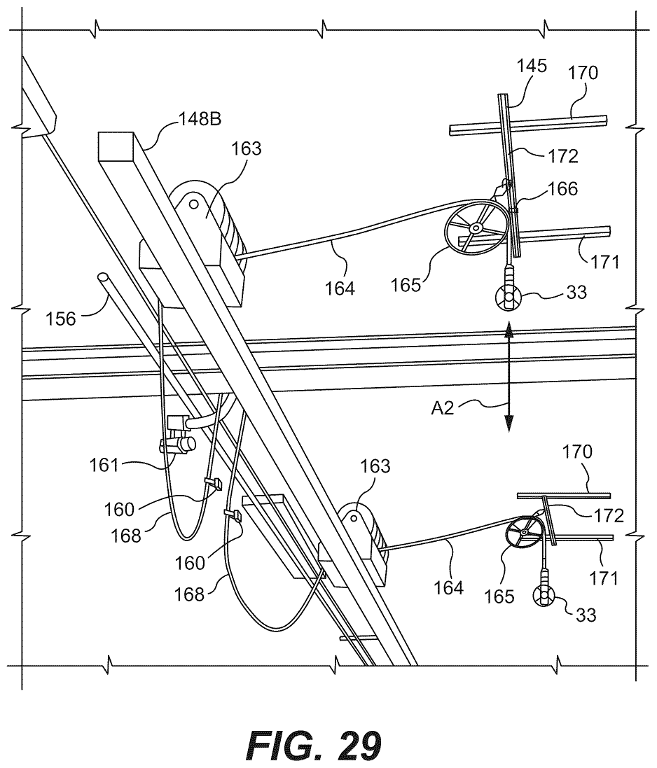

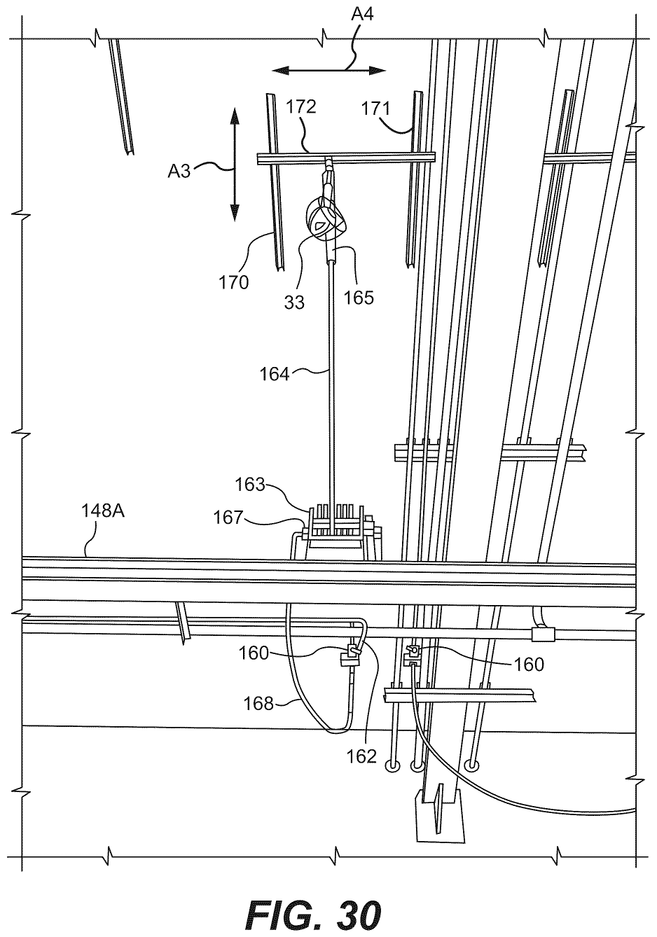

Turning to FIGS. 29 and 30, in an embodiment, each of the one or more first fluid outlets 33 may be provided as part of a separate fluid delivery assembly that includes (1) one or more fluid lines for conveying the one or more pressurized cleaning fluids to a corresponding first fluid outlet 33, (2) at least one retractable member for directing the first fluid outlet 33 between one or more non-operating positions and one or more operating positions, and, depending on the configuration of the fluid delivery system, (3) at least one guide member configured to establish a travel path of the first fluid outlet 33 between the one or more non-operating positions and the one or more operating positions. In an embodiment, a retractable member may include a retractable hose reel 163 mounted to one or more primary supports 144. In an embodiment, the one or more fluid lines may include one or more pressurized hoses 164 (“one or more hoses 164”) having a first end in fluid communication with the retractable hose reel 163 and a second end in fluid communication with a first fluid outlet 33. In an embodiment, a guide member may include a pulley member 165 releasably secured to one or more overhead secondary supports 145 secured to the ceiling 135, wherein the pulley member 165 is configured to receive the hose 164 extending from the retractable hose reel 163 in a horizontal or substantially horizontal orientation and redirect the hose 164 and first fluid outlet 33 through a linear vertical travel path (see directional arrow A2 in FIG. 29).

With reference to the embodiment of FIG. 29, a retractable hose reel 163 may include an automated electrical hose reel having (a) a frame portion releasably secured to second I-beam 148B and (b) a reel portion for rotatably supporting the hose 164, wherein the reel portion is configured to rotate in a first hose payout direction and a second, opposed, hose take up direction as understood in the art of retractable hose reels. For purposes of cleaning enclosures 10, a suitable pressurized hose 164 may include a pressurized hose with a pressure rating effective for conveying pressurized cleaning fluid up to 5000.0 psi. In an embodiment, a suitable pressurized hose 164 may include a two-wire braided steel reinforced hydraulic hose, or the like (e.g., SAE 100R16-12 hydraulic hose and/or the like) with a working pressure of or about 4000.0 psi and a burst pressure of or about 16000.0 psi. As understood by the skilled artisan, a suitable pressurized hose 164 has a bend radius operable with (1) the reel portion of the retractable hose reel 163 and (2) the pulley member 165. As shown in FIG. 29, in an embodiment a fluid delivery assembly may also include a pulley member equipped with one or more travel limit switches 166 configured to control the maximum hose payout (i.e., control the maximum payout travel distance of the first fluid outlet 33 toward the support surface 132 of a cleaning bay 102).

With reference to FIG. 30, in an embodiment a retractable hose reel 163 may include a fluid inlet 167 configured to receive pressurized cleaning fluid from a corresponding fluid-actuated valve 160 via a transfer fluid line 168. A suitable transfer fluid line 168 may include one or more pressurized hoses with a pressure rating effective for conveying pressurized cleaning fluid up to 5000.0 psi (e.g., SAE 100R16-12 hydraulic hose and/or the like), with a working pressure of or about 4000.0 psi and a burst pressure of or about 16000.0 psi. In an embodiment, when a pneumatic actuator of a valve 160 is set to an OPEN position remotely via the manifold 161, one or more pressurized cleaning fluids are suitably directed out from a corresponding header member 156 through the valve 160 and transfer fluid line 168 to the hose reel 163 and hose 164 for emission out through the first fluid outlet 33 as one or more pressurized fluid streams 30. Herein, an OPEN position of a valve 160 is also an ON position of a corresponding first fluid outlet 33. As such, when an operator sets a pneumatic actuator of a valve 160 to a CLOSED position remotely via the manifold 161 a corresponding first fluid outlet 33 is set to an OFF position.

In an embodiment, the one more first fluid outlets 33 may include one or more spray nozzles, including but not limited to, one or more non-rotating nozzles, self-rotating nozzles (a.k.a., self-propelled nozzles or free spinning spray nozzles), cluster nozzles, pneumatically driven nozzles, and electronically driven nozzles. Non-limiting examples of non-rotating nozzles may include flat-fan nozzles, hollow-cone nozzles, full-cone nozzles, misting nozzles, solid-stream nozzles, and static multichannel spray-ball nozzles. Non-limiting examples of self-rotating nozzles include, but are not limited to, rotary jet nozzles and rotary fan nozzles. In an embodiment, a first fluid outlet 33 for washing one or more interior surfaces of one or more enclosures 10 as described herein may include features as provided in Table 3 below.

TABLE 3

| Inlet | ¾ | BSP F |
|---|---|---|
| Minimum Operating Pressure | 3.0 MPa (435.0 psi) | |
| Permissible Operating Pressure | 16.0 MPa (2300.00 psi) | |
| Rated Flow Rate | 20.0-120.0 | liters per minute |
| Rated Working Temperature | 0.0-90.0° C. (32.0-195.0° F.) | |
| Material of Construction | Stainless Steel 303 | |
| Seals Material | Fluoroelastomer (FKM) | |
| Nozzle Type | 4 × ¼ | Npt |
| Rated Rotation Speed | 10.0-16.0 | rpm |

One exemplary self-rotating nozzle type first fluid outlet 33 for system 100 operation includes the A80 R self-rotating tank cleaner commercially available from P.A. SpA, Rubiera RE, Italy. Other commercial sources of self-rotating nozzles for system 100 operation may include, but are not limited to Spraying Systems Co., Glendale Heights, Illinois, U.S.A. and Alfa Laval Inc., Richmond, Virginia, U.S.A.

With further reference to FIGS. 29 and 30, in an embodiment, the one or more overhead secondary supports 145 for a pulley member 165 may be configured in a manner effective to manually adjust the location of a corresponding first fluid outlet 33 along multiple axes including at least (1) an X-axis from first sidewall 131 to second sidewall 133 (see directional arrow A3) and (2) an Y-axis from entry 126 to exit 127 (see directional arrow A4). In an embodiment, the one or more overhead secondary supports 145 for a pulley member 165 may include an adjustable assembly including at least a pair of parallel frame members 170 and 171 mounted to the ceiling 135, or other ceiling support member, and at least one adjustable cross member 172 releasably adjustable along the length of the frame members 170 and 171 (i.e., adjustable along the X-axis), or vice versa.

As shown in the embodiment of FIGS. 29 and 30, the cross member 172 may be configured as an adjustable attachment surface for a corresponding pulley member 165 suspended therefrom, wherein the pulley member 165 may be directed along the length of the cross member 172 (i.e., adjustable along the Y-axis). As such, the location of the cross member 172 along the length of the frame members 170 and 171 and the location of the pulley member 165 along the length of the cross member 172 establishes the coordinates of the first fluid outlet 33, thereby providing a desired vertical travel path of the first fluid outlet 33 along the Z-axis to one or more operating vertical positions at altitudes lower than an altitude defining the one or more non-operating positions of the first fluid outlet 33. In an embodiment, a pressurized hose 164 may include a length effective for the first fluid outlet 33 to be directed in the payout direction within a cleaning zone 125 as desired. At a maximum, a pressurized hose 164 may include a length effective for the first fluid outlet 33 to be directed to a contact position with a corresponding support surface 132 of a cleaning bay 102.

In an embodiment, the parallel frame members 170 and 171 and the cross member 172 may comprise strut channels, fixing rails, and/or the like, and/or combinations thereof. In an embodiment, the frame members 170 and 171 may be secured to a ceiling 135 truss in a manner effective to distribute the load of the pulley member 165 and the first fluid outlet 33 attached thereto. In an embodiment, one or more additional frame members may be included as part of one or more overhead secondary supports 145, providing one or more additional horizontal travel paths for a pulley member 165 and a first fluid outlet 33 attached thereto along three or more axes within a cleaning bay 102. In an embodiment, the one or more overhead secondary supports 145 may include one or more overhead electric hoist systems configured to remotely adjust the location of the one or more first fluid outlets 33 along multiple axes within a cleaning bay 102. In an embodiment, the one or more overhead secondary supports 145 may include one or more overhead worm-drive systems configured to remotely adjust the location of the one or more first fluid outlet 33 along multiple axes within a cleaning bay 102.

In an embodiment comprising one or more first fluid steam outlets 34, each of the one or more first fluid steam outlets 34 may be provided as part of a separate fluid delivery assembly that includes (1) one or more pressurized steam lines for conveying pressurized steam to the one or more first fluid steam outlets 34, (2) at least one retractable member (e.g., a retractable hose reel 163), in fluid communication with the one or more pressurized steam lines for directing a first fluid steam outlet 34 between one or more non-operating positions and one or more operating positions, and, depending on the configuration of the fluid delivery system, (3) at least one guide member (e.g., a pulley member 165 releasably secured to one or more overhead secondary supports 145 secured to the ceiling 135) similar to that described above with respect to the one or more first fluid outlets 33. In an embodiment, the one or more pressurized steam lines may include one or more steam pressure hoses with a maximum working temperature up to or about 210.0° C. (410.0° F.) and a maximum working pressure up to or about 1.8 MPa (261.06 psi).

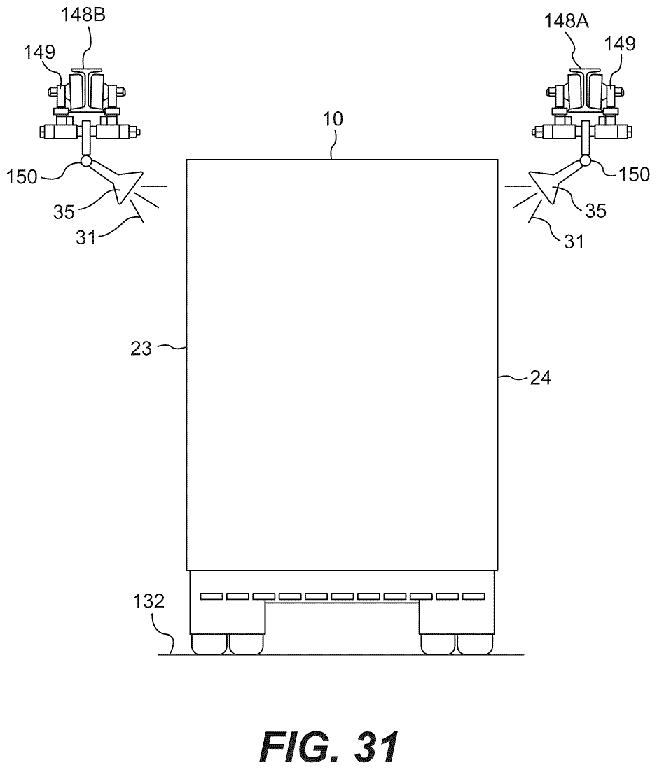

Referring to FIG. 31, in addition to acting as support surfaces for the one or more first fluid outlets 33 and the one or more second fluid outlets 35, in an embodiment the second I-beams 148A and/or 148B may also be configured as track type travel surfaces for one or more second fluid outlets 35. The one or more second fluid outlets 35 may be set or directed to one or more points along the length of each of the second I-beams 148A and/or 148B for focusing one or more pressurized fluid streams 31 toward one or more target areas along a left side exterior surface 23 and/or a right side exterior surface 24 of an enclosure 10 positioned within a corresponding cleaning zone 125. In an embodiment, a separate second fluid outlet 35 may be operably secured to each of the second I-beams 148A and 148B via a corresponding I-beam trolley 149. As understood in the art of I-beam trolleys, an I-beam trolley 149 of this disclosure may include (1) a manually operable I-beam trolley 149 configured to be manually directed along the length of a corresponding second I-beam 148A or 148B, or (2) an automated I-beam trolley 149 configured to be directed along the length of a corresponding second I-beam 148A or 148B in an alternating manner via (a) an electric motor system attached to the I-beam trolley 149 or (2) a linear chain-drive system 142, and/or combinations thereof, at one or more speeds in either direction along the length of a corresponding second I-beam 148A or 148B. Suitably, each of the second I-beams 148A and 148B comprises a length effective for the corresponding one or more second fluid outlets 35 to be located at one or more static positions along the full length of an enclosure 10 positioned within a corresponding cleaning zone 125 during operation of the system 100. In an embodiment, the second I-beams 148A and 148B may include lengths greater than the length of a cleaning zone 125 up to or about the length of a corresponding cleaning bay 102. In an embodiment, the second I-beams 148A and 148B may include lengths up to or about the length of a corresponding cleaning zone 125. In an embodiment, the second I-beams 148A and 148B may include lengths less than a corresponding cleaning zone 125, wherein the one or more second fluid outlets 35 are configured to cover all or substantially all of a corresponding cleaning zone 125 with one or more pressurized fluid streams 31. In an embodiment, one or more surface members other than the second I-beams 148A and 148B may be employed as support surfaces and/or travel surfaces for the one or more second fluid outlets 35 (e.g., H-beams, cylindrical tubing, square tubing). In an embodiment, overhead movement of the one or more second fluid outlets 35 may be accomplished via a strut channel trolley system and/or the like.

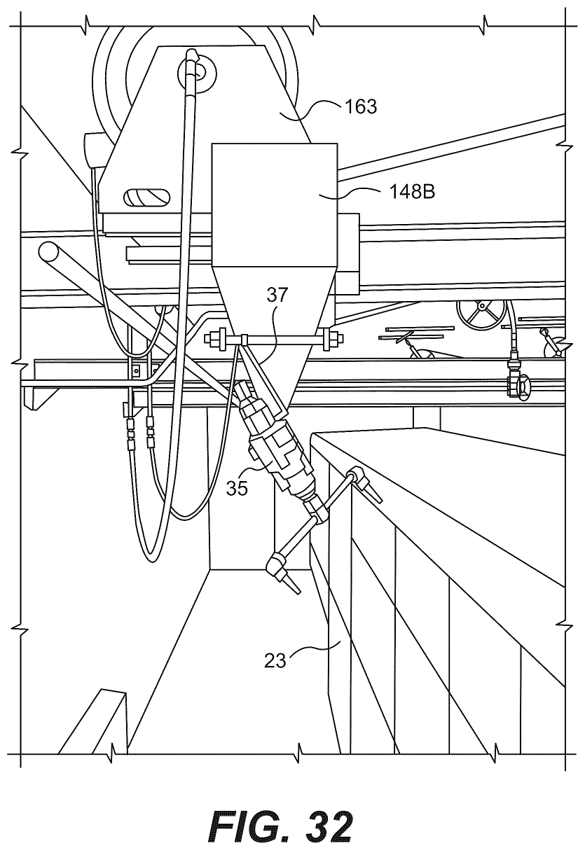

Referring to FIGS. 31 and 32, the one or more second fluid outlets 35 may be positioned at one or more altitudes along a cleaning zone 125 effective to direct one or more pressurized fluid streams 31 in at least one or more downward directions for impacting the external surfaces 23 and 24 of an enclosure 10 to promote external surface cleaning. In an embodiment, the one or more second fluid outlets 35 may be positioned in a fixed orientation. As shown in FIG. 31, in an embodiment the one or more second fluid outlets 35 may include adjustable swivel joints 150 allowing for customized orienting of the line of sight of the one or more second fluid outlets 35 for emitting one or more pressurized fluid streams 31 onto the external surfaces 23 and 24 of an enclosure 10 as desired. As shown in FIG. 32, in an embodiment, the one or more second fluid outlets 35 may each be secured to a corresponding bracket member 37 that is operably secured to a corresponding I-beam trolley 149. In an embodiment, a bracket member 37 may be provided as an adjustable member. In an embodiment, a bracket member 37 may be provided as a fixed member. Non-limiting examples of the one or more second fluid outlets 35 may include, but are not limited to, non-rotating nozzles, self-rotating nozzles (a.k.a., self-propelled nozzles or free spinning spray nozzles), and cluster nozzles. Non-limiting examples of non-rotating nozzles may include flat fan nozzles, hollow cone nozzles, full cone nozzles, misting nozzles, solid stream nozzles, and static multichannel spray ball nozzles. Non-limiting examples of self-rotating nozzles may include rotary jet nozzles, and rotary fan nozzles. Exemplary features for a second fluid outlet 35 of this disclosure for washing external surfaces 23 and 24 of an enclosure 10 are provided in Table 4 below.

TABLE 4

| Inlet | ½ | BSP F |
|---|---|---|
| Minimum Operating Pressure | 4.0 MPa (580.0 psi) | |
| Permissible Operating Pressure | 16.0 MPa (2300.00 psi) | |
| Rated Flow Rate | 20.0-60.0 | liters per minute |
| Rated Working Temperature | 0.0-90.0° C. (32.0-195.0° F.) | |
| Material of Construction | Stainless Steel 303 | |
| Seals Material | Fluoroelastomer (FKM) | |
| Nozzle Type | 3 × ¼ | Npt |
| Rated Rotation Speed | 180.0-260.0 | rpm |

One exemplary self-rotating type second fluid outlet 35 for system 100 operation includes the A43-FR2 self-rotating tank cleaner commercially available from P.A. SpA, Rubiera RE, Italy, or equivalent. Other commercial sources of self-rotating nozzles for system 100 operation may include, but are not limited to, Spraying Systems Co., Glendale Heights, Illinois, U.S.A. and Alfa Laval Inc., Richmond, Virginia, U.S.A.

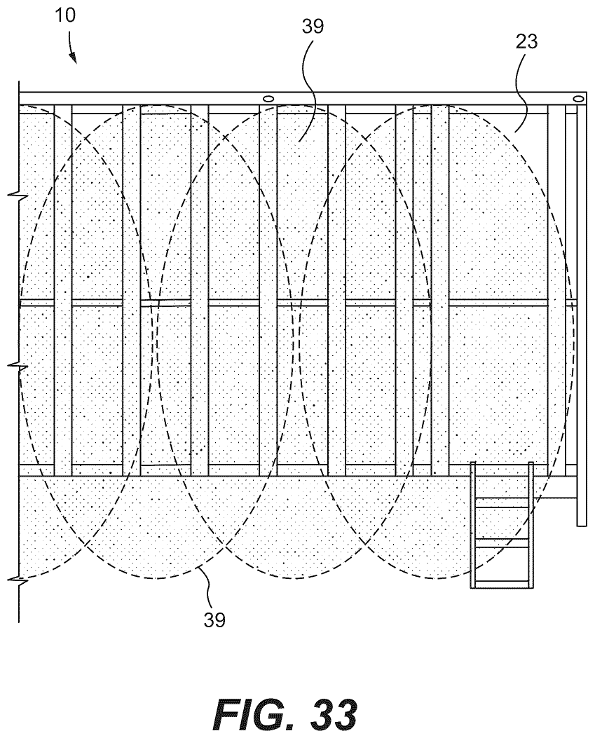

Referring to FIG. 31, in an embodiment each of the second I-beams 148A and 148B may include a second fluid outlet 35 secured to an automated I-beam trolley 149, wherein the I-beam trolleys 149 are configured to be directed along the length of the second I-beams 148A and 148B in an alternating manner at one or more speeds effective to operably impact the external surfaces 23 and 24 of an enclosure 10 positioned within a corresponding cleaning zone 125 with one or more pressurized fluid streams 31. In an embodiment wherein each of the second fluid outlets 35 includes a self-rotating nozzle as described in Table 4, the I-beam trolleys 149 may be configured to travel back and forth along the second I-beams 148A and 148B at a speed of or about 0.46 m/s (1.5 ft/s) effective for the second fluid outlets 35 to produce pressurized fluid streams 31 in a circular or oval-type overlapping spray pattern 39 as shown in FIG. 33. Suitably, the spray pattern 39 produced along the external surfaces 23 and 24 of an enclosure 10 is a function of the type of one or more second fluid outlets 35 used, the operating pressure of the one or more second fluid outlets 35, and the speed at which the I-beam trolleys 149 travel along the second I-beams 148A and 148B.

In an embodiment of a system 100 including one or more second fluid steam outlets 36, the one or more second fluid steam outlets 36 may be positioned within a cleaning bay 102 at one or more altitudes along the cleaning zone 125 effective to direct one or more steam fluid streams 38 in one or more directions for heating the external surfaces of an enclosure 10 to ensure microbicidal activity. In an embodiment, each of the one or more second fluid steam outlets 36 may be secured to the one or more primary supports 144 in a fixed orientation. In another embodiment, each of the one or more second fluid steam outlets 36 may be secured to the one or more primary supports 144 in an adjustable orientation. In an embodiment, each of the one or more second fluid steam outlets 36 may be secured to one or more support members attached to the first sidewall 131 and the second sidewall 133 in a fixed orientation. In another embodiment, each of the one or more second fluid steam outlets 36 may be secured to one or more support members attached to the first sidewall 131 and the second sidewall 133 in an adjustable orientation. Suitably, an operable location for each of the one or more second fluid steam outlets 36 does not hinder or otherwise interfere with operation of the second fluid outlets 35 and corresponding I-beam trolleys 149.

In an embodiment of a system 100 operationally configured to clean one or more enclosures 10 comprising removable outer panels (e.g., winter panels), the panels may be cleaned using one or more second fluid outlets 35 of a cleaning bay 102. In another embodiment, panels may be manually removed from an enclosure 10 and cleaned in a designated part of a cleaning bay 102. In another embodiment, panels may be manually removed from an enclosure 10 and cleaned in a location other than a cleaning bay 102 (e.g., cleaned in a wash cabin and/or the like). Exemplary panels are described in United States Patent Number U.S. Pat. No. 8,465,073 B2, titled “Panel Assembly for an Animal Transport Vehicle,” issued Jun. 18, 2013; which is herein incorporated by reference in its entirety.

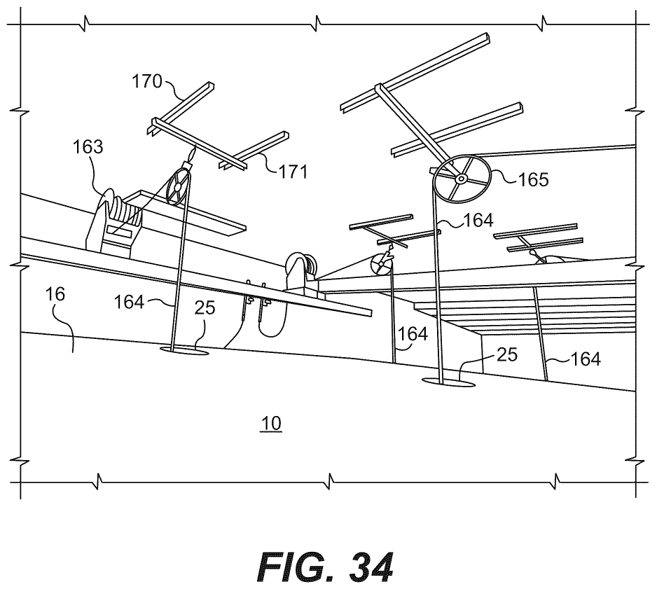

For operation of a cleaning bay 102 equipped with an overhead cleaning fluid dispensing system 130 as described above, any enclosure 10 to be washed in the cleaning bay 102 requires top-down entry of the one or more first fluid outlets 33 into the interior of the enclosure 10 for cleaning one or more interior surfaces of the one or more enclosure 10. As such, for purposes of cleaning a roofed enclosure 10, a roof 16 of a roofed enclosure 10 requires one or more apertures 25 (or “roof apertures 25”) for receiving the one or more first fluid outlets 33 there through to enable cleaning of one or more interior surfaces of the roofed enclosure 10 (see FIG. 34). As such, in an embodiment of a system 100 of this disclosure, one or more roofed enclosures 10 may be manufactured to include one or more roof apertures 25. In another embodiment, one or more roofed enclosures 10 may have one or more roof apertures 25 formed in the roof 16 post-production. Herein, one or more roof apertures 25 produced as original equipment of a roofed enclosure 10 may be referred to as “OE roof apertures 25” or “OE apertures 25,” and one or more roof apertures 25 produced post-production for a roofed enclosure 10 may be referred to as “post-production roof apertures 25” or “post-production apertures 25.”

As described herein, the location, size, shape and total number of one or more roof apertures 25 for receiving one or more first fluid outlets 33 there through may vary according to one or more factors, including, but not limited to: (1) the type of roofed enclosure 10, including the interior surface configuration or interior surface layout of the roofed enclosure 10 and the interior surface area of the roofed enclosure 10; (2) the type of one or more first fluid outlets 33 used (e.g., non-rotating nozzles and/or self-rotating nozzles); (3) the minimum impingement force(s) of the one or more fluid streams 30 at an optimum distance of each of the one or more first fluid outlets 33 from one or more target interior surfaces of the roofed enclosure 10; (4) a known or average level of fouling of the roofed enclosure 10; (5) any cleaning fluid consumption requirements for a cleaning operation; (6) any time constraints for completing a cleaning operation; and/or combinations thereof.

Some system 100 cleaning operations may require one or more fluid streams 30 with more turbulent action and/or higher temperatures and/or one or more additives compared to one or more other system 100 cleaning operations. For example, a roofed enclosure 10 as described herein presented with hardened contaminants caked onto one or more interior surfaces may require one or more fluid streams 30 with more turbulent action for removing the contaminants compared to the turbulent action required to remove contaminants such as fluids from interior surfaces of an enclosure 10. As such, in an embodiment, the cleaning operation characteristics of the system 100 may vary on a per-cleaning basis according to the level of fouling present in each individual enclosure 10. For example, cleaning operation characteristics may vary with respect to (1) the type(s) of one or more first fluid outlets 33 included for use, (2) the particular cleaning fluids used, (3) the duration of a cleaning operation, (4) the fluid stream 30 characteristics for a cleaning operation, and (5) the sequence or pattern of emission of the one or more first pressurized cleaning fluid streams 30 (or “fluid stream pattern”) from each individual first fluid outlet 33 during a cleaning operation. However, for ease of system 100 operation, in an embodiment a cleaning bay 102 may include one or more first fluid outlets 33 having one or more baseline operating characteristics, including one or more baseline fluid stream 30 characteristics, effective for cleaning one or more roofed enclosures 10 notwithstanding the interior surface configuration of the one or more roofed enclosures 10 and/or the characteristics of the one or more contaminants within the one or more roofed enclosures 10.

In an embodiment, the one or more first fluid outlets 33 may be configured to emit one or more fluid streams 30 that impact one or more interior surfaces of an enclosure 10 with sufficient spray impact up to a maximum optimum distance from the one or more interior surfaces effective to clean the one or more interior surfaces-herein referred to as a “operative spray range” for each of the one or more first fluid outlets 33. In an embodiment, an operative spray range may include one or more distances between a first fluid outlet 33 and one or more interior surfaces of an enclosure 10 wherein the one or more fluid streams 30 impact the one or more interior surfaces without atomization of the one or more fluid streams 30. In an embodiment, an operative spray range may include one or more distances between a first fluid outlet 33 and one or more interior surfaces of an enclosure 10 wherein the one or more fluid streams 30 exert a minimum impingement force upon one or more interior surfaces of an enclosure 10—herein referred to as an “impingement range” for a first fluid outlet 33. Stated differently, when a first fluid outlet 33 is located within a selected impingement range, then the one or more fluid streams 30 emitted out from the first fluid outlet 33 are effective to clean the one or more interior surfaces according to the minimum impingement forces exerted by the one or more fluid streams 30 upon the one or more target interior surfaces of an enclosure 10. For purposes of this disclosure, the impingement force of a fluid stream 30 emitted from a first fluid outlet 33 and impacting an interior surface of an enclosure 10 is a function of (1) the flow rate of the fluid stream 30, (2) the distance between the first fluid outlet 33 and the impacted interior surface, and (3) the operating pressure of the first fluid outlet 33. Accordingly, an optimum distance between a first fluid outlet 33 and one or more interior surfaces of a roofed enclosure 10 is a distance effective for exerting a minimum impingement force on the one more interior surfaces without creating dead spots or shadows.

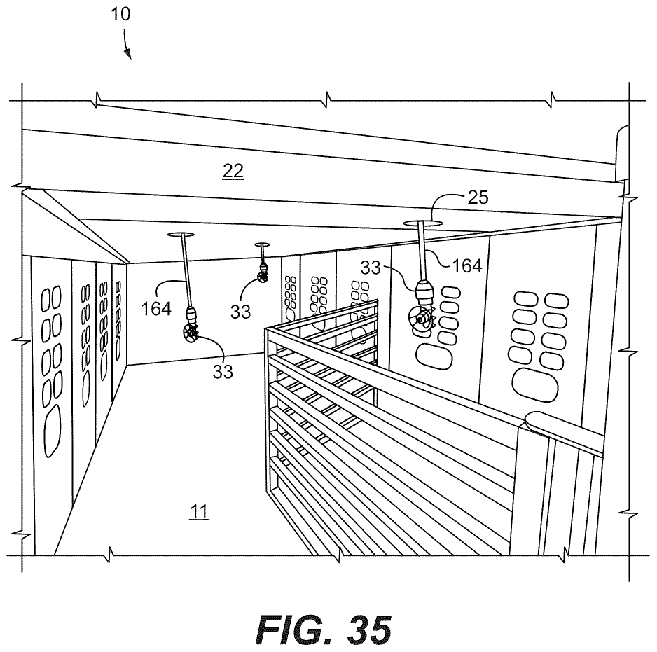

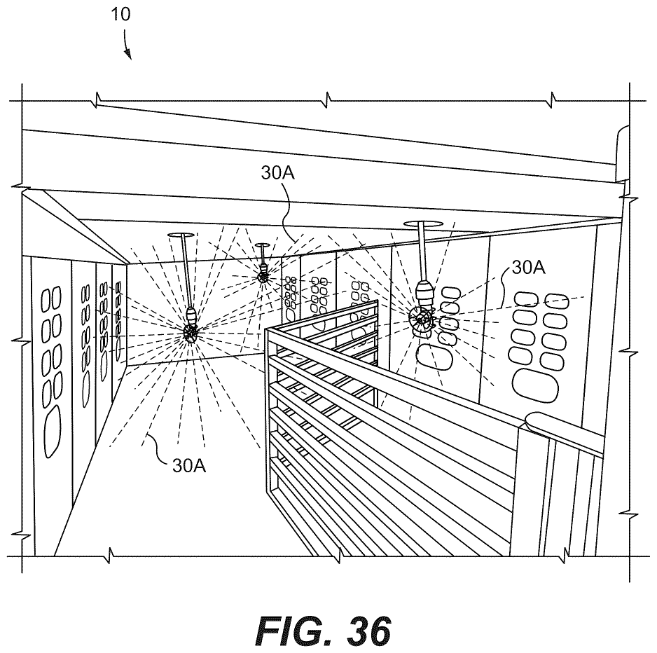

With reference to FIGS. 35 and 36, in an embodiment each of the one or more first fluid outlets 33 may be configured to produce one or more fluid streams 30 in a spherical pattern effective to exert a minimum impingement force upon one or more target interior surfaces of an enclosure 10 up to a selected optimum distance from the one or more target interior surfaces. Herein, one or more fluid streams 30 emitted in a spherical pattern from a first fluid outlet 33 within an impingement area may be referred to as an “impingement sphere 30A.” As shown in FIGS. 35 and 36, in an embodiment the one or more first fluid outlets 33 may be directed through corresponding roof apertures 25 to one or more points in space within an enclosure 10 effective to produce one or more impingement spheres 30A for cleaning the one or more interior surfaces of the enclosure 10 (i.e., effective to impact all interior surfaces of an enclosure 10 with one or more fluid streams 30 of a minimum impingement force). Although not necessarily required for each cleaning operation, as shown in FIG. 36, in an embodiment the one or more first fluid outlets 33 may be located within an enclosure 10 at points in space effective to produce overlapping impingement spheres 30A impacting all interior surfaces of an enclosure 10 with one or more fluid streams 30 of a minimum impingement force. Although a cleaning bay 102 of this disclosure is scalable, for cleaning enclosures 10 with maximum dimensions as listed in Table 2, the one or more first fluid outlets 33 may each be configured to produce an impingement sphere 30A comprising one or more fluid streams 30 effective to exert a minimum impingement force onto one or more interior surfaces of an enclosure 10 at a distance up to or about 3.1 meters (10.0 feet) from the one or more interior surfaces of the enclosure 10. In an embodiment for cleaning enclosures 10 with maximum dimensions as listed in Table 2 and at a flow rate and operating pressure range as described in Table 1, each of the one or more first fluid outlets 33 may produce an impingement sphere 30A comprising one or more fluid streams 30 effective to exert a minimum impingement force of or about 11216.88 gf (110.0 N) onto one or more interior surfaces of an enclosure 10 at a distance up to or about 3.1 meters (10.0 feet) from the one or more interior surfaces. In terms of an impingement sphere 30A as described in this paragraph, in an embodiment the total number of first fluid outlets 33 to be provided for cleaning the one or more interior surfaces of a roofed enclosure 10 may be determined using the formula [L+(r·Fcorr)2r]·[W+(r·Fcorr)√3r], where L is the length of the roofed enclosure 10, wherein W is the width of the roofed enclosure 10, where r is the impingement radius of a first fluid outlet 33, and where Fcorr is a correction factor.

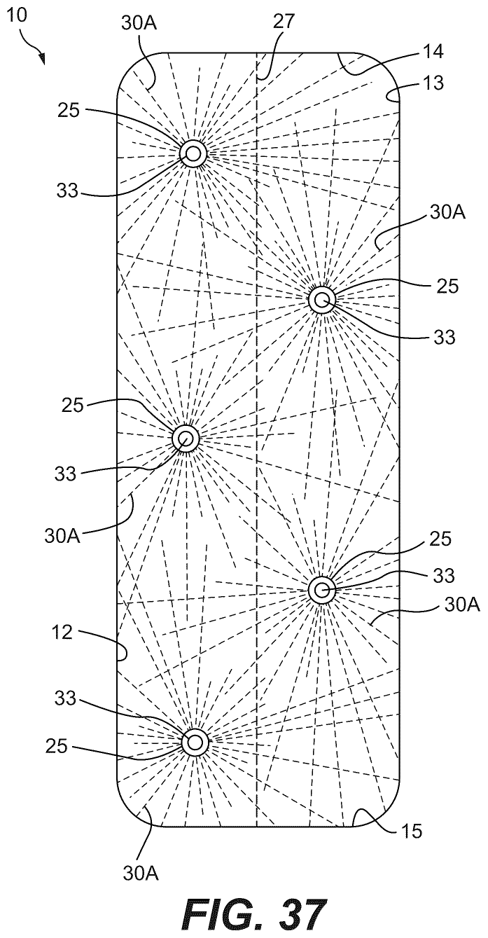

While the surface area of the roof 16 and the size and/or shape of each roof aperture 25 may define an upper limit on the number of roof apertures 25 that can be formed in a given roofed enclosure 10, the use of one or more first fluid outlets 33 having known impingement spheres 30A enables, in an embodiment, a system 100 of this disclosure to be configured to minimize the total number of roof apertures 25 necessary to clean the interior surfaces of the roofed enclosure 10. As an example, in an embodiment employing one or more first fluid outlets 33, each characterized by an impingement sphere 30A of or about 3.1 meters (10.0 feet), the minimum number of roof apertures 25 to be provided in a roofed enclosure 10 may be determined based on the inner dimensions of the roofed enclosure 10 and the configuration of the interior surfaces of the roofed enclosure 10. With reference to FIG. 37, in a simplified example of a roofed enclosure 10 having an open interior compartment similar to that shown in FIG. 11, when employing first fluid outlets 33, each characterized by an impingement sphere 30A of or about 10.0 feet, and with knowledge of the inner dimensions of the roofed enclosure 10, it may be determined that a minimum of five (5) roof apertures 25 is required to introduce five (5) first fluid outlets 33 into the interior of the roofed enclosure 10 at locations effective to emit overlapping impingement spheres 30A such that interior surfaces 12, 13, 14 and 15 of the roofed enclosure 10 are impacted for satisfactory or passable cleaning of the interior of the roofed enclosure 10.

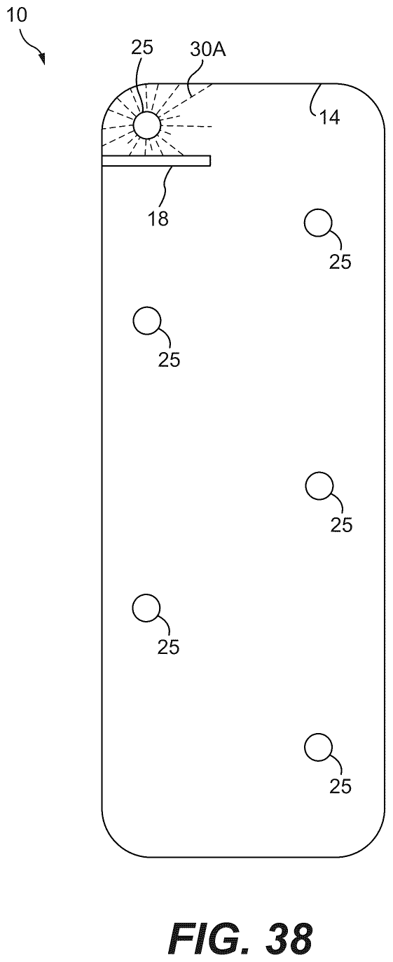

In the illustration of FIG. 37, the roof apertures 25 are shown disposed along the roof 16 in an alternating pattern with three (3) roof apertures located on a left side of a center line 27 of the roofed enclosure 10 and two (2) apertures located on a right side of the center line 27 effective for first fluid outlets 33 to emit overlapping impingement spheres 30A to ensure cleaning of the interior surfaces 12, 13, 14 and 15 of the roofed enclosure 10. As described herein, in addition to considering the inner dimensions of a roofed enclosure 10 and the impingement spheres 30A associated with each of the one or more first fluid outlets 33, the configuration of the interior surfaces of a roofed enclosure 10 may also determine the layout and number of roof apertures 25 for a particular roofed enclosure 10. In a simplified example, a roofed enclosure 10 similar as the roofed enclosure 10 of FIG. 37 may be provided but further including a vertical divider 18 or the like located near the forward wall 14 of the roofed enclosure 10 (see FIG. 38). As shown, the roofed enclosure 10 may require an additional sixth roof aperture 25 at a location effective for positioning a first fluid outlet 33 to emit a sixth impingement sphere 30A, or at least one or more fluid streams 30, onto a forward side of the divider 18 to ensure cleaning of all of the interior surfaces of the roofed enclosure 10.

Although scalable and not limited to a particular shape, for purposes of cleaning enclosures 10 with maximum dimensions as listed in Table 2 and one or more first fluid outlets 33 having features as provided in Table 3, the one or more roof apertures 25 formed in a roof 16 of roofed enclosure 10 may each include a circular or substantially circular shape of an inner dimension from or about 17.78 cm (7.0 inches) to or about 25.4 cm (10.0 inches). In a particular embodiment, the one or more roof apertures 25 formed in a roof 16 of roofed enclosure 10 may each include a circular or substantially circular shape with an inner dimension of or about 20.32 cm (8.0 inches).

In an embodiment, the first fluid outlets 33 may be configured to produce one or more fluid streams 30 in one or more wave patterns or dispersal sequences to promote directing one or more contaminants toward a rear end 19 of a roofed enclosure 10 and to minimize blowback of the one or more contaminants toward a forward wall 14 that may otherwise occur due to the directional flow of the one or more fluid streams 30 emitted from the first fluid outlets 33. For example, in an embodiment including first fluid outlets 33 configured to emit overlapping impingement spheres 30A, the first fluid outlets 33 may be turned ON and OFF in sequential order beginning with the first fluid outlet 33 nearest the forward wall 14 and ending with the first fluid outlet 33 nearest the rear end 19, thereby forming a directional wave pattern of fluid streams 30 from the forward wall 14 to the rear end 19 (e.g., forming a directional fluid curtain within the roofed enclosure 10).

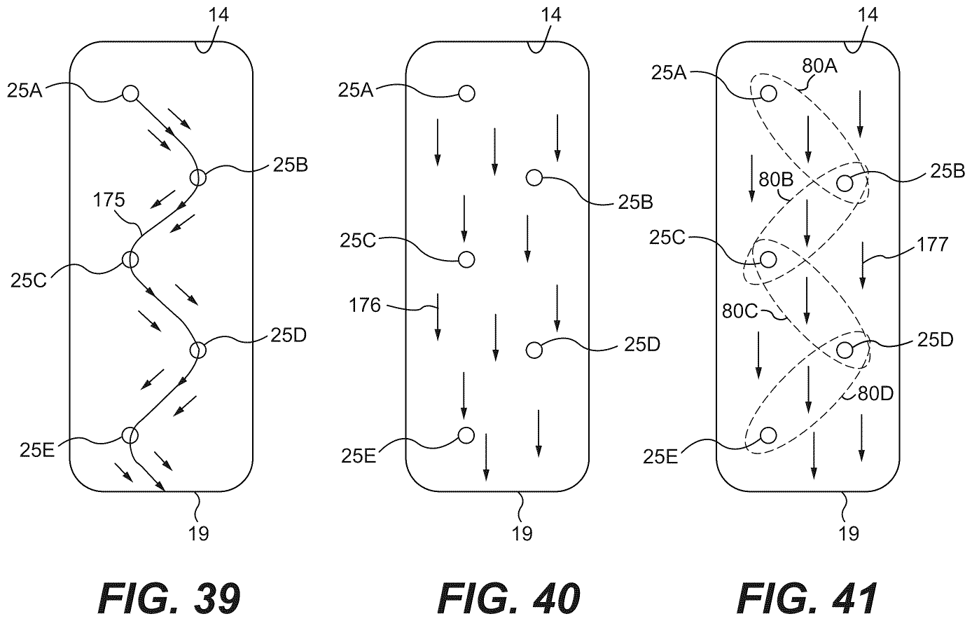

As shown in the non-limiting illustrations of FIGS. 39 and 40, in an embodiment the general direction of flow of a directional wave pattern may be determined, at least in part, according to the layout of the corresponding roof apertures 25 for each of the first fluid outlets 33 and/or the flow rate and/or the operating pressure of each individual first fluid outlet 33. In FIG. 39, the directional wave pattern 175 is shown as a generally serpentine-type directional wave pattern 175 according to the layout of the corresponding roof apertures 25A-25E. In FIG. 40, the directional wave pattern 176 is shown as a generally linear type directional wave pattern 176 according to the layout of the corresponding roof apertures 25A-25E. In an embodiment, the first fluid outlets 33 may be turned ON and OFF repetitively sequentially providing a series of directional wave patterns 175 or 176 of a particular number of cycles of the first fluid outlets 33. In an embodiment, the first fluid outlets 33 may be turned ON and OFF repetitively sequentially providing a series of directional wave patterns 175 or 176 for one or more particular periods of time.

In an embodiment, two or more first fluid outlets 33 may be turned ON and OFF in sequential order beginning with a grouping of first fluid outlets 33 nearest a forward wall 14 of a roofed enclosure 10 and ending with a grouping of first fluid outlets 33 nearest a rear end 19 of a roofed enclosure 10. For example, as shown in the illustration of FIG. 41, a desired directional wave pattern 177 may be formed within a roofed enclosure 10 according to sequential operation of (1) a first grouping 80A of first fluid outlets 33 nearest a forward wall 14 of a roofed enclosure 10 corresponding to roof apertures 25A and 25B, (2) a second grouping 80B of first fluid outlets 33 corresponding to roof apertures 25B and 25C, (3) a third grouping 80C of first fluid outlets 33 corresponding to roof apertures 25C and 25D, and (4) a fourth grouping 80D of first fluid outlets 33 corresponding to roof apertures 25D and 25E. In an embodiment, a desired directional wave pattern 177 may be determined, at least in part, according to the combined flow rate of each grouping of first fluid outlets 33 and/or the combined operating pressure of each grouping of first fluid outlets 33 and/or the layout of the corresponding roof apertures 25. As shown in FIG. 41, a directional wave pattern 177 may include a generally linear type directional wave pattern 177. In another embodiment, a directional wave pattern 177 may include a generally serpentine-type directional wave pattern similar to wave pattern 175. In an embodiment, the first fluid outlets 33 of each grouping may be turned ON and OFF repetitively sequentially providing a series of directional wave patterns 177 of a particular number of cycles of the groupings of first fluid outlets 33. In an embodiment, the first fluid outlets 33 of each grouping may be turned ON and OFF repetitively sequentially providing a series of directional wave patterns 177 for one or more particular periods of time.

With further reference to FIG. 41, in a non-limiting example, groupings comprised of a single first fluid outlet 33 and multiple first fluid outlets 33 for use with roof apertures 25A-25E may be turned ON and OFF according to a cleaning sequence as shown in Table 5 below.

TABLE 5

| Grouping | ON Position Cleaning Sequence |
|---|---|
| 1 | 25A |
| 2 | 25A, 25B |
| 3 | 25A, 25B, 25C |
| 4 | 25B, 25C, 25D |
| 5 | 25C, 25D, 25E |
| 6 | 25D, 25E |
| 7 | 25E |

Each ON position of the cleaning sequence of Table 5 may have a run time as desired and the cleaning sequence may be performed one or more times as desired. As a non-limiting example, each ON position of the cleaning sequence may have a run time of or about sixty (60) seconds equating to a total run time per individual first fluid outlet 33 of or about three (3) minutes.

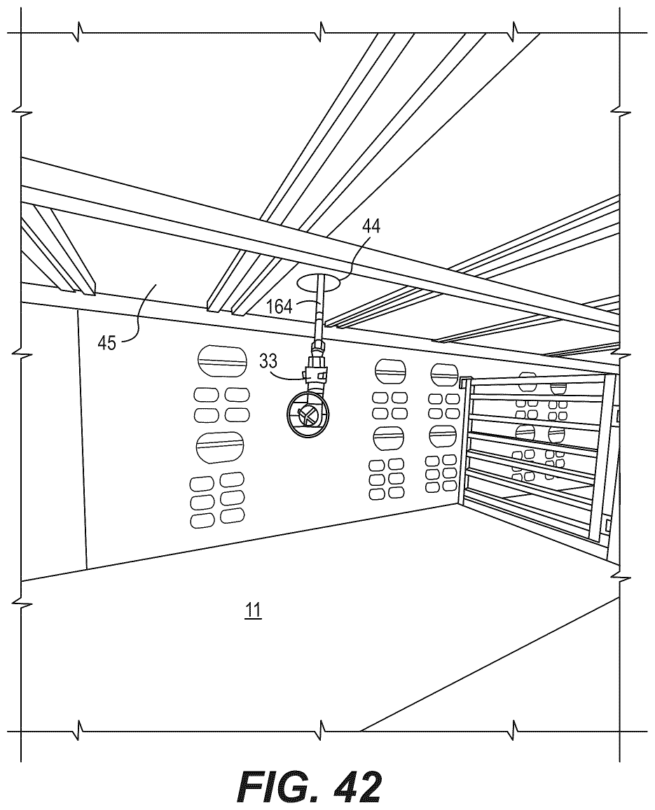

As described above, a roofed enclosure 10 having an open interior compartment similar as shown in FIG. 11 requires locating one or more roof apertures 25 along a roof 16 of the roofed enclosure 10 in a manner effective to position one or more first fluid outlets 33 within the interior compartment at one or more points in space effective to clean the interior surfaces of the roofed enclosure 10 without any dead spots or shadows. However, in an embodiment of a multi-deck roofed enclosure 10 as shown in FIG. 9 including one or more deck floors 17 defining a plurality of decks within the roofed enclosure 10, each of the one or more deck floors 17 requires one or more deck floor apertures operable as one or more access points for each of the one or more first fluid outlets 33 into successive lower deck spaces of the roofed enclosure 10 for purposes of cleaning the interior surfaces of each of the lower deck spaces (see deck floor aperture 44 in FIG. 42 configured to receive a first fluid outlet 33 there through).

As described above, each of the one or more first fluid outlets 33 of a system 100 may be configured to be directed up and down vertically within a cleaning bay 102 along the Z-axis. As such, each of the one or more deck floor apertures 44 of a multi-deck roofed enclosure 10 are aligned vertically or substantially vertically with a corresponding roof aperture 25 in a manner effective to form one or more vertical pathways for each of the one or more fluid outlets 33 within an enclosure 10 effective for washing one or more interior surfaces of each deck space including the underside(s) of the one or more deck floors 17 (see bottom surface 45 of the deck floor in FIG. 42). Although not limited to a particular size and shape, in an embodiment, the one or more deck floor apertures 44 may include a size and shape the same or substantially similar as the size and shape of the corresponding roof apertures 25.

In an embodiment, one or more roofed enclosures 10 may be manufactured with one or more deck floor apertures 44. In another embodiment, one or more roofed enclosures 10 may have one or more deck floor apertures 44 formed in one or more deck floors 17 post-production. For purposes of this disclosure, deck floor apertures 44 provided as original equipment of a roofed enclosure 10 may be referred to as “OE deck floor apertures 44” or “OE apertures 44,” and deck floor apertures 44 added post-production may be referred to as “post-production deck floor apertures 44” or “post-production apertures 44.”

In regard to a multi-deck roofed enclosure 10, the locations of the one or more vertical pathways within the roofed enclosure 10 are determined on a deck-by-deck basis effective for cleaning the interior surfaces of the roofed enclosure 10 without dead spots or shadows. In other words, with knowledge of an operative spray range for each of the one or more first fluid outlets 33 of a system 100, one or more vertical pathways may be established according to one or more cleaning requirements of one or more bottommost deck spaces of a roofed enclosure 10, one or more vertical pathways may be established according to one or more cleaning requirements of one or more intermediate deck spaces of a roofed enclosure 10, and one or more vertical pathways may be established according to one or more cleaning requirements of one or more uppermost deck spaces of a roofed enclosure 10.

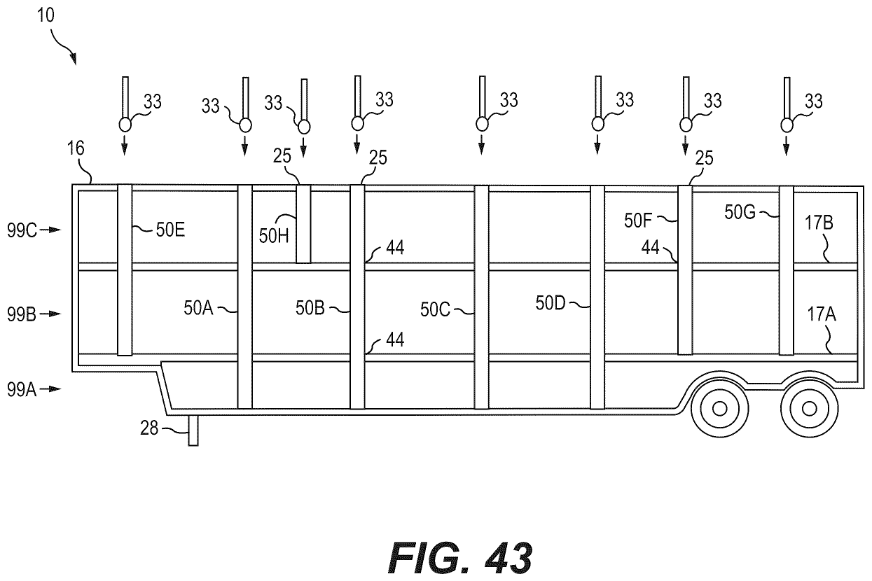

Referring to FIG. 43, in an exemplary embodiment a three-deck roofed enclosure 10 may require a total of four vertical pathways 50A-50D that are formed through a roof 16, a first deck floor 17A (or “lower deck floor 17A”) and a second deck floor 17B (or “upper deck floor 17B”) providing access for corresponding first fluid outlets 33 into a bottommost deck space 99A, an intermediate deck space 99B and an uppermost deck space 99C of the roofed enclosure 10. Suitably, the vertical pathways 50A-50D are formed along the roofed enclosure 10 at locations allowing each of the corresponding first fluid outlets 33 to be positioned at one or more points within the bottommost deck space 99A according to its operative spray range effective for cleaning the interior surfaces of the bottommost deck space 99A without dead spots or shadows. As shown, the locations of the vertical pathways 50A-50D also allow each of the corresponding first fluid outlets 33 to be positioned at one or more points within the intermediate deck space 99B and within the uppermost deck space 99C for cleaning one or more interior surfaces of the intermediate deck space 99B and cleaning one or more interior surfaces of the uppermost deck space 99C according to an operative spray range of each of the corresponding first fluid outlets 33.

In an embodiment of a multi-deck roofed enclosure 10 having uniform deck spaces, the vertical pathways formed for cleaning a bottommost deck space may also define the vertical pathways effective for cleaning any intermediate deck spaces and an uppermost deck space. As shown in FIG. 43, in an embodiment comprising deck spaces 99A-99C that vary in shape and/or size, one or more additional vertical pathways may be formed in the roofed enclosure 10 at one or more locations for positioning one or more first fluid outlets 33 within the intermediate deck space 99B and/or the uppermost deck space 99C according to an operative spray range for each first fluid outlet 33 effective to clean the interior surfaces of the intermediate deck space 99B and/or the uppermost deck space 99C. In the illustration of FIG. 43, the roofed enclosure 10 includes three vertical pathways 50E-50G formed through the roof 16 and second deck floor 17B providing access for corresponding first fluid outlets 33 into the intermediate deck space 99B and the uppermost deck space 99C. As shown, the roofed enclosure 10 also includes a vertical pathway 50H formed through the roof 16 providing access for a corresponding first fluid outlet 33 into the uppermost deck space 99C. Collectively, the vertical pathways 50A-50H provide access for one or more first fluid outlets 33 to be positioned at one or more points within the roofed enclosure 10 according to their operative spray ranges effective for cleaning all interior surfaces of each of the deck spaces 99A, 99B and 99C.

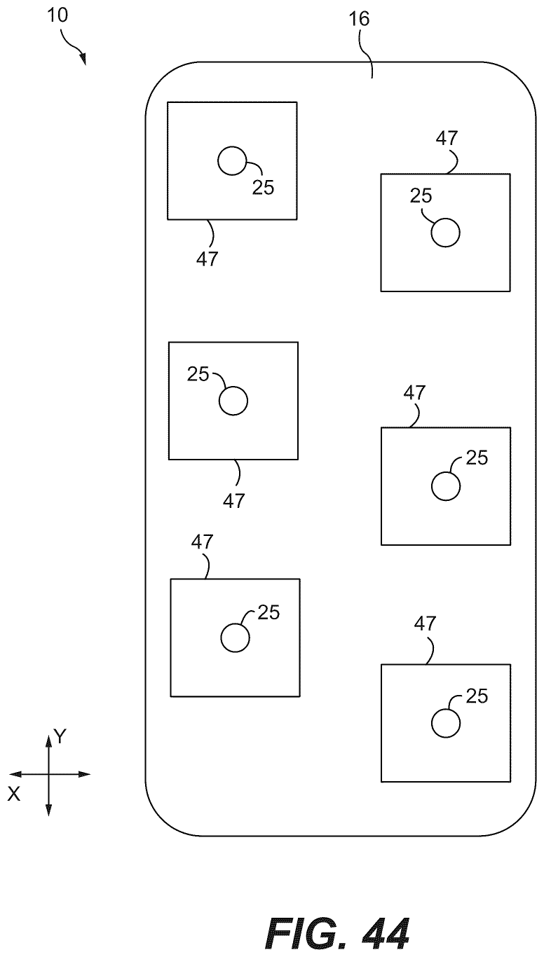

As stated above, an overhead cleaning fluid dispensing system 130 of this disclosure may include one or more overhead secondary supports 145 located at points above a cleaning zone 125 of a cleaning bay 102 in a manner effective for the one or more first fluid outlets 33 to be adjusted along the X-axis and/or the Y-axis within a cleaning bay 102 to vertically align the one or more first fluid outlets 33 with corresponding roof apertures 25 for a cleaning operation. In an embodiment of a system 100, one or more overhead secondary supports 145 may be located at one or more points above a cleaning zone 125 of a cleaning bay 102 in a layout corresponding to a layout of one or more roof apertures 25 of one or more known roofed enclosures 10. In such an embodiment, when a known roofed enclosure 10 is operably positioned in a cleaning zone 125 of the cleaning bay 102 (e.g., via a laser parking system as described above), each of the one or more roof apertures 25 is suitably located under a corresponding overhead secondary support 145 in a vicinity effective for each of the first fluid outlets 33 to be vertically aligned with a particular roof aperture 25. With reference to FIG. 44, because each of the one or more known roofed enclosures 10 may not be positioned in exactly the same location within a cleaning zone 125 for each separate cleaning event, the configuration of each of the one or more overhead secondary supports 145 allows each first fluid outlet 33 to be adjusted along the X-axis and/or the Y-axis within a defined alignment area 47 to vertically align the first fluid outlet 33 with its corresponding roof aperture 25 as required.

As stated above, one or more overhead secondary supports 145 may be positioned at one or more points above a cleaning zone 125 of a cleaning bay 102 in a layout corresponding to the layout of the one or more roof apertures 25 of one or more target roofed enclosures 10. Accordingly, in an embodiment, the total number of overhead secondary supports 145 and first fluid outlets 33 provided in a particular cleaning bay 102 may match the total number of roof apertures 25 for the one or more roofed enclosures 10 to be washed in the cleaning bay 102. As such, in an embodiment, once a number and layout of one or more vertical pathways for the one or more particular roofed enclosures 10 of the system 100 is known, at least an equal number of overhead secondary supports 145 and first fluid outlets 33 may be installed above a cleaning zone 125 in a layout corresponding to the layout of the vertical pathways and the locations of those vertical pathways when the one or more roofed enclosures 10 are operably positioned in the cleaning zone 125 for cleaning according to a laser parking system of the system 100.

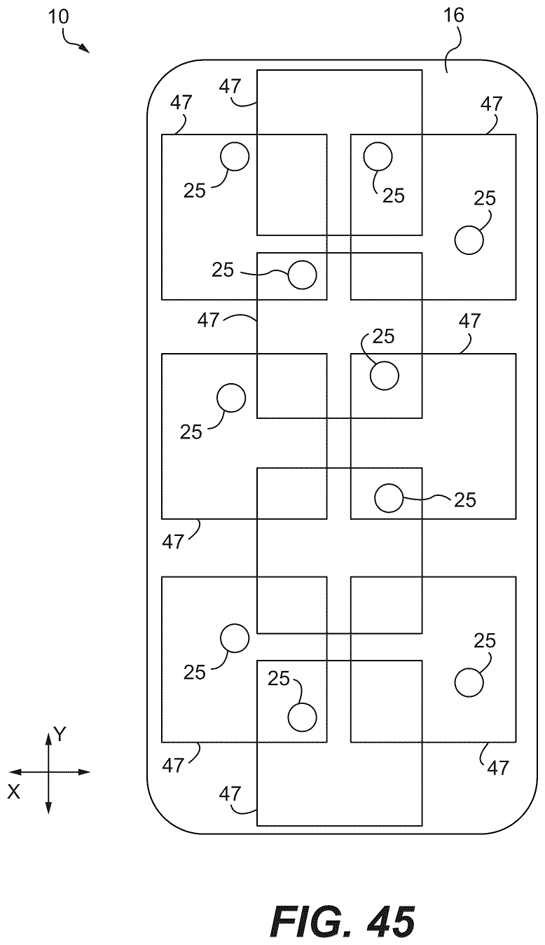

In an embodiment of a system 100 configured to clean dissimilar roofed enclosures 10 having dissimilar roof-aperture counts and dissimilar roof-aperture layouts, a suitable number of overhead second supports 145 and first fluid outlets 33 may be installed above a cleaning zone 125, wherein an alignment area 47 for each of the one or more first fluid outlets 33 encompasses a sufficiently large region to allow each first fluid outlet 33 to be adjusted along the X-axis and/or the Y-axis at distances effective to cover all of the roof apertures 25 of a particular roofed enclosure 10 (see FIG. 45).

In an embodiment, the total number of overhead secondary supports 145 and first fluid outlets 33 may match the total number of roof apertures 25 for one or more different known roofed enclosures 10, based on the roofed enclosure 10 having the highest roof-aperture count. For example, in an embodiment of a system 100 including known roofed enclosures 10 having nine (9) roof apertures 25, known roofed enclosures 10 having ten (10) roof apertures 25, and known roofed enclosures 10 having eleven (11) roof apertures 25, a cleaning bay 102 may include at least eleven (11) overhead secondary supports 145 and at least eleven (11) first fluid outlets 33. By including a maximum number of first fluid outlets 33 in a cleaning bay 102 that at least matches the highest roof-aperture count for a known roofed enclosure 10 of a system 100 to be washed in a cleaning bay 102, the system 100 may be configured to clean a roofed enclosure 10 using a first fluid outlet 33 in each of the vertical pathways of the roofed enclosure 10 simultaneously, as may be desired or otherwise required for a particular wash operation.

In an embodiment, a PLC of the system 100 may include or otherwise access one or more databases storing information for each individual roofed enclosure 10 of the system 100, including, but not limited to: the type of roofed enclosure 10; the total number of vertical pathways of the roofed enclosure 10; the location of each vertical pathway (i.e., the location of each roof aperture 25 when the roofed enclosure 10 is operably positioned in a cleaning zone 125); the depth of each vertical pathway of the roofed enclosure 10; the total number of deck spaces associated with each vertical pathway of the roofed enclosure 10; and an estimated level of fouling for the roofed enclosure 10 based on the one or more types of livestock transported in the roofed enclosure 10 prior to a cleaning operation.

In an embodiment of a system 100 including one or more first fluid steam outlets 34, the vertical pathways of a roofed enclosure 10 (e.g., vertical pathways 50A-50H) may provide access for the one or more first fluid steam outlets 34 to be positioned at one or more points in space within the roofed enclosure 10, wherein the one or more first fluid steam outlets 34 are configured to collectively heat the interior surfaces of the roofed enclosure 10 in a manner effective to ensure microbicidal activity. In an embodiment, the one or more first fluid steam outlets 34 may be configured to emit one or more steam fluid streams 32 effective to heat one or more interior surfaces of the roofed enclosure 10 to one or more temperatures, at distances optimal for ensuring microbicidal activity-herein referred to as a “steam cleaning area” for each of the one or more first fluid steam outlets 34. Herein, the one or more first fluid steam outlets 34 may include one or more low pressure and/or high pressure steam nozzles (e.g., flat fan spray nozzles, cone spray nozzles).

In an embodiment, a steam treatment for a roofed enclosure 10 may be performed as an isolated operation separate from cleaning the roofed enclosure 10 via the one or more first fluid outlets 33, such that the one or more first fluid outlets 33 and the one or more first fluid steam outlets 34 do not simultaneously occupy common vertical pathways (e.g., vertical pathways 50A-50H). In another embodiment, the one or more first fluid steam outlets 34 and the one or more first fluid outlets 33 may be directed into and occupy common vertical pathways (e.g., vertical pathways, 50A-50H) during a cleaning operation of a roofed enclosure 10.

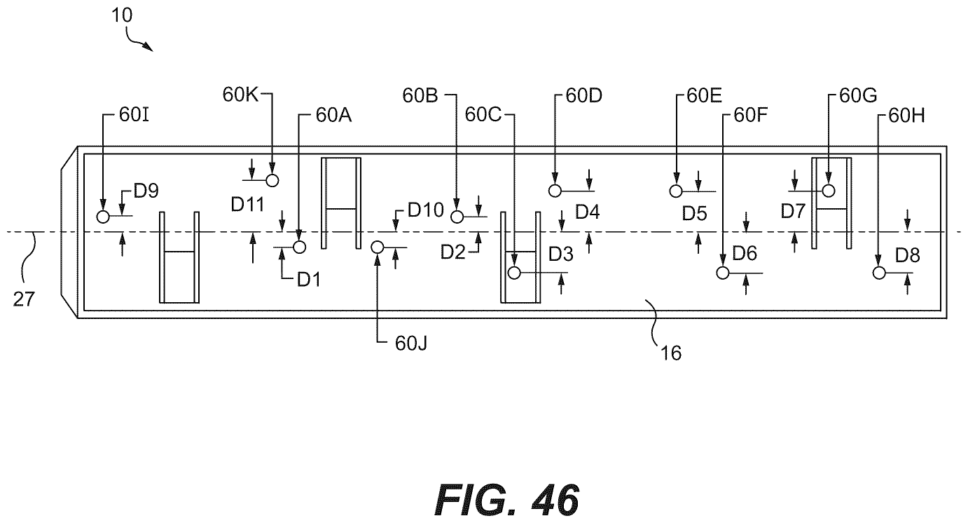

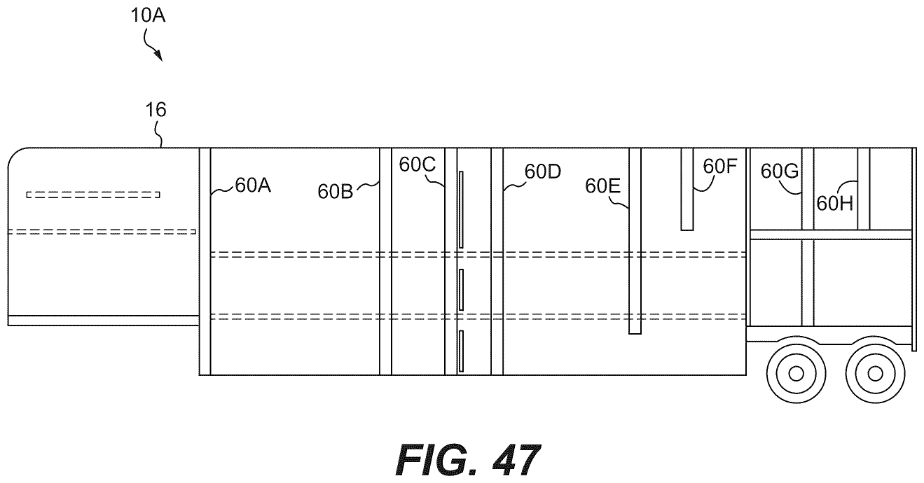

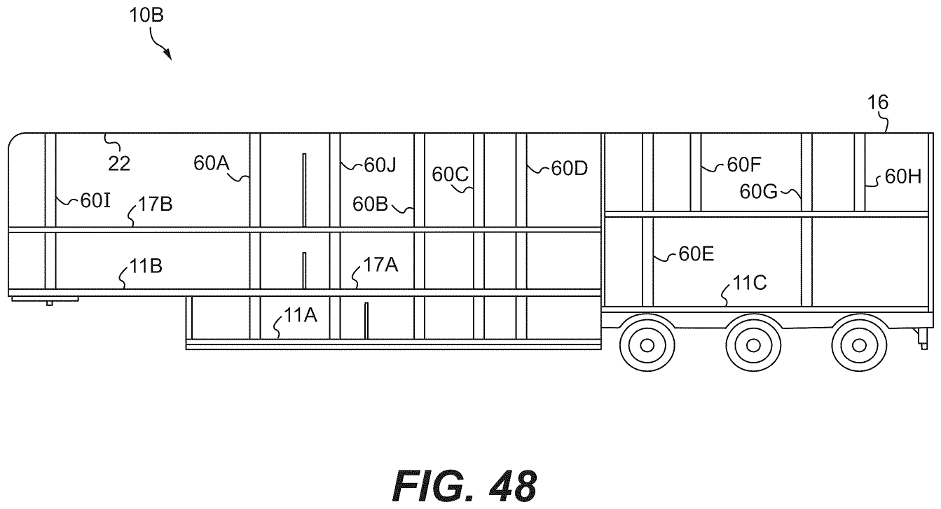

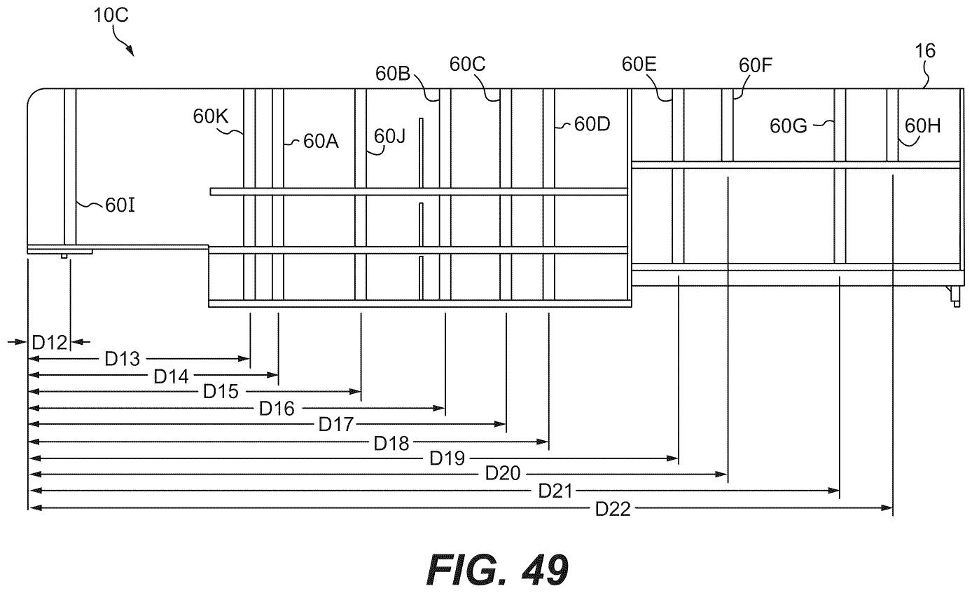

Referring now to FIGS. 46-49, in an embodiment, a system 100 of this disclosure may include a plurality of different roofed enclosures 10, wherein the operative spray ranges of one or more first fluid outlets 33 of the system 100 are configured to clean various interior spaces of each of the roofed enclosures 10 in a manner effective to allow each of the roofed enclosures 10 to include a common vertical pathway layout (i.e., a common roof aperture 25 layout) up to a certain number of vertical pathways formed in each roofed enclosure 10. In this example, three different roofed enclosures 10 with different total vertical pathway counts are provided, each having a total of eight (8) common vertical pathways, namely: (1) Enclosure 10A, which, in this example, is a 14.6 meter (48.0 feet) long, 2.6 meters (8.5 feet) wide, multi-deck double-axle animal transport roofed enclosure 10 (FIG. 47); (2) Enclosure 10B, which, in this example, is a 15.9 meter (52.0 feet) long, 2.6 meters (8.5 feet) wide, lift deck triple-axle animal transport roofed enclosure 10 (FIG. 48); and (3) Enclosure 10C, which, in this example, is a 15.9 meter (52.0 feet) long, 2.6 meters (8.5 feet) wide, triple-deck triple-axle animal transport roofed enclosure 10 (FIG. 49). As shown in FIGS. 47-49, vertical pathways 60A-60H are common to all three roofed enclosures 10A, 10B, and 10C.

As shown in FIG. 47, vertical pathways 60A-60H define the total number of vertical pathways for Enclosure 10A effective for cleaning the interior surfaces of Enclosure 10A. As shown in FIG. 48, in addition to vertical pathways 60A-60H, Enclosure 10B further comprises vertical pathways 60I and 60J, which allow first fluid outlets 33 to be positioned at one or more points in space within Enclosure 10B according to their operative spray ranges to ensure cleaning of all interior surfaces of Enclosure 10B not otherwise cleaned by the first fluid outlets 33 located in vertical pathways 60A-60H. As shown in FIG. 49, in addition to vertical pathways 60A-60J, Enclosure 10C comprises additional vertical pathway 60K for a first fluid outlet 33 to be positioned at one or more points in space within Enclosure 10C according to its operative spray range to ensure cleaning all interior surfaces of Enclosure 10C not otherwise cleaned by the first fluid outlets 33 located in vertical pathways 60A-60J.

With reference to FIG. 46, regarding the common vertical pathways 60A-60H as depicted, the vertical pathways 60A, 60C, 60F and 60H are disposed along a first side of the center line 27 for each of Enclosures 10A, 10B, and 10C and vertical pathways 60B, 60D, 60E and 60G are disposed along a second side of the center line 27 for each of Enclosures 10A, 10B, and 10C. As further shown, vertical pathway 60I is disposed along the second side of the center line 27 and vertical pathway 60J is disposed along the first side of the center line 27 for each of Enclosures 10B and 10C. Also, vertical pathway 60K is disposed along the second side of the center line 27 for Enclosure 10C. In an embodiment including one or more first fluid outlets 33 configured to produce one or more impingement spheres 30A as described above, the distribution and depth of each of the vertical pathways 60A-60K is effective to produce impingement spheres 30A within each of Enclosures 10A, 10B, 10C for cleaning of all interior surfaces of Enclosures 10A, 10B, 10C.

As stated above, one or more roof apertures 25 and one or more deck floor apertures 44 of a roofed enclosure 10 may be provided as post-production roof apertures 25 and post-production deck floor apertures 44. In such embodiment, each of the one or more post-production roof apertures 25 and post-production deck floor apertures 44 may be formed using one or more tools and/or other instruments according to the thickness, shape, and materials of construction of the roof 16 and deck floor(s) 17 of a particular roofed enclosure 10. For example, in an embodiment of a roofed enclosure 10 including a roof 16 and one or more deck floors 17 constructed of aluminum, one or more post-production roof apertures 25 may be formed in the roof 16 and one or more post-production deck floor apertures 44 may be formed in the one or more deck floors 17 using a tool including, but not limited to, a punch tool, a cutting instrument such as a jigsaw or the like, a torch cutting tool, and/or combinations thereof.

As also stated above, one or more roof apertures 25 and one or more deck floor apertures 44 of a roofed enclosure 10 may be provided as OE roof apertures 25 and OE deck floor apertures 44. In such embodiment, each of the one or more OE roof apertures 25 and OE deck floor apertures 44 may be formed according to one or more aperture forming techniques including, but not limited to, the aperture techniques used to form post-production roof apertures 25 and post-production deck floor apertures 44. In an embodiment, OE roof apertures 25 and OE deck floor apertures 44 may be formed in a roof 16 and one or more deck floors 17 via a processes including, but not limited to, molding processes, casting processes, forging processes, machining processes, and/or combinations thereof.

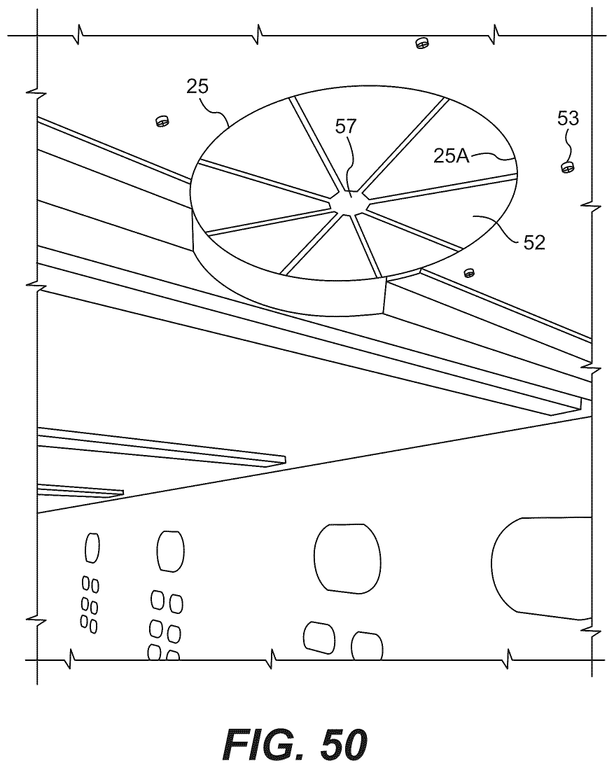

In an embodiment, the one or more roof apertures 25 of a roofed enclosure 10 may be provided with roof aperture 25 cover members, for example, one or more removable cover plates, one or more removable fastenable cover plates, one or more slide plates, one or more hinged flip-up covers, one or more removable threaded covers, one or more removable twist-lock covers, one or more removable plug members, and/or combinations thereof. In an embodiment, the one or more roof aperture 25 cover members may be set at a closed position and then set to an opened position or otherwise removed from corresponding roof apertures 25 for cleaning the interior of a roofed enclosure 10. In an embodiment, a closed position of a roof aperture 25 cover member may further comprise a sealed position of the roof aperture 25 cover member with a corresponding roof aperture 25. To avert placing personnel on a roof 16 of a roofed enclosure 10 for purposes of opening and closing the one or more roof aperture 25 cover members, in an embodiment, each of the one or more roof apertures 25 of a roofed enclosure 10 may be provided with a resilient roof aperture 25 cover member 52 (or “resilient cover member 52”) as shown in FIG. 50. Herein, a roof aperture 25 provided with a roof aperture 25 cover member may be referred to as a “roof hatch.” A roof aperture 25 provided with a resilient roof aperture 25 cover member may be referred to as a “resilient roof hatch.”

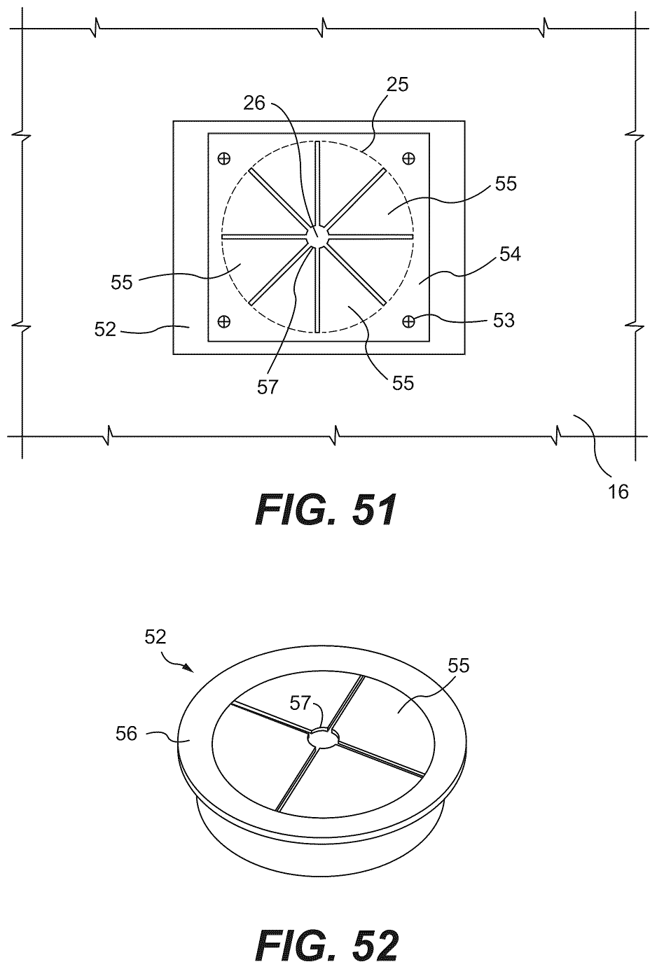

With reference to FIGS. 50 and 51, in an embodiment a resilient cover member 52 may include a planar member disposed across a roof 16 of a roofed enclosure 10 in a manner effective to cover a roof aperture 25 as shown. In an embodiment, a resilient cover member 52 may be releasably secured to a roof 16 via one or more fasteners 53, either directly or releasably secured using a mounting plate 54 as shown in FIG. 51. In an embodiment comprising a mounting plate 54, a resilient cover member 52 may also be referred to as a “resilient cover member assembly.”

As shown in FIGS. 50 and 51, in an embodiment, the cover member 52 may include a plurality of resilient flap members 55 radially disposed about the inner perimeter of a corresponding roof aperture 25, whereby, at a first resting position each of the resilient flap members 55 is configured to bias toward a center point 26 of a corresponding roof aperture 25 in a planar or substantially planar configuration. As shown in FIG. 52, in an embodiment, a resilient cover member 52 may comprise an annular grommet type member 56 or the like with resilient flaps 55 radially disposed inward from the grommet type member 56 as shown, wherein the grommet type member 56 may be sealably securable along an inner perimeter edge 25A of a roof aperture 25 (see inner perimeter edge 25A in FIG. 50).

Suitably, a resilient cover member 52 of this disclosure is configured as a protective guard to prevent a hose 164 from being cut or otherwise damaged by the inner perimeter edge 25A of a roof aperture 25. For example, a resilient cover member 52 suitably prevents the hose 164 from being cut or otherwise damaged (1) as the hose 164 is directed through the roof aperture 25 along the Z-axis, and (2) during a cleaning operation when the hose 164 is disposed through the roof aperture 25.

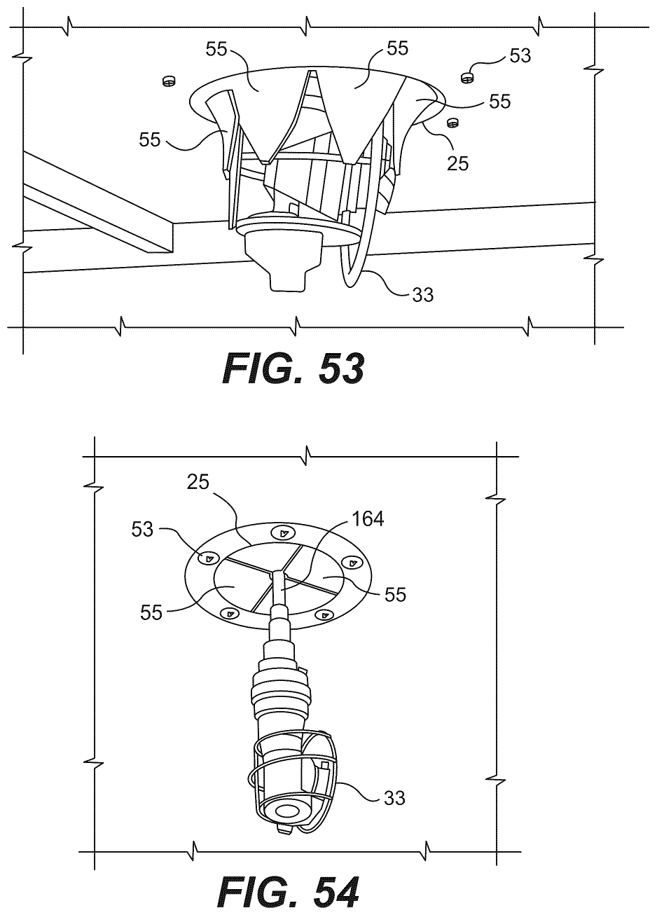

During operation, as a first fluid outlet 33 is directed into a roofed enclosure 10 through a resilient cover member 52 of a roof aperture 25, the resilient flap members 55 are configured to be displaced from the first resting position radially outward in a downward direction according to the outer surface configuration of the first fluid outlet 33 (see FIG. 53). Once the first fluid outlet 33 has traveled beyond a resilient cover member 52, the resilient flap members 55 are configured to bias back to the first resting to encircle a corresponding hose 164, as shown in FIG. 54, thereby maintaining the hose 164 in place within the roof aperture 25. In particular, in this position the resilient flap members 55 are collectively configured to (1) act as guide members for maintaining a concentric or substantially concentric position of the hose 164 within the roof aperture 25; (2) act as guide members for maintaining a concentric or substantially concentric position of the corresponding first fluid outlet 33 within the corresponding vertical pathway as the first fluid outlet 33 is being lowered into the roofed enclosure 10 and during operation; (3) act as stabilizing members for maintaining a concentric or substantially concentric position of the hose 164 within the roof aperture 25 during operation of the corresponding first fluid outlet 33; (4) act as stabilizing members for maintaining a concentric or substantially concentric position of the corresponding first fluid outlet 33 within the corresponding vertical pathway during operation; and (5) act as seal members about the outer surface of the hose 164 to assist in minimizing, inhibiting or otherwise preventing cleaning fluid from escaping from the roofed enclosure 10 through the roofed aperture 25 during cleaning operations. With reference to FIGS. 50, 51, 52 and 54, in an embodiment the distal ends of the resilient flap members 55 may form a circular or substantially circular opening 57 concentric with a center point 26 of a corresponding roof aperture 25 effective as a vertical alignment opening for a hose 164 360.0 degrees about the hose 164.

In an embodiment, the resilient flap members 55 are configured to remain in the first resting position, as shown in FIG. 50, during transport of a roofed enclosure 10, thereby guarding against contaminants entering the roofed enclosure 10 through the one or more roof apertures 25 (e.g., contaminants including, but not limited to, hail, snow, rain, as well as objects projected into the air such as rocks, sand, road debris, tree debris). The total number of resilient flap members 55 for a resilient cover member 52 may vary as desired or as may otherwise be required for one or more operations. For example, the resilient cover member 52 as shown in FIGS. 50 and 51 include a total of eight (8) resilient flap members 55, and the resilient cover member 52 as shown in FIGS. 52 and 54 include a total of four (4) resilient flap members 55.

In an embodiment, a resilient cover member 52 as shown in FIGS. 50 and 51, an annular grommet type member 56 as shown in FIG. 52, and the resilient flap members 55 of each may be constructed of one or more materials including, but not limited to nitrile rubber, neoprene rubber, silicone rubber, ethylene propylene diene monomer (EPDM), thermoplastic elastomer, thermoplastic vulcanizate, styrene butadiene rubber, and/or combinations thereof. In an embodiment, as shown in FIGS. 50, 53 and 54, a resilient cover member 52 including its resilient flap members 55 may be constructed of EPDM.

In an embodiment, a resilient cover member 52 may include radially disposed resilient brush members in place of the resilient flap member 55. In an embodiment, a resilient cover member 52 may include an annular grommet type member 56, or the like, with resilient bristles radially disposed inward from the grommet type member 56 in a manner similar to the resilient flap members 55 described above. In an embodiment, a resilient cover member 52 may include an annular grommet type member 56, or the like, with resilient overlapping brush members forming a resilient cover within the inner perimeter of the annular grommet type member 56.

In an embodiment, the one or more deck floor apertures 44 may be provided with deck floor aperture 44 cover members, for example, one or more removable cover plates, one or more removable fastenable cover plates, one or more slide plates, one or more hinged flip-up covers, one or more removable threaded covers, one or more removable twist-lock covers, one or more removable plug members, and/or combinations thereof. In an embodiment, one or more deck floor aperture 44 cover members may be set at a closed position and then set to an open position, or removed from the corresponding deck floor aperture 44, thereby providing access for first fluid outlets 33 there through. In an embodiment, the closed position of a deck floor aperture 44 cover member may further comprise a sealed position in which the deck floor aperture 44 cover member forms a seal with the corresponding deck floor aperture 44. Herein, a deck floor aperture 44 provided with a deck floor aperture 44 cover member may be referred to as a “deck floor hatch.”

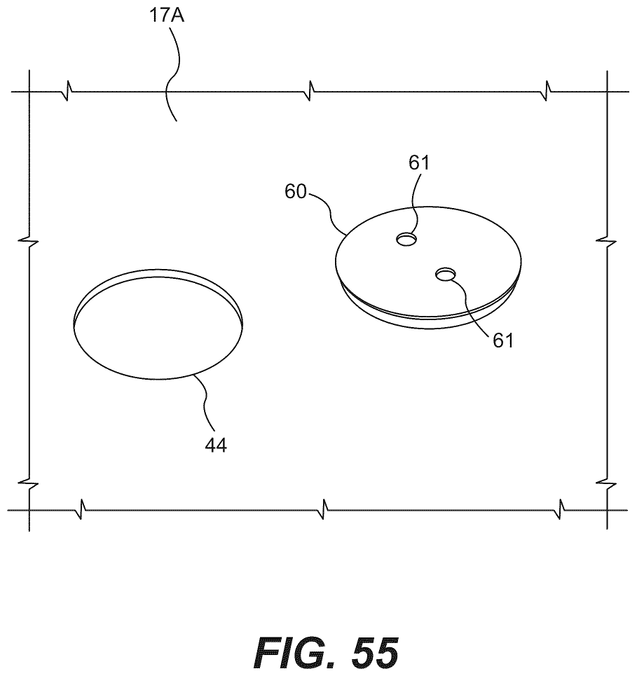

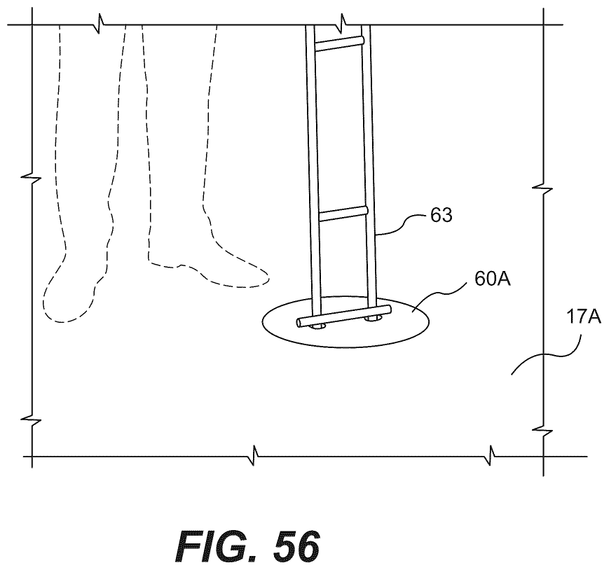

Referring to FIGS. 55 and 56, in an embodiment a deck floor aperture 44 cover member may include a removable twist-lock type deck floor aperture cover member 60 (e.g., a threaded twist-lock cover member 60) as shown. In an embodiment, a removable twist-lock type cover member 60 may include a dog-ear type cover for use with a bow-tie shape floor aperture 44.

Still referring to FIGS. 55 and 56, in an embodiment one or more deck floors 17 of a roofed enclosure 10 may include a solid planar or substantially planar upper support surface 17A and a cover member 60 may include a planar or substantially planar upper surface 60A set flush or substantially flush with the upper support surface 17A when the cover member 60 is mated with a corresponding deck floor aperture 44. In an embodiment, a deck floor 17 may be constructed of a diamond plate material such as aluminum, steel, and/or combinations thereof. In an embodiment, an upper surface 60A of a cover member 60 may include a diamond plate surface or other slip-resistant surface configuration the same or substantially similar as the upper support surface 17A of a deck floor 17.

With further reference to FIGS. 55 and 56, in an embodiment, including a twist-lock type cover member 60, the cover member 60 may include a plurality of mating holes 61 configured to receive corresponding prongs of an extraction tool 63 configured to twist and remove a cover member 60 from a deck floor aperture 44. In another embodiment, a cover member 60 may be provided as a plug type cover member 60 including one or more catch surfaces configured to be removed from a deck floor aperture 44 via a hook such as a manhole type hook or other lifting tool.

A cover member 60 of this disclosure may be constructed of one or more materials as desired or as may otherwise be required for one or more particular operations. As an example, in an embodiment of a roofed enclosure 10 for transporting livestock, a cover member 60 may be constructed of one or more materials resistant to chipping, cracking, excessive bending and reshaping as a result of weathering, heat, moisture, other outside mechanical and chemical influences, as well as vibration and physical impacts. In an embodiment, one or more cover members 60 may be constructed of one or more materials suitable for use with one or more particular types of animal to be transported in a roofed enclosure 10, for example, one or more metals, one or more plastics, one or more filled composite materials, and/or combinations thereof depending on the type or types of cleaning operations to be performed. Suitable metals may include ferrous metals (e.g., stainless steel), and non-ferrous metals (e.g., aluminum). Suitable plastics may include thermoplastics such as polyvinyl chloride (“PVC”) and chlorinated polyvinyl chloride (“CPVC”).

The disclosure will be better understood with reference to the following non-limiting examples, which are illustrative only and not intended to limit the disclosure to a particular embodiment.

### Example 1

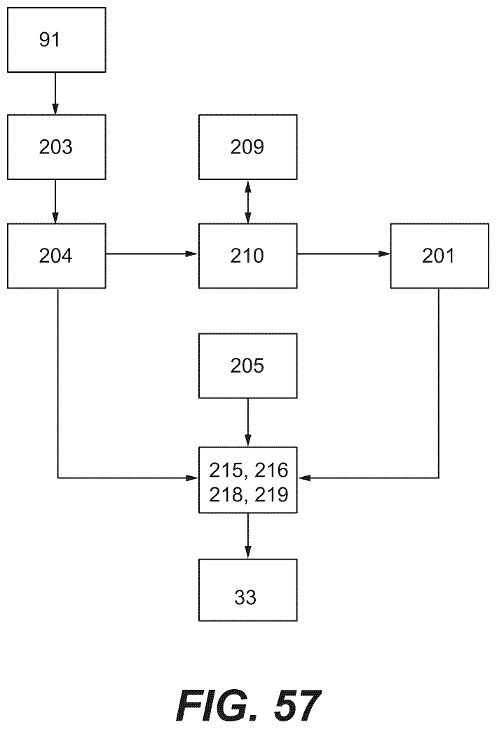

In a first non-limiting example, a system 100 may be provided as illustrated in FIG. 57 for supplying cleaning fluid to an enclosure 10 located in a cleaning zone 125 of a first cleaning bay 102. As shown, a fluid delivery system 104 of the system 100 is configured to receive hard potable well water or water from a public water line 91 into at least a first water softener 203. The first water softener 203 is fluidly communicated with at least one cold-water storage tank 204, which is fluidly communicated with (1) at least one heat exchanger 210, and with (2) system 100 pumps including at least (a) a low pressure pump 215 for the first cleaning bay 102, (b) a booster pump 216, (c) a high pressure floor level fluid outlet pump 218, and (d) a first high pressure pump 219.

The heat exchanger 210 is configured to receive hot water from a hot-water boiler 209 and convey the hot water to at least one hot-water storage tank 201, which is configured to convey hot water to the system 100 pumps 215, 216, 218, 219. The fluid delivery system 104 of the system 100 further includes a washing chemical storage container 205 in fluid communication with each of the system 100 pumps 215, 216, 218, 219. The system 100 pumps 215, 216, 218, 219 are configured to pump cold water, hot water and washing chemicals separately, and as one or more mixtures to the one or more first fluid outlets 33.

In operation, the incoming hard potable well water is softened through ion exchange inside the water softener 203. Once treated via the water softener 203, the treated water is discharged into the cold-water storage tank 204 preventing water back-flow. From the cold-water storage tank 204 the treated water is conveyed to the hot-water boiler 209 for heating the treated water, and then conveyed to the booster pump 216 and the low pressure pump 215. The hot-water boiler 209 is configured to generate hot water, which is stored in the hot-water storage tank 201 until the hot water is conveyed to the cleaning fluid dispensing system 130 of the system 100. The booster pump 216 is configured to increase the Net Positive Suction Head Available (“NPSHA”) of the system 100 to match or exceed the Net Positive Suction Head Required (“NPSHR”) required by the high pressure pump 219.

Once the cleaning fluid has been expelled through the one or more first fluid outlets 33 and/or the cleaning fluid outlets 35 and/or one or more low pressure floor level fluid outlets 137, the spent cleaning fluid and water (“spent fluid”) delivered into the cleaning bay 102 is collected through a gravitational drainage system and conveyed to a sedimentation pit 136 and is thereafter pumped out from the system 100 to one or more downstream containments and/or to a municipal sewage system or the like.

### Example 2

In a second non-limiting example, operation of a cleaning system 100 for cleaning a multi-deck roofed enclosure 10 including a roofed enclosure 10 as shown in FIG. 43 is provided.

1. The roofed enclosure 10 is directed into a cleaning bay 102 of the system 100 and guided along guide rails 152A, 152B to a cleaning position in a cleaning zone 125 of the cleaning bay 102 according to a first laser break beam sensor and a second laser break beam sensor of an enclosure 10 positioning system. The tractor 6 or other power unit pulling the roofed enclosure 10 into the cleaning zone 125 is detached from the roofed enclosure 10 and directed out from the cleaning bay 102. At a cleaning position, the legs 28 of the roofed enclosure 10 (e.g., crank down legs or drop legs), are set to a maximum height to increase the flow of cleaning fluid toward one or more gravitational drains 134 in the cleaning bay 102.

2. Any paneling is manually removed from the exterior of the roofed enclosure 10 for cleaning in a designated area in the cleaning bay 102 or outside the cleaning bay 102. Any deck boards present are manually removed from the interior of the roofed enclosure 10 for cleaning in a designated area in the cleaning bay 102 or outside the cleaning bay 102. Cleaning bay 102 personnel set the loading ramp(s) of the roofed enclosure 10 to a loaded or up position and set all divide gate(s) in the roofed enclosure 10 to a closed position. Cleaning of the paneling and/or deck boards may be performed by cleaning bay 102 personnel prior to, concurrent with, or following cleaning of the roofed enclosure 10.

3. Cleaning bay 102 personnel enter the roofed enclosure 10 and remove the cover members 60 from each of the deck floor apertures 44 using an extraction tool 63. The cover members 60 and any enclosure 10 tools (e.g., shovels, scrapers, humane livestock moving devices such as shakers and chase boards) may be left in the roofed enclosure 10 during the cleaning operation. In the alternative, the cover members 60 and any enclosure 10 tools may be removed from the roofed enclosure 10 and the cover members 60 and any enclosure 10 tools may be located at a designated area within the cleaning bay 102 or outside the cleaning bay 102 to be cleaned. For example, the cover members 60 and/or any enclosure 10 tools may be set on one or more dedicated wash racks located in the cleaning bay 102. Cover members 60 and any enclosure 10 tools removed from the roofed enclosure 10 may be cleaned by cleaning bay 102 personnel prior to, concurrent with, or following cleaning of the roofed enclosure 10.

4. The cleaning bay 102 includes at least eight (8) first fluid outlets 33 for use with each of the eight (8) vertical pathways 50A-50H of the roofed enclosure 10. One or more of the first fluid outlets 33 are adjusted along the X-axis and/or the Y-axis as needed to vertically align each of the first fluid outlets 33 with a corresponding vertical pathway 50A-50H.

5. Once vertically aligned, an operator remotely lowers each of the first fluid outlets 33 along the Z-axis into its corresponding vertical pathway to a first cleaning altitude (or “first cleaning position”) within the uppermost deck space 99C of the roofed enclosure 10 via a PLC of the system 100 using encoder feedback on either a retractable hose reel 163 or a pulley member 165, or via an altimeter on a hose 164 fitting for a corresponding first fluid outlet 33. Lowering of the first fluid outlets 33 to a first cleaning position is performed by lowering the first fluid outlets 33 successively beginning with the first fluid outlet 33 nearest the forward wall 14 and finishing with the first fluid outlet 33 nearest the rear end 19 of the roofed enclosure 10. The orientation of the first fluid outlets 33 in the uppermost deck space 99C, the loading ramp(s) set to an up position, and the divide gate(s) set to a closed position may be referred to herein as “Position A” of a cleaning operation.

6. The level of fouling of the roofed enclosure 10 is determined by the system 100 operator and/or other personnel upon visual inspection of the exterior and interior of the roofed enclosure 10. The operator interacts with the PLC of the system 100 via an HMI to select a cleaning program according to one or more cleaning parameters.

7. Cleaning Procedure-Uppermost deck space 99C

a. Pre-Wash Stage. Using each of the first fluid outlets 33 located in each of the vertical pathways 50A-50H, low pressure water is emitted onto the interior surfaces of the uppermost deck space 99C using a wave pattern of one or more fluid streams 30 as described above. The total volume of water used is determined according to the cleaning program. The pressure of the one or more fluid streams 30 is determined according to the cleaning program. The period of time for the pre-wash stage is determined according to the cleaning program. In another cleaning program, one or more cleaning fluids may be added to the low pressure water to provide a pre-rinse wash solution.

b. Main Wash Stage. Using each of the first fluid outlets 33 located in each of the vertical pathways 50A-50H, cleaning fluid is emitted onto the interior surfaces of the uppermost deck space 99C using a wave pattern of one or more fluid streams 30 as described above. The cleaning fluid solution and the total volume of cleaning fluid solution used is determined according to the cleaning program. The pressure of the one or more fluid streams 30 is determined according to the cleaning program. The period of time for the main wash stage is determined according to the cleaning program.

c. Rinse Stage. Using each of the first fluid outlets 33 located in each of the vertical pathways 50A-50H, low pressure water is emitted onto the interior surfaces of the uppermost deck space 99C using a wave pattern of one or more fluid streams 30 as described above. The total volume of water used is determined according to the cleaning program. The pressure of the one or more fluid streams 30 is determined according to the cleaning program. The period of time for the rinse stage is determined according to the cleaning program. A suitable rinse stage is effective to remove all main wash stage cleaning fluid from the interior surfaces of the uppermost deck space 99C.

d. Exterior cleaning of the roofed enclosure 10 using the one or more second fluid outlets 35 is performed during each of the (1) Pre-Wash stage, (2) Main Wash stage, and (3) Rinse stage.

e. The operator pauses the cleaning operation and cleaning bay 102 personnel enter roofed enclosure 10 to visually inspect the uppermost deck space 99C. Operator receives inspection report from cleaning bay 102 personnel via the HMI (e.g., audio communication and/or visual communication). For cleaning the intermediate deck space 99B, cleaning bay 102 personnel set the loading ramp(s) of the roofed enclosure 10 to an unloaded or down position, set the divide gate(s) in the roofed enclosure 10 to an open position and direct the first fluid outlets 33 located in vertical pathways 50A-50G into the intermediate deck space 99B (“Position B” of a cleaning operation). The resetting of the loading ramp(s) to an unloaded or down position and the resetting of the divide gate(s) to an open position is intended to clean any surfaces of the ramp(s) and divide gate(s) during the following cleaning procedure of the intermediate deck space 99B not cleaning during the previous cleaning procedure for the uppermost deck space 99C due to any dead spots or shadows realized according to the orientation of the loading ramp(s) and divide gate(s) in Position A.

8. Cleaning Procedure-Intermediate Deck Space 99B

a. Once cleaning bay 102 personnel exit the roofed enclosure 10, the operator resumes the cleaning operation via the HMI.

b. Pre-Wash Stage. Using each of the first fluid outlets 33 located in each of the vertical pathways 50A-50G, low pressure water is emitted onto the interior surfaces of the intermediate deck space 99B using a wave pattern of one or more fluid streams 30 as described above. The total volume of water used is determined according to the cleaning program. The pressure of the one or more fluid streams 30 is determined according to the cleaning program. The period of time for the pre-wash stage is determined according to the cleaning program. In another cleaning program, one or more cleaning fluids may be added to the low pressure water to provide a pre-rinse cleaning solution.

c. Main Wash Stage. Using each of the first fluid outlets 33 located in each of the vertical pathways 50A-50G, cleaning fluid is emitted onto the interior surfaces of the intermediate deck space 99B using a wave pattern of one or more fluid streams 30 as described above. The cleaning fluid solution and the total volume of cleaning fluid solution used is determined according to the cleaning program. The pressure of the one or more fluid streams 30 is determined according to the cleaning program. The period of time for the main wash stage is determined according to the cleaning program.

d. Rinse Stage. Using each of the first fluid outlets 33 located in each of the vertical pathways 50A-50G, low pressure water is emitted onto the interior surfaces of the intermediate deck space 99B using a wave pattern of one or more fluid streams 30 as described above. The total volume of water used is determined according to the cleaning program. The pressure of the one or more fluid streams 30 is determined according to the cleaning program. The period of time for the rinse stage is determined according to the cleaning program. A suitable rinse stage is effective to remove all main wash stage cleaning fluid from the interior surfaces of the intermediate deck space 99B.

e. Exterior cleaning of the roofed enclosure 10 using the one or more second fluid outlets 35 is performed during each of the (1) Pre-Wash stage, (2) Main Wash stage, and (3) Rinse stage.

f. The operator pauses the cleaning operation and cleaning bay 102 personnel enter roofed enclosure 10 to visually inspect the intermediate deck space 99B. Operator receives inspection report from cleaning bay 102 personnel via the HMI (e.g., audio communication and/or visual communication). Cleaning bay 102 personnel set the loading ramp(s) of the roofed enclosure 10 to a loaded or up position, set the divide gate(s) in the roofed enclosure 10 to a closed position and direct the first fluid outlets 33 located in vertical pathways 50A-50D into the bottommost deck space 99A (“Position C” of a cleaning operation). The resetting of the loading ramp(s) to a loaded or up position and the resetting of the divide gate(s) to a closed position is intended to clean any surfaces of the ramp(s) and divide gate(s) during the following cleaning procedure of the bottommost deck space 99A not cleaned during the previous cleaning procedure for the intermediate deck space 99B due to any dead spots or shadows realized according to the orientation of the loading ramp(s) and divide gate(s) in Position B.

9. Cleaning Procedure-Bottommost Deck Space 99A

a. Once cleaning bay 102 personnel exit the roofed enclosure 10, the operator resumes the cleaning operation via the HMI.

b. Pre-Wash Stage. Using each of the first fluid outlets 33 located in each of the vertical pathways 50A-50D, low pressure water is emitted onto the interior surfaces of the bottommost deck space 99A using a wave pattern of one or more fluid streams 30 as described above. The total volume of water used is determined according to the cleaning program. The pressure of the one or more fluid streams 30 is determined according to the cleaning program. The period of time for the pre-wash stage is determined according to the cleaning program. In another cleaning program, one or more cleaning fluids may be added to the low pressure water to provide a pre-rinse cleaning solution.

c. Main Wash Stage. Using each of the first fluid outlets 33 located in each of the vertical pathways 50A-50D, cleaning fluid is emitted onto the interior surfaces of the bottommost deck space 99A using a wave pattern of one or more fluid streams 30 as described above. The cleaning fluid solution and the total volume of cleaning fluid solution used is determined according to the cleaning program. The pressure of the one or more fluid streams 30 is determined according to the cleaning program. The period of time for the main wash stage is determined according to the cleaning program.

d. Rinse Stage. Using each of the first fluid outlets 33 located in each of the vertical pathways 50A-50D, low pressure water is emitted onto the interior surfaces of the bottommost deck space 99A using a wave pattern of one or more fluid streams 30 as described above. The total volume of water used is determined according to the cleaning program. The pressure of the one or more fluid streams 30 is determined according to the cleaning program. The period of time for the rinse stage is determined according to the cleaning program. A suitable rinse stage is effective to remove all main wash stage cleaning fluid from the interior surfaces of the bottommost deck space 99A.

e. Exterior cleaning of the roofed enclosure 10 using the one or more second fluid outlets 35 is performed during each of the (1) Pre-Wash stage, (2) Main Wash stage, and (3) Rinse stage.

10. Following the cleaning operation, the first fluid outlets 33 are directed vertically up and out from the roofed enclosure 10 to a non-operating position for each first fluid outlet 33 and cleaning bay 102 personnel ensure that loading ramp(s) are set to a loaded or up position and that divide gate(s) are set to a closed position for transport of the roofed enclosure 10 out from the cleaning bay 102.

11. Post-Wash Inspection. The operator and/or cleaning bay 102 personnel and/or personnel at one or more remote locations, such as via a video feed or video monitoring system, may perform a visual surface inspection of the interior and exterior of the roofed enclosure 10 visually inspecting the entire interior and exterior of the roofed enclosure 10, performing manual touch-up cleaning as necessary. For example, one or more floor level fluid outlets 137 may be used to rinse out remaining visible contaminants from within the roofed enclosure 10 or from one or more exterior surfaces of the roofed enclosure 10.

12. Post-Wash Disinfection. Following the post-wash inspection and any manual touch-up cleaning, one or more disinfectant solutions are applied to each of the exterior surfaces and the interior surfaces of the roofed enclosure 10, the paneling, deck boards and cover members 60. In an embodiment, the one or more disinfectant solutions may be applied to the interior surfaces of the roofed enclosure 10 via the first fluid outlets 33 and the one or more disinfectant solutions may be applied to the exterior surface of the roofed enclosure 10 via the one or more second fluid outlets 35. In an embodiment, the exterior and interior surfaces of the roofed enclosure 10, the paneling, deck boards and cover members 60 may each be treated with one or more disinfectant solutions using one or more floor level fluid outlets 137. As an alternative, personnel may use one or more mobile foam sprayers to treat one or more of the exterior surfaces of the roofed enclosure 10, the interior surfaces of the roofed enclosure 10, the paneling, the deck boards, and the cover members 60. Following application of the one or more disinfectants, each of the exterior surfaces of the roofed enclosure 10, the interior surfaces of the roofed enclosure 10, the paneling, the deck boards and the cover members 60 are allowed to air dry.

13. Cleaning bay 102 personnel reinstall each of the cover members 60 back into each of the deck floor apertures 44 using the extraction tool 63 to ensure stable load-bearing support surfaces for livestock entering the roofed enclosure 10. Cleaning bay 102 personnel place any enclosure 10 tools back into the roofed enclosure 10. Cleaning bay 102 personnel reinstall the paneling and the deck boards.

14. The tractor 6, or other power unit, is reattached to the roofed enclosure 10 and the roofed enclosure 10 is pulled out of the cleaning bay 102.

15. The floor 132 of the cleaning bay 102 is rinsed and optionally disinfected as desired to ready the cleaning bay 102 for a future wash operation.

### Example 3

In a third non-limiting example, in the cleaning operation of Example 2, when a roofed enclosure 10 is directed out of the cleaning bay 102 then the roofed enclosure 10 may be directed into a baking bay 120 for one or more baking treatments. The baking bay 120 is configured to heat the ambient air within the baking bay 120 to a temperature ranging from or about 70.0° C. (158.0° F.) to or about 80.0° C. (176.0° F.) for a period of time not less than ten (10) minutes to ensure microbicidal activity.

Following one or more baking treatments, baking bay 120 personnel may also perform one or more surface detections including, for example, one or more swab methods, use of a portable luminometer, and/or combinations thereof. If needed, the roofed enclosure 10 may be redirected into the cleaning bay 102 for one or more second cleaning operations as required.

### Example 4

In a fourth non-limiting example, in the cleaning operation of Example 2, following disinfection of the interior surfaces and exterior surfaces of the roofed enclosure 10, one or more heat treatments may be applied to the interior and exterior surfaces using one or more steam applications at one or more temperatures and for one or more durations effective to ensure microbicidal activity. In an embodiment, steam may be applied to the interior surfaces of the roofed enclosure 10 using one or more first fluid steam outlets 34, as described above, configured to emit one or more steam fluid streams 32 onto the interior surfaces, and one or more second fluid steam outlets 36, as described above, configured to emit one or more steam fluid streams 38 onto the exterior surfaces, at a temperature of or about 121.1° C. (250.0° F.) or higher for a duration ranging from or about 1.0 minute to or about 120.0 minutes to ensure microbicidal activity.

Following one or more steam treatments, cleaning bay 102 personnel and/or personnel at one or more remote locations, such as via a video feed or video monitoring system, may perform a visual surface inspection of the interior and exterior of the roofed enclosure 10. Cleaning bay 102 personnel may also perform one or more surface detections including, for example, one or more swab methods, use of a portable luminometer, and/or combinations thereof. If needed, the system 100 may be programmed via the control system 106 to perform one or more second cleaning operations as required.

### Example 5

With reference to FIGS. 46 and 49, in a fifth non-limiting example a triple-deck triple-axle animal transport roofed enclosure 10 having eleven vertical pathways 60A-60K is cleaned via a system 100 including a total of eleven (11) first fluid outlet 33 corresponding to each of the eleven vertical pathway 60A-60K. Groupings comprised of individual first fluid outlets 33 and multiple first fluid outlets 33 for use with the vertical pathway 60A-60K may be turned ON and OFF according to a cleaning sequence in reference to the vertical pathway 60A-60K as shown in Table 6 below.

TABLE 6

| Grouping | ON Position Cleaning Sequence |
|---|---|
| 1 | 60I |
| 2 | 60I, 60K |
| 3 | 60I, 60K, 60A |
| 4 | 60K, 60A, 60J |
| 5 | 60A, 60J, 60B |
| 6 | 60J, 60B, 60C |
| 7 | 60B, 60C, 60D |
| 8 | 60C, 60D, 60E |
| 9 | 60D, 60E, 60F |
| 10 | 60E, 60F, 60G |
| 11 | 60F, 60G, 60H |
| 12 | 60G, 60H |
| 13 | 60H |

Each ON position of the cleaning sequence has a run time of or about fifty (50) seconds equating to a total run time per individual first fluid outlet 33 of or about one hundred fifty (150) seconds (i.e., two minutes and thirty seconds) per cycle. The cleaning sequence may include a number of cycles as desired or as may otherwise be required. Non-limiting cleaning sequences may include a number of cycles for a duration from or about thirty (30.0) minutes to or about sixty (60.0) minutes. In an embodiment, the cleaning sequence may include a number of cycles for a duration of or about fifty-three (53.0) minutes.

### Example 6

With reference to FIGS. 46 and 49, in a sixth non-limiting example a triple-deck triple-axle animal transport roofed enclosure 10 may include vertical pathways 60A-60K disposed along the roofed enclosure 10 as described in Table 7 below.

TABLE 7

| | |
|---|---|
| D1: | of or about 22.9 cm (9.0 inches) |
| D2: | of or about 22.9 cm (9.0 inches) |
| D3: | of or about 70.0 cm (24.0 inches) |
| D4: | of or about 70.0 cm (24.0 inches) |
| D5: | of or about 70.0 cm (24.0 inches) |
| D6: | of or about 70.0 cm (24.0 inches) |
| D7: | of or about 70.0 cm (24.0 inches) |
| D8: | of or about 70.0 cm (24.0 inches) |
| D9: | of or about 22.9 cm (9.0 inches) |
| D10: | of or about 22.9 cm (9.0 inches) |
| D11: | of or about 78.7 cm (31.0 inches) |
| D12: | of or about 0.74 meters (2.42 feet) |
| D13: | of or about 3.81 meters (12.5 feet) |
| D14: | of or about 4.3 meters (14.08 feet) |
| D15: | of or about 5.7 meters (18.75 feet) |
| D16: | of or about 7.2 meters (23.5 feet) |
| D17: | of or about 8.21 meters (26.92 feet) |
| D18: | of or about 8.94 meters (29.33 feet) |
| D19: | of or about 11.15 meters (36.58 feet) |
| D20: | of or about 11.98 meters (39.3 feet) |
| D21: | of or about 13.9 meters (45.67 feet) |
| D22: | of or about 14.8 meters (48.67 feet) |

### Example 7

In a seventh non-limiting example, non-limiting examples of roofed enclosures 10 that may have one or more vertical pathways formed therein for cleaning as part of a system 100 of this disclosure are described in United States Patent Publication Number US 2007/0251462 A1, titled “Livestock Transportation System and Cover,” published Nov. 1, 2007; United States Patent Publication Number US 2017/0267153 A1, titled “Livestock Trailer with Enclosed Elevator Platform,” published Sep. 21, 2017; United States Patent Number U.S. Pat. No. 8,075,033 B1, titled “Dual Loading Stock Trailer,” issued Dec. 13, 2011; and United States Patent Number U.S. Pat. No. 11,751,531 B2, titled “Livestock Transport Container,” published Sep. 12, 2023; each of which is herein incorporated by reference in its entirety.

### Example 8

In an eighth non-limiting example, in an embodiment including a partially roofed enclosure 10, a deck floor aperture 44 formed in a part of an upper deck floor 17B not covered by part of the roof 16 of the partially roofed enclosure 10 may be configured to establish a vertical pathway within the partially roofed enclosure 10. As such, in an embodiment a vertical pathway having a deck floor aperture 44 as an upper access point may also be referred to herein as “a deck floor accessible vertical pathway.”

### Example 9

Water Based Autonomous Cleaning Operation. In a ninth non-limiting example, a contaminated roofed enclosure 10 in the form of a livestock trailer having an interior surface area from or about 120 m² to or about 250 m² and a plurality of roof apertures 25 may be positioned within a cleaning bay 102 following the transport of livestock. Corresponding first fluid outlets 33 may be adjusted along the X-axis and/or the Y-axis to vertically align each first fluid outlet 33 with a corresponding roof aperture 25. Once the first fluid outlets 33 are directed through the roof apertures 25, each to a desired dispensing position within the roofed enclosure 10, the interior of the roofed enclosure 10 may be cleaned by directing from or about 3000 liters to or about 8000 liters of a cleaning fluid comprising potable water and/or washing chemicals at a temperature from or about 40° C. to or about 65° C. out through each of the first fluid outlets 33 onto the interior surfaces of the roofed enclosure 10 at a total flow rate of or about 100 L/min for a duration of from or about twenty (20) minutes to or about sixty (60) minutes, depending on the size and configuration of the livestock trailer.

The cleaning operation may eliminate visible biological contamination, may remove biofilm, and may provide sanitization of interior surfaces of the roofed enclosure 10 corresponding to a reduction in microbial activity of at least about 3-log (99.9%), and in some embodiments up to about 4-log (99.99%).

### Example 10

Steam Based Autonomous Cleaning Operation. In a tenth non-limiting example, a contaminated roofed enclosure 10 in the form of a livestock trailer having an interior surface area of from or about 120 m² to or about 250 m² and a plurality of roof apertures 25 may be positioned within a cleaning bay 102 following the transport of livestock. The interior surfaces of the roofed enclosure 10 may first be cleaned using the water-based autonomous cleaning operation described in Example 9.

Following completion of the water-based cleaning operation, corresponding first fluid steam outlets 34 may be adjusted along the X-axis and/or the Y-axis to vertically align each first fluid steam outlet 34 with a corresponding roof aperture 25. Once the first fluid steam outlets 34 extend through the roof apertures 25 to a desired dispensing position within the roofed enclosure 10, steam at a temperature of from or about 110° C. to or about 125° C. may be directed through each of the first fluid steam outlets 34 onto the interior surfaces of the roofed enclosure 10 for a duration of from or about thirty (30) minutes to or about sixty (60) minutes. During the same operation, one or more second fluid steam outlets 36 may direct steam onto exterior surfaces of the roofed enclosure 10 at a temperature within the same range for a similar duration, providing concurrent interior and exterior steam treatment.

The steam-based autonomous cleaning operation may reduce disease-causing microorganisms, may eliminate visible biological contamination, may remove biofilm, and may provide partial sterilization of the interior and exterior surfaces of the roofed enclosure 10 corresponding to a reduction in microbial activity of at least about 4-log (99.99%).

### Example 11

Steam Based Sterilization-level Autonomous Cleaning Operation. In an eleventh non-limiting example, a contaminated roofed enclosure 10 in the form of a livestock trailer having an interior surface area of from or about 120 m² to or about 250 m² and a plurality of roof apertures 25 may be positioned within a cleaning bay 102 following the transport of livestock. The interior surfaces of the roofed enclosure 10 may first be cleaned using the water-based autonomous cleaning operation described in Example 9.

Following completion of the water-based cleaning operation, corresponding first fluid steam outlets 34 may be adjusted along the X-axis and/or the Y-axis to vertically align each first fluid steam outlet 34 with a corresponding roof aperture 25. Once the first fluid steam outlets 34 extend through the roof apertures 25 to a desired dispensing position within the roofed enclosure 10, steam at a temperature of from or about 118° C. to or about 125° C. may be directed through each of the first fluid steam outlets 34 onto the interior surfaces of the roofed enclosure 10 for a duration of from or about forty-five (45) minutes to or about ninety (90) minutes. During the same operation, one or more second fluid steam outlets 36 may direct steam onto exterior surfaces of the roofed enclosure 10 at a temperature within the same range for a similar duration, providing concurrent interior and exterior steam treatment.

The steam-based sterilization-level autonomous cleaning operation may reduce or eliminate biological contamination, may remove biofilm, and may provide sterilization of the interior and exterior surfaces of the roofed enclosure 10 corresponding to a reduction in microbial activity of at least about 6-log (99.9999%). In some embodiments, the performance of this operation may exceed current industry standards for cleaning and disinfection (“C&D”) of livestock-carrying animal transport enclosures and may provide a sterility assurance level (“SAL”) of less than about 10-3, corresponding to less than a 1-in-1,000 probability of a viable organism remaining following the cleaning operation.

### Example 12

In a twelfth non-limiting example, a system 100 includes a cleaning fluid dispensing system 130 and at least a first roofed enclosure 10 having one or more roof-accessible pathways. In this embodiment, the roof-accessible pathways are not limited to strictly vertical geometries and are configured to receive movable fluid outlets introduced at non-vertical or oblique angles. For example, one or more first fluid outlets 33 may comprise rigid or semi-rigid dispensing structures that are advanced through the roof-accessible pathways along angled trajectories.

A system 100 and method of the present disclosure may be described according to one or more of the following Embodiments.

Embodiment 1. A system, comprising:
one or more roofed enclosures, each of the one or more roofed enclosures comprising one or more roof-accessible pathways; and
a fluid dispensing system comprising one or more first fluid outlets configured to be directed into the one or more roof-accessible pathways of the one or more roofed enclosures and to dispense a fluid within an interior of the one or more roofed enclosures.

Embodiment 2. The system of Embodiment 1, wherein the one or more roof-accessible pathways comprise one or more roof-accessible vertical pathways.

Embodiment 3. The system of Embodiment 1, wherein the one or more roof-accessible pathways are formed at least in part by one or more resilient roof hatches.

Embodiment 4. The system of Embodiment 1, wherein the one or more first fluid outlets are configured to be directed to one or more dispensing positions within the one or more roof-accessible pathways.

Embodiment 5. The system of Embodiment 2, wherein the one or more roof-accessible pathways are formed at least in part by one or more resilient roof hatches, and wherein the one or more resilient roof hatches are configured to concentrically maintain the one or more first fluid outlets within the one or more roof-accessible pathways.

Embodiment 6. The system of Embodiment 1, wherein the one or more roof-accessible pathways of each of the one or more roofed enclosures are configured according to at least (1) an inner surface configuration of the roofed enclosure and (2) an operative spray range of each of the one or more first fluid outlets.

Embodiment 7. The system of Embodiment 1, wherein the one or more first fluid outlets are configured to emit one or more pressurized fluid streams.

Embodiment 8. The system of Embodiment 7, wherein the one or more pressurized fluid streams are configured to be applied to one or more interior surfaces of the one or more roofed enclosures and wherein the one or more pressurized fluid streams comprise one or more non-atomized pressurized fluid streams.

Embodiment 9. The system of Embodiment 1, further comprising at least a first cleaning area wherein the one or more first fluid outlets comprise one or more multi-axis fluid outlets configured to be located in the one or more roof-accessible pathways, wherein each of the one or more multi-axis fluid outlets is configured to emit the fluid having one or more spray parameters onto one or more target interior surfaces of a roofed enclosure of the one or more roofed enclosures that is positioned in the first cleaning area.

Embodiment 10. The system of Embodiment 1, further comprising at least a first cleaning area for the one or more roofed enclosures, the first cleaning area including the one or more first fluid outlets of the fluid dispensing system, wherein the one or more first fluid outlets are movable along at least X, Y, and Z axes for vertically aligning the one or more first fluid outlets with the one or more roof-accessible pathways of a roofed enclosure located in the first cleaning area.

Embodiment 11. The system of Embodiment 1, further comprising one or more second fluid outlets configured to emit one or more pressurized fluid streams onto one or more exterior surfaces of the one or more roofed enclosures.

Embodiment 12. The system of Embodiment 1, comprising one or more multi-deck roofed enclosures, wherein each of the one or more multi-deck roofed enclosures includes one or more roof apertures and one or more corresponding deck floor apertures forming the one or more roof-accessible pathways.

Embodiment 13. The system of Embodiment 2, comprising one or more multi-deck roofed enclosures, wherein each of the one or more multi-deck roofed enclosures includes one or more roof apertures and one or more corresponding deck floor apertures forming the one or more roof-accessible vertical pathways.

Embodiment 14. A system, comprising:
at least a first roofed enclosure comprising one or more roof-accessible pathways; and
a fluid dispensing system comprising one or more first fluid outlets configured to be directed to one or more dispensing positions within the one or more roof-accessible pathways of the first roofed enclosure.

Embodiment 15. The system of Embodiment 14, wherein the one or more roof-accessible pathways are formed at least in part by one or more resilient roof hatches.

Embodiment 16. The system of Embodiment 14, further including at least a first cleaning area, wherein the one or more first fluid outlets are movable in a manner effective to be directed to the one or more dispensing positions in the one or more roof-accessible pathways when the first roofed enclosure is located in the first cleaning area.

Embodiment 17. The system of Embodiment 14, wherein the one or more roof-accessible pathways are configured according to at least (1) an inner surface configuration of the first roofed enclosure and (2) an operative spray range of each of the one or more first fluid outlets.

Embodiment 18. The system of Embodiment 14, wherein the first roofed enclosure includes one or more resilient roof hatches forming the one or more roof-accessible pathways.

Embodiment 19. A system, comprising:
at least a first roofed enclosure; and
at least one cleaning fluid dispensing system comprising one or more first fluid outlets;
wherein the first roofed enclosure includes one or more resilient roof hatches forming one or more first vertical pathways in an interior of the first roofed enclosure;
wherein the one or more first fluid outlets are moveable in a manner effective to be directed to one or more dispensing positions within the one or more first vertical pathways, the one or more dispensing positions corresponding to one or more target interior surfaces of the first roofed enclosure;
wherein the one or more resilient roof hatches are configured to concentrically maintain the one or more first fluid outlets in the one or more first vertical pathways; and
wherein the one or more first vertical pathways of the first roofed enclosure are configured according to at least (1) an inner surface configuration of the first roofed enclosure and (2) an operative spray range of each of the one or more first fluid outlets.

Embodiment 20. The system of Embodiment 19, further comprising at least a second roofed enclosure having (1) a second inner surface configuration different from the inner surface configuration of the first roofed enclosure and (2) one or more resilient roof hatches forming one or more second vertical pathways different from the one or more first vertical pathways, wherein the one or more first fluid outlets are movable in a manner effective to be directed to one or more dispensing positions within the one or more second vertical pathways, the one or more dispensing positions corresponding to one or more target interior surfaces of the second roofed enclosure, and wherein the one or more second vertical pathways of the second roofed enclosure are configured according to at least (1) the second inner surface configuration of the second roofed enclosure and (2) the operative spray range of each of the one or more first fluid outlets.

Embodiment 21. A system, comprising:
at least a first roofed enclosure; and
at least one cleaning fluid dispensing system comprising one or more first fluid outlets;
wherein the first roofed enclosure includes one or more resilient roof hatches forming one or more vertical pathways in an interior of the first roofed enclosure;
wherein the one or more first fluid outlets are movable in a manner effective to be directed to one or more dispensing positions within the one or more vertical pathways;
wherein the one or more resilient roof hatches are configured to concentrically maintain the one or more first fluid outlets within the one or more vertical pathways; and
wherein the one or more vertical pathways are configured according to at least (1) an inner surface configuration of the first roofed enclosure and (2) an operative spray range of each of the one or more first fluid outlets.

Embodiment 22. A system, comprising:
one or more roofed enclosures; and
at least a first cleaning area including one or more first fluid outlets;
wherein each of the one or more roofed enclosures includes one or more resilient roof hatches forming one or more vertical pathways in an interior of the roofed enclosure;
wherein the one or more first fluid outlets are movable in a manner effective to be directed to one or more dispensing positions in the one or more vertical pathways of a roofed enclosure located in the first cleaning area; and
wherein the one or more vertical pathways of each of the one or more roofed enclosures are configured according to at least (1) an inner surface configuration of the roofed enclosure and (2) an operative spray range of each of the one or more first fluid outlets.

Embodiment 23. A system, comprising:
one or more roofed enclosures; and
at least a first cleaning area including one or more first fluid outlets;
wherein each of the one or more roofed enclosure includes one or more resilient roof hatches forming one or more vertical pathways;
wherein the one or more first fluid outlets are movable along at least X, Y, and Z axes for aligning the one or more first fluid outlets with the one or more resilient roof hatches, for directing the one or more first fluid outlets to one or more dispensing positions in the one or more vertical pathways, and for withdrawing the one or more first fluid outlets from the one or more resilient roof hatches; and
wherein the one or more vertical pathways of each of the one or more roofed enclosures are configured according to at least (1) an inner surface configuration of the roofed enclosure and (2) an operative spray range of each of the one or more first fluid outlets.

Embodiment 24. A system, comprising:
at least a first roofed enclosure; and
at least a first cleaning area including a cleaning fluid dispensing system having one or more first fluid outlets;
wherein the first roofed enclosure includes one or more resilient roof hatches forming one or more vertical pathways;
wherein when the first roofed enclosure is located in the first cleaning area, then the one or more first fluid outlets may be directed to one or more dispensing positions within the one or more vertical pathways; and
wherein the one or more vertical pathways are configured according to at least (1) an inner surface configuration of the first roofed enclosure and (2) an operative spray range of each of the one or more first fluid outlets.

Embodiment 25. A system, comprising:
at least a first roofed enclosure; and
at least a first cleaning area including a cleaning fluid dispensing system having one or more multi-axis first fluid outlets;
wherein the first roofed enclosure includes one or more resilient roof hatches forming one or more vertical pathways;
wherein the one or more multi-axis first fluid outlets are configured to be directed to one or more dispensing positions within the one or more vertical pathways effective to emit one or more pressurized fluid streams onto one or more interior surfaces of the first roofed enclosure; and
wherein the one or more resilient roof hatches are configured to concentrically maintain the one or more first fluid outlets within the one or more vertical pathways.

Embodiment 26. A system for cleaning roofed enclosures in a designated cleaning area, the system comprising:
one or more multi-axis first fluid outlets configured to emit one or more first pressurized fluid streams; and
one or more multi-axis second fluid outlets configured to emit one or more second pressurized fluid streams;
wherein each roofed enclosure includes one or more resilient roof hatches forming one or more vertical pathways;
wherein when a roofed enclosure is located in the designated cleaning area, then the one or more multi-axis first fluid outlets are configured to be directed to one or more dispensing positions within the one or more vertical pathways effective to clean one or more interior surfaces of the roofed enclosure; and
wherein the one or more vertical pathways are configured according to at least (1) an inner surface configuration of the roofed enclosure and (2) an operative spray range of each of the one or more multi-axis first fluid outlets.

Embodiment 27. A system, comprising:
at least a first cleaning area including a cleaning fluid dispensing system; and
a plurality of roofed enclosures, each roofed enclosure having a plurality of roof apertures defining a plurality of vertical pathways;
wherein the cleaning fluid dispensing system includes a plurality of first fluid outlets movable along at least X, Y, and Z axes effective to position each of the plurality of first fluid outlets in the plurality of vertical pathways of a roofed enclosure located in the first cleaning area; and wherein the plurality of vertical pathways are configured according to at least (1) an inner surface configuration of the roofed enclosure and (2) an operative spray range of each of the plurality of first fluid outlets.

Embodiment 28. A system, comprising:
one or more cleaning areas for one or more roofed enclosures, each cleaning area including one or more first fluid outlets having an operative spray range;
wherein each of the one or more roofed enclosures includes one or more roof-accessible vertical pathways configured to receive the one or more first fluid outlets; and
wherein the one or more vertical pathways are configured according to at least (1) an inner surface configuration of the roofed enclosure and (2) the operative spray range of each of the one or more first fluid outlets.

Embodiment 29. A system, comprising:
one or more cleaning areas having one or more first fluid outlets movable along a plurality of axes; and
one or more roofed enclosures having one or more roof-accessible vertical pathways;
wherein the one or more first fluid outlets are configured to be directed to one or more dispensing positions in the one or more vertical pathways of a roofed enclosure located in a cleaning area; and
wherein the one or more vertical pathways are configured according to at least (1) an inner surface configuration of the roofed enclosure and (2) the operative spray range of each of the one or more first fluid outlets.

Embodiment 30. The system of any of Embodiments 1, 14, 19, and 21-29, wherein the roofed enclosure includes an inner surface configuration different from another roofed enclosure of the system.

Embodiment 31. The system of any of Embodiments 1, 14, 19, and 21-29, wherein the roofed enclosure includes a resilient roof-hatch layout different from another roofed enclosure of the system.

Embodiment 32. The system of Embodiment 14, Embodiment 19, or any of Embodiments 21-29, wherein the one or more resilient roof hatches are configured to concentrically maintain the one or more first fluid outlets within the one or more roof-accessible pathways.

Embodiment 33. The system of any of Embodiments 1, 14, 19, and 21-29, further comprising one or more second fluid outlets configured to emit one or more pressurized fluid streams onto one or more exterior surfaces of the roofed enclosure.

Embodiment 34. The system of any of Embodiments 1, 14, 19, and 21-29, wherein the roofed enclosure includes a roof-accessible pathway configuration different from another roofed enclosure of the system.

Embodiment 35. The system of Embodiment 14, Embodiment 19, or any of Embodiments 21-29, wherein the one or more resilient roof hatches inhibit cleaning fluid from escaping through the roof of the roofed enclosure during operation.

Embodiment 36. The system of any of Embodiments 1, 14, 19, and 21-29, wherein the roofed enclosure includes a perforated roof comprising one or more resilient roof hatches forming one or more roof-accessible pathways.

Embodiment 37. The system of any of Embodiments 1, 14, 19, and 21-29, wherein the roofed enclosure is a multi-deck roofed enclosure including one or more roof apertures and one or more deck floor apertures forming one or more roof-accessible pathways extending through two or more decks.

Embodiment 38. The system of any of Embodiments 1, 14, 19, and 21-29, wherein one or more roof apertures or deck floor apertures include removable cover members.

Embodiment 39. The system of any of Embodiments 1, 14, 19, and 21-29, wherein the multi-deck roofed enclosure includes a multi-deck inner surface configuration different from another multi-deck roofed enclosure of the system.

Embodiment 40. The system of any of Embodiments 1, 14, 19, and 21-29, wherein the system includes one or more cleaning bays having overhead cleaning fluid dispensing systems.

Embodiment 41. The system of any of Embodiments 1, 14, 19, and 21-29, wherein one or more roof apertures are configured to receive one or more first fluid outlets in a manner effective to emit pressurized fluid onto one or more interior surfaces.

Embodiment 42. The system of any of Embodiments 1, 14, 19, and 21-29, wherein one or more dispensing positions correspond to one or more target interior surfaces.

Embodiment 43. The system of any of Embodiments 1, 14, 19, and 21-29, wherein one or more dispensing positions are selected according to an interior surface configuration and an ability of one or more fluid outlets to apply one or more fluid streams to the interior surface.

Embodiment 44. The system of any of Embodiments 1, 14, 19, and 21-29, wherein one or more roof-accessible pathways for a roofed enclosure are configured according to, at least in part, one or more dispensing positions of the one or more first fluid outlets.

Embodiment 45. The system of any of Embodiments 1, 14, 19, and 21-29, wherein an operative spray range comprises one or more distances at which one or more fluid streams impact one or more interior surfaces without atomization.

Embodiment 46. The system of any of Embodiments 1, 14, 19, and 21-29, wherein an operative spray range comprises one or more distances at which one or more fluid streams exert a minimum impingement force effective to clean one or more interior surfaces.

Embodiment 47. The system of any of Embodiments 1, 14, 19, and 21-29, wherein one or more roof-accessible pathways are configured to reduce or eliminate one or more dead spots or shadows within the roofed enclosure during operation.

Embodiment 48. The system of any of Embodiments 1, 14, 19, and 21-29, wherein the one or more first fluid outlets are configured to emit one or more non-atomized pressurized fluid streams.

Embodiment 49. The system of any of Embodiments 1, 14, 19, and 21-29, wherein the one or more first fluid outlets are movable along at least X, Y, and Z axes for aligning the one or more first fluid outlets with one or more roof-accessible pathways of a roofed enclosure located in a cleaning area of the system.

Embodiment 50. The system of any of Embodiments 1, 14, 19, and 21-29, wherein the one or more first fluid outlets are movable along the Z axis for insertion into and withdrawal from one or more roof-accessible pathways of a roofed enclosure located in a cleaning area of the system.

Embodiment 51. The system of any of Embodiments 1, 14, 19, and 21-29, wherein one or more interior surfaces of a roofed enclosure are cleaned in a top-to-bottom sequence.

Embodiment 52. The system of any of Embodiments 1, 14, 19, and 21-29, wherein one or more dispensing positions are selected to first impact upper interior surfaces of a roofed enclosure and subsequently impact lower interior surfaces of the roofed enclosure.

Embodiment 53. The system of any of Embodiments 1, 14, 19, and 21-29, wherein one or more multi-axis fluid outlets are configured to emit cleaning fluid onto one or more interior surfaces and one or more exterior surfaces of one or more roofed enclosure located in a cleaning area of the system.

Embodiment 54. The system of any of Embodiments 1, 14, 19, and 21-29, wherein a roofed enclosure such as an openwork animal transport enclosure includes one or more roof apertures configured to stabilize one or more first fluid outlets positioned relative to the apertures.

Embodiment 55. The system of any of Embodiments 1, 14, 19, and 21-29, wherein a cleaning bay of the system includes a fluid delivery system configured to provide one or more cleaning fluids of one or more types, volumes, pressures, temperatures, or other specifications.

Embodiment 56. The system of any of Embodiments 1, 14, 19, and 21-29, wherein one or more multi-axis fluid outlets are configured to be positioned relative to one or more openings of a perforated-roof transport enclosure that is located in a cleaning area of the system.

Embodiment 57. The system of any of Embodiments 1, 14, 19, and 21-29, wherein one or more multi-axis fluid outlets are configured to be positioned within one or more vertical pathways of a multi-deck roofed enclosure that is located in a cleaning area of the system.

Embodiment 58. The system of any of Embodiments 1, 14, 19, and 21-29, wherein one or more cleaning fluid dispensing systems are disposed along at least a ceiling of a cleaning bay of the system.

Embodiment 59. The system of any of Embodiments 1, 14, 19, and 21-29, wherein one or more cleaning fluids are emitted according to one or more spray parameters selected based on one or more known or anticipated contaminants in or on a roofed enclosure of the system.

Embodiment 60. The system of any of Embodiments 1, 14, 19, and 21-29, wherein each roofed enclosure of a fleet of roofed enclosures includes one or more roof-accessible vertical pathways formed according to an inner surface configuration of the roofed enclosure and an operative spray range of one or more first fluid outlets.

Embodiment 61. The system of any of Embodiments 1, 14, 19, and 21-29, wherein one or more cleaning fluid sources are formulated according to one or more identified contaminants of one or more roofed enclosures.

Embodiment 62. A method of cleaning one or more interior surfaces of one or more roofed enclosures in a cleaning area comprising one or more first fluid outlets, the method including forming in each roofed enclosure one or more resilient roof hatches according to at least (a) an inner surface configuration of the roofed enclosure and (b) an operative spray range of each of the one or more first fluid outlets, and emitting cleaning fluid from the one or more first fluid outlets onto the one or more interior surfaces of the roofed enclosure when the one or more first fluid outlets are oriented through the one or more resilient roof hatches in one or more operative spray-range dispensing positions.

Embodiment 63. A method of cleaning one or more interior surfaces of one or more roofed enclosures in a cleaning area comprising one or more first fluid outlets, the method including forming in each roofed enclosure one or more post-production roof apertures according to at least (a) an inner surface configuration of the roofed enclosure and (b) an operative spray range of each of the one or more first fluid outlets, and emitting cleaning fluid from the one or more first fluid outlets onto the one or more interior surfaces of the roofed enclosure when the one or more first fluid outlets are oriented through the one or more post-production roof apertures in one or more operative spray-range dispensing positions.

Embodiment 64. A method of cleaning one or more interior surfaces of one or more multi-deck roofed enclosures in a cleaning area comprising one or more first fluid outlets, the method including forming in each multi-deck roofed enclosure one or more roof apertures and one or more deck floor apertures providing one or more vertical pathways in an interior of the multi-deck roofed enclosure according to at least (a) an inner surface configuration of the multi-deck roofed enclosure and (b) an operative spray range of each of the one or more first fluid outlets, and emitting cleaning fluid from the one or more first fluid outlets onto the one or more interior surfaces of the multi-deck roofed enclosure when the one or more first fluid outlets are oriented in the one or more vertical pathways in one or more operative spray-range dispensing positions.

Embodiment 65. A method of cleaning one or more roofed enclosures in a cleaning area comprising one or more first fluid outlets and one or more second fluid outlets, the method including forming in each roofed enclosure one or more roof apertures according to at least (a) an inner surface configuration of the roofed enclosure and (b) an operative spray range of each of the one or more first fluid outlets, directing the one or more first fluid outlets through the one or more roof apertures to one or more operative spray-range dispensing positions and emitting cleaning fluid from the one or more first fluid outlets onto one or more interior surfaces of the roofed enclosure, and directing the one or more second fluid outlets to one or more positions along the cleaning area and emitting cleaning fluid from the one or more second fluid outlets onto one or more exterior surfaces of the roofed enclosure.

Embodiment 66. A method of cleaning a plurality of roofed enclosures in a cleaning area comprising one or more multi-axis first fluid outlets, the method including forming in each roofed enclosure one or more roof apertures in a layout according to at least (a) an inner surface configuration of the roofed enclosure and (b) an operative spray range of each of the one or more first fluid outlets, locating a first roofed enclosure in the cleaning area, directing the one or more first fluid outlets along one or more axes to one or more operative spray-range dispensing positions through the one or more roof apertures of the first roofed enclosure and emitting a first amount of cleaning fluid onto one or more interior surfaces of the first roofed enclosure, removing the first roofed enclosure from the cleaning area, locating a second roofed enclosure having one or more roof apertures in a second roof-aperture layout different from the first roof-aperture layout, and directing the one or more first fluid outlets along the one or more axes to one or more operative spray-range dispensing positions through the one or more roof apertures of the second roofed enclosure and emitting a second amount of cleaning fluid onto one or more interior surfaces of the second roofed enclosure.

Embodiment 67. The method of any of Embodiments 62, 63, 64, 65, or 66, wherein directing the one or more first fluid outlets through the one or more resilient roof hatches precedes emitting the cleaning fluid.

Embodiment 68. The method of any of Embodiments 62, 63, 64, or 65, wherein directing the one or more first fluid outlets through one or more post-production roof apertures precedes emitting the cleaning fluid.

Embodiment 69. The method of any of Embodiments 62, 63, 64, 65, or 66, wherein directing the one or more first fluid outlets through one or more post-production resilient roof hatches precedes emitting the cleaning fluid.

Embodiment 70. The method of any of Embodiments 62, 63, 64, 65, or 66, wherein one or more interior surfaces of a multi-deck roofed enclosure are cleaned top-to-bottom on a deck-by-deck basis.

Embodiment 71. The method of any of Embodiments 62, 63, 64, 65, or 66, wherein one or more interior surfaces of a multi-deck roofed enclosure are cleaned top-to-bottom in one or more wave patterns on a deck-by-deck basis.

Embodiment 72. The method of any of Embodiments 62, 63, 64, 65, or 66, wherein the one or more first fluid outlets are directed to one or more operative spray-range dispensing positions in one or more vertical pathways of a roofed enclosure.

Embodiment 73. The method of any of Embodiments 62, 63, 64, 65, or 66, wherein one or more cleaning fluids are emitted according to one or more spray parameters selected based on one or more known or anticipated contaminants.

Embodiment 74. The method of any of Embodiments 62, 63, 64, 65, or 66, wherein one or more cleaning fluids are provided at one or more volumes, pressures, or temperatures according to one or more known or anticipated contaminants.

Embodiment 75. The method of any of Embodiments 62, 63, 64, 65, or 66, wherein one or more cleaning fluids are provided according to one or more cleaning specifications.

Embodiment 76. The method of any of Embodiments 62, 63, 64, or 65, wherein one or more multi-axis fluid outlets are positioned relative to one or more openings of a perforated-roof transport enclosure.

Embodiment 77. The method of any of Embodiments 62, 63, 64, or 65, wherein one or more multi-axis fluid outlets are positioned relative to one or more roof-accessible vertical pathways of an openwork animal transport enclosure type roofed enclosure.

Embodiment 78. The method of any of Embodiments 62, 63, 64, 65, or 66, wherein one or more multi-axis fluid outlets are positioned within one or more vertical pathways of a multi-deck roofed enclosure.

Embodiment 79. The method of any of Embodiments 62, 63, 64, 65, or 66, wherein one or more cleaning fluid dispensing systems are disposed along at least a ceiling of a cleaning bay.

Embodiment 80. The method of any of Embodiments 62, 63, 64, 65, or 66, wherein one or more cleaning fluid dispensing systems are in fluid communication with a fluid delivery system configured to provide one or more cleaning fluids of one or more cleaning fluid specifications.

Embodiment 81. The method of any of Embodiments 62, 63, 64, or 66, wherein one or more roof apertures and one or more deck floor apertures are formed according to an inner surface configuration of the roofed enclosure and an operative spray range of one or more first fluid outlets of the system.

Embodiment 82. The method of any of Embodiments 62, 63, 64, or 66, wherein the one or more roof apertures, post-production roof apertures and one or more resilient roof hatches are disposed along the roof in an alternating pattern.

Embodiment 83. The method of any of Embodiments 62, 63, 64, or 66, wherein one or more post-production roof apertures are formed according to an inner surface configuration of the roofed enclosure and an operative spray range of one or more first fluid outlets.

Embodiment 84. The method of any of Embodiments 62, 63, 64, or 66, wherein one or more post-production resilient roof hatches are formed according to an inner surface configuration of the roofed enclosure and an operative spray range of one or more first fluid outlets.

Embodiment 85. The method of any of Embodiments 62, 63, 64, 65, or 66, wherein the one or more first fluid outlets are directed along one or more axes to one or more operative spray-range dispensing positions.

Embodiment 86. The method of Embodiment 65, wherein the one or more second fluid outlets are directed to one or more positions along the cleaning area to emit cleaning fluid onto one or more exterior surfaces of the roofed enclosure.

Embodiment 87. The method of any of Embodiments 62, 63, 64, 65, or 66, wherein one or more cleaning fluid sources are formulated according to one or more identified contaminants of one or more roofed enclosures.

Embodiment 88. The method of any of Embodiments 62, 63, or 66, wherein one or more roof-accessible vertical pathways are formed in a layout according to an inner surface configuration of the roofed enclosure and an operative spray range of one or more first fluid outlets.

Embodiment 89. The method of Embodiment 66, wherein one or more roofed enclosures of a fleet of roofed enclosures are cleaned using one or more first fluid outlets directed to one or more dispensing positions effective to clean one or more interior surfaces of a roofed enclosure in the cleaning area according to minimum impingement forces exerted by one or more fluid streams upon the one or more interior surfaces of the roofed enclosure.

Embodiment 90. The method of Embodiment 66, further comprising producing one or more cleaning systems according to one or more identified contaminants of a fleet of roofed animal transport enclosures.

Embodiment 91. The method of Embodiment 66, wherein one or more roof-accessible vertical pathways are formed in each roofed animal transport enclosure of the fleet of roofed enclosures according to an inner surface configuration of the roofed enclosure and an operative spray range of one or more first fluid outlets.

Embodiment 92. The method of Embodiment 62, wherein one or more multi-axis fluid outlets are positioned relative to the one or more one or more resilient roof hatches.

Embodiment 93. The method of Embodiment 63, wherein one or more multi-axis fluid outlets are positioned relative to the one or more post-production roof apertures.

Embodiment 94. The method of Embodiment 64, wherein one or more multi-axis fluid outlets are positioned relative to the one or more roof apertures.

Embodiment 95. A system and method for cleaning transport enclosures including, but not limited to animal transport enclosures such as open top animal transport enclosures and/or roofed openwork animal transport enclosures of varying size and kind within one or more cleaning areas.

Embodiment 96. A system and method for cleaning transport enclosures within a designated cleaning area, the system comprising a fluid dispensing system disposed adjacent a designated cleaning space, the fluid dispensing system having one or more fluid outlets configured to emit pressurized fluid into the designated cleaning space; wherein each of the one or more fluid outlets is configured to be located at one or more fluid dispensing positions in the designated cleaning space according to a layout of a transport enclosure positioned within the designated cleaning space effective to emit the pressurized fluid onto one or more target surfaces of the transport enclosure for cleaning the transport enclosure.

Embodiment 97. A method comprising cleaning an openwork animal transport enclosure positioned within a designated cleaning space using a system including a cleaning fluid dispensing system disposed adjacent the designated cleaning space, the cleaning fluid dispensing system having one or more fluid outlets configured to emit pressurized fluid into the designated cleaning space; wherein each of the one or more fluid outlets is configured to be located at one or more dispensing positions in the designated cleaning space according to a layout of a transport enclosure positioned within the designated cleaning space effective to emit the pressurized fluid onto one or more target surfaces of the transport enclosure.

Embodiment 98. A system, comprising:
at least one open top animal transport enclosure; and
a fluid dispensing system comprising one or more first fluid outlets configured to be directed along X, Y, and Z axes to one or more dispensing positions effective for dispensing one or more fluids onto an interior of the open top animal transport enclosure.

Embodiment 99. The system of Embodiment 98, wherein the one or more first fluid outlets are configured for top down positioning to the one or more dispensing positions.

Although the present disclosure is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Persons of ordinary skill in the art will recognize that many modifications may be made to the present disclosure without departing from the spirit and scope of the disclosure. The embodiment(s) described herein are meant to be illustrative only and should not be taken as limiting the invention, which is defined in the claims.

We claim:

1. A system, comprising:
one or more roofed enclosures, each of the one or more roofed enclosures comprising one or more roof-accessible pathways; and
a fluid dispensing system comprising one or more first fluid outlets configured to be directed into the one or more roof-accessible pathways of the one or more roofed enclosures and to dispense a fluid within an interior of the one or more roofed enclosures.

2. The system of claim 1, wherein the one or more roof-accessible pathways comprise one or more roof-accessible vertical pathways.

3. The system of claim 1, wherein the one or more roof-accessible pathways are formed at least in part by one or more resilient roof hatches.

4. The system of claim 1, wherein the one or more first fluid outlets are configured to be directed to one or more dispensing positions within the one or more roof-accessible pathways.

5. The system of claim 2, wherein the one or more roof-accessible pathways are formed at least in part by one or more resilient roof hatches, and wherein the one or more resilient roof hatches are configured to concentrically maintain the one or more first fluid outlets within the one or more roof-accessible pathways.

6. The system of claim 1, wherein the one or more roof-accessible pathways of each of the one or more roofed enclosures are configured according to at least (1) an inner surface configuration of the roofed enclosure and (2) an operative spray range of each of the one or more first fluid outlets.

7. The system of claim 1, wherein the one or more first fluid outlets are configured to emit one or more pressurized fluid streams.

8. The system of claim 7, wherein the one or more pressurized fluid streams are configured to be applied to one or more interior surfaces of the one or more roofed enclosures and wherein the one or more pressurized fluid streams comprise one or more non-atomized pressurized fluid streams.

9. The system of claim 1, further comprising at least a first cleaning area wherein the one or more first fluid outlets comprise one or more multi-axis fluid outlets configured to be located in the one or more roof-accessible pathways, wherein each of the one or more multi-axis fluid outlets is configured to emit the fluid having one or more spray parameters onto one or more target interior surfaces of a roofed enclosure of the one or more roofed enclosures that is positioned in the first cleaning area.

10. The system of claim 1, further comprising at least a first cleaning area for the one or more roofed enclosures, the first cleaning area including the one or more first fluid outlets of the fluid dispensing system, wherein the one or more first fluid outlets are movable along at least X, Y, and Z axes for vertically aligning the one or more first fluid outlets with the one or more roof-accessible pathways of a roofed enclosure located in the first cleaning area.

11. The system of claim 1, further comprising one or more second fluid outlets configured to emit one or more pressurized fluid streams onto one or more exterior surfaces of the one or more roofed enclosures.

12. The system of claim 1, comprising one or more multi-deck roofed enclosures, wherein each of the one or more multi-deck roofed enclosures includes one or more roof apertures and one or more corresponding deck floor apertures forming the one or more roof-accessible pathways.

13. The system of claim 2, comprising one or more multi-deck roofed enclosures, wherein each of the one or more multi-deck roofed enclosures includes one or more roof apertures and one or more corresponding deck floor apertures forming the one or more roof-accessible vertical pathways.

14. A system, comprising:
at least a first roofed enclosure comprising one or more roof-accessible pathways; and
a fluid dispensing system comprising one or more first fluid outlets configured to be directed to one or more dispensing positions within the one or more roof-accessible pathways of the first roofed enclosure.

15. The system of claim 14, wherein the one or more roof-accessible pathways are formed at least in part by one or more resilient roof hatches.

16. The system of claim 14, further including at least a first cleaning area, wherein the one or more first fluid outlets are movable in a manner effective to be directed to the one or more dispensing positions in the one or more roof-accessible pathways when the first roofed enclosure is located in the first cleaning area.

17. The system of claim 14, wherein the one or more roof-accessible pathways are configured according to at least (1) an inner surface configuration of the first roofed enclosure and (2) an operative spray range of each of the one or more first fluid outlets.

18. The system of claim 14, wherein the first roofed enclosure includes one or more resilient roof hatches forming the one or more roof-accessible pathways.

19. A system, comprising:
at least a first roofed enclosure; and
at least one cleaning fluid dispensing system comprising one or more first fluid outlets;
wherein the first roofed enclosure includes one or more resilient roof hatches forming one or more first vertical pathways in an interior of the first roofed enclosure;
wherein the one or more first fluid outlets are moveable in a manner effective to be directed to one or more dispensing positions within the one or more first vertical pathways, the one or more dispensing positions corresponding to one or more target interior surfaces of the first roofed enclosure;
wherein the one or more resilient roof hatches are configured to concentrically maintain the one or more first fluid outlets in the one or more first vertical pathways; and
wherein the one or more first vertical pathways of the first roofed enclosure are configured according to at least (1) an inner surface configuration of the first roofed enclosure and (2) an operative spray range of each of the one or more first fluid outlets.

20. The system of claim 19, further comprising at least a second roofed enclosure having (1) a second inner surface configuration different from the inner surface configuration of the first roofed enclosure and (2) one or more resilient roof hatches forming one or more second vertical pathways different from the one or more first vertical pathways, wherein the one or more first fluid outlets are movable in a manner effective to be directed to one or more dispensing positions within the one or more second vertical pathways, the one or more dispensing positions corresponding to one or more target interior surfaces of the second roofed enclosure, and wherein the one or more second vertical pathways of the second roofed enclosure are configured according to at least (1) the second inner surface configuration of the second roofed enclosure and (2) the operative spray range of each of the one or more first fluid outlets.
